(19) United States
(12) Patent Application Publication
(10) Pub. No.: US 2024/0378018 A1
(43) Pub. Date: Nov. 14, 2024

(54) ADDER CIRCUITS FOR FLOATING-POINT OPERATION

(71) Applicant: SK hynix Inc., Icheon-si Gyeonggi-do (KR)

(72) Inventor: Seong Ju LEE, Icheon-si Gyeonggi-do (KR)

(73) Assignee: SK hynix Inc., Icheon-si Gyeonggi-do (KR)

(21) Appl. No.: 18/783,143

(22) Filed: Jul. 24, 2024

Related U.S. Application Data
(63) Continuation-in-part of application No. 17/503,770, filed on Oct. 18, 2021.

(30) Foreign Application Priority Data
May 18, 2021 (KR) 10-2021-0064088

(51) Int. Cl. G06F 7/485

(52) U.S. Cl. CPC G06F 7/485

(57) ABSTRACT

An adder circuit includes a negative number processing circuit configured to receive mantissa data and sign data of a plurality of floating point data and configured to output selected mantissa data, and an adder tree configured to perform an addition operation on the selected mantissa data to generate mantissa addition data. The negative number processing circuit is configured to output mantissa data of floating point data having a positive sign as the selected mantissa data, and to output an inverted mantissa data in which values of mantissa data of the floating point data having a negative sign are inverted as the selected mantissa data. And the adder tree is configured to perform the addition operation on the selected mantissa data with a number of “+1” operations equal to the number of the inverted mantissa data output from the negative number processing circuit.

### CROSS-REFERENCE TO RELATED APPLICATIONS

The present application is a continuation-in-part application of U.S. patent application Ser. No. 17/503,770, filed on Oct. 18, 2021, which claims priority under 35 U.S.C. § 119(a) to Korean application number 10-2021-0064088, filed on May 18, 2021, in the Korean Intellectual Property Office, the entire contents of which applications are incorporated herein by reference.

### BACKGROUND

### 1. Technical Field

Various embodiments of the present teachings relate to adder circuits for floating point operations.

### 2. Related Art

Recently, interest in artificial intelligence (AI) has been increasing not only in the information technology industry but also in the financial and medical industries. Accordingly, in various fields, the artificial intelligence, more precisely, the introduction of deep learning is considered and prototyped. In general, techniques for effectively learning deep neural networks (DNNs) or deep networks having the increased layers as compared with general neural networks to utilize the deep neural networks (DNNs) or the deep networks in pattern recognition or inference are commonly referred to as the deep learning.

One of backgrounds or causes of this widespread interest may be due to the improved performance of a processor performing arithmetic operations. To improve the performance of the artificial intelligence, it may be necessary to increase the number of layers constituting a neural network in the artificial intelligence to educate the artificial intelligence. This trend has continued in recent years, which has led to an exponential increase in the amount of computation required for the hardware that actually does the computation. Moreover, if the artificial intelligence employs a general hardware system including a memory and a processor which are separated from each other, the performance of the artificial intelligence may be degraded due to limitation of the amount of data communication between the memory and the processor. In order to solve this problem, a processing-in-memory (PIM) device including a processor and a memory which are integrated in one semiconductor chip has been employed as an artificial intelligence accelerator. Because the PIM device directly performs arithmetic operations in the PIM device using data stored in the memory of the PIM device as input data, a data processing speed in the neural network may be improved.

### SUMMARY

According to an embodiment, an adder circuit according to an embodiment of the present disclosure may include a negative number processing circuit configured to receive mantissa data and sign data of a plurality of floating point data as input and configured to output selected mantissa data, and an adder tree configured to perform an addition operation on the selected mantissa data to generate mantissa addition data. The negative number processing circuit is configured to output mantissa data of floating point data having a positive sign as the selected mantissa data, and to output an inverted mantissa data in which values of mantissa data of the floating point data having a negative sign are inverted as the selected mantissa data. And the adder tree is configured to perform the addition operation on the selected mantissa data with a number of “+1” operations equal to the number of the inverted mantissa data output from the negative number processing circuit.

### BRIEF DESCRIPTION OF THE DRAWINGS

Certain features of the disclosed technology are illustrated by various embodiments with reference to the attached drawings, in which:

FIG. 1 is a block diagram illustrating an artificial intelligence accelerator according to an embodiment of the present disclosure;

FIG. 2 is a timing diagram illustrating an accumulative adding calculation of an accumulative addition circuit included in the artificial intelligence accelerator of FIG. 1;

FIG. 3 illustrates an example of a matrix multiplying calculation executed by a multiplication/accumulation (MAC) operation of the artificial intelligence accelerator of FIG. 1;

FIG. 4 illustrates a process of storing weight data in FIG. 3 into a left memory bank and a right memory bank included in the artificial intelligence accelerator of FIG. 1;

FIG. 5 illustrates a process of storing vector data in FIG. 3 into a first global buffer and a second global buffer included in the artificial intelligence accelerator of FIG. 1;

FIG. 6 is a block diagram illustrating an example of configurations and operations of a left multiplication circuit, a right multiplication circuit, and an integrated adder tree included in the artificial intelligence accelerator of FIG. 1;

FIG. 7 is a block diagram illustrating an example of configurations and operations of a left accumulator and a right accumulator constituting an accumulative addition circuit included in the artificial intelligence accelerator of FIG. 1;

FIG. 8 is a block diagram illustrating an example of a configuration of a left accumulative adder included in a left accumulator shown in FIG. 7;

FIG. 9 is a block diagram illustrating an example of a configuration of an exponent operation circuit included in the left accumulative adder of FIG. 8;

FIG. 10 is a block diagram illustrating an example of a configuration of a mantissa operation circuit included in the left accumulative adder of FIG. 8;

FIG. 11 is a block diagram illustrating an example of a configuration of a normalizer included in the left accumulative adder of FIG. 8;

FIG. 12 illustrates an operation of processing exponent part data and mantissa part data during an accumulative adding calculation of the left accumulative adder described with reference to FIGS. 8 to 11;

FIG. 13 illustrates operation timings of a left accumulative adder and a right accumulative adder shown in FIG. 7;

FIG. 14 is a block diagram illustrating an artificial intelligence accelerator according to another embodiment of the present disclosure;

FIG. 15 is a block diagram illustrating an example of a configuration of a left multiplication/addition circuit included in the artificial intelligence accelerator of FIG. 14;

FIG. 16 is a block diagram illustrating an example of a configuration of a right multiplication/addition circuit included in the artificial intelligence accelerator of FIG. 14;

FIG. 17 is a block diagram illustrating an artificial intelligence accelerator according to yet another embodiment of the present disclosure;

FIG. 18 is a block diagram illustrating an example of a configuration of a first MAC unit included in the artificial intelligence accelerator of FIG. 17;

FIG. 19 is a block diagram illustrating another example of a configuration of a first MAC unit included in the artificial intelligence accelerator of FIG. 17;

FIG. 20 illustrates a matrix multiplying calculation executed by a MAC operation of the artificial intelligence accelerator of FIG. 17;

FIG. 21 is a block diagram illustrating an adder circuit according to an embodiment of the present disclosure.

FIG. 22 is a circuit diagram illustrating one example of a negative number processing circuit included in the adder circuit of FIG. 21.

FIG. 23 is a block diagram illustrating one example of a first full-adder of an adder tree included in the adder circuit of FIG. 21.

FIG. 24 is a diagram illustrating an addition operation of an adding logic included in the first full-adder of FIG. 23.

FIG. 25 is a diagram illustrating a LSB addition process of an output circuit included in the first full-adder of FIG. 23.

FIG. 26 is a diagram illustrating one example of an output circuit included in the first full-adder of FIG. 23.

FIG. 27 is a block diagram illustrating one example of a first half-adder of an adder tree included in the adder circuit of FIG. 21.

FIG. 28 is a diagram illustrating an addition operation of an adding logic included in the first half-adder of FIG. 27.

FIG. 29 is a diagram illustrating a LSB addition process of an output circuit included in the first half-adder of FIG. 27.

FIG. 30 is a block diagram illustrating one example of a third full-adder of an adder tree included in the adder circuit of FIG. 21.

FIG. 31 is a diagram illustrating an addition operation of an adding logic included in the third full-adder of FIG. 30.

FIG. 32 is a diagram illustrating a LSB addition process of the output circuit included in the third full-adder of FIG. 30.

FIG. 33 is a block diagram illustrating one example of a fourth full-adder of an adder tree included in the adder circuit of FIG. 21.

FIG. 34 is a diagram illustrating an addition operation of an adding logic included in the fourth full-adder of FIG. 33.

FIG. 35 is a diagram illustrating a LSB addition process of an output circuit included in the fourth full-adder of FIG. 33.

FIG. 36 is a block diagram illustrating one example of a second half-adder of an adder tree included in the adder circuit of FIG. 21.

FIG. 37 is a diagram illustrating an addition operation of an adding logic included in the second half-adder of FIG. 36.

FIG. 38 is a block diagram illustrating an adder circuit according to other example of the present disclosure.

FIG. 39 is a block diagram illustrating an adder circuit according to another example of the present disclosure.

FIG. 40 is a block diagram illustrating one example of a third full-adder included in an adder tree of the adder circuit of FIG. 39.

FIG. 41 is a diagram illustrating a LSB addition process of a first input circuit included in the third full-adder of FIG. 40.

FIG. 42 is a diagram illustrating one example of a first input circuit configuration included in the third full-adder of FIG. 40.

FIG. 43 is a diagram illustrating an addition operation of an addition logic circuit included in the third full-adder of FIG. 40.

FIG. 44 is a block diagram illustrating one example of a fourth full-adder included in an adder tree of the adder circuit of FIG. 39.

FIG. 45 is a block diagram illustrating an adder circuit according to another example of the present disclosure.

### DETAILED DESCRIPTION OF THE EMBODIMENTS

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure. Although the following embodiments are described in conjunction with dynamic random access memory (DRAM) devices, it may be apparent to those of ordinary skill in the art that the present disclosure is not limited to the DRAM devices. For example, the following embodiments may be equally applied to various memory devices such as an SRAM, a synchronous DRAM (SDRAM), a double data rate synchronous DRAM (DDR SDRAM, DDR2 SDRAM, or DDR3 SDRAM), a graphic double data rate synchronous DRAM (GDDR, GDDR2, GDDR3, or the like), a quad data rate DRAM (QDR DRAM), a Rambus extreme data rate DRAM (Rambus XDR DRAM), a fast page mode DRAM (FPM DRAM), a video DRAM (VDRAM), an extended data output DRAM (EDO DRAM), a burst extended data output DRAM (BEDO DRAM), a multibank DRAM (MDRAM), a synchronous graphic RAM (SGRAM), or another type DRAM.

Various embodiments are directed to artificial intelligence accelerators.

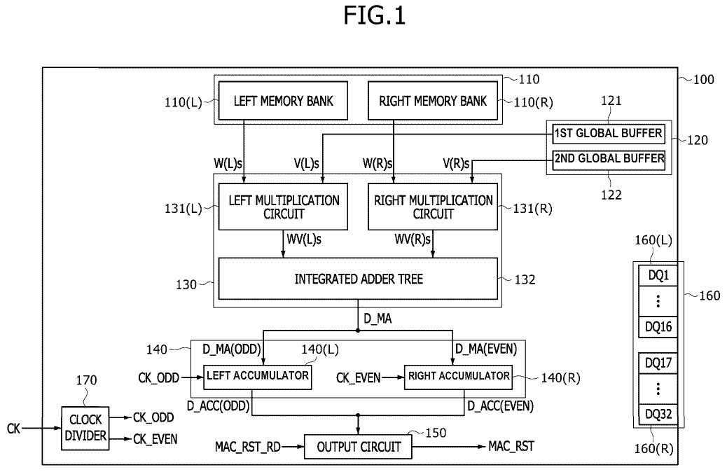

FIG. 1 is a block diagram illustrating an artificial intelligence (AI) accelerator 100 according to an embodiment of the present disclosure. In an embodiment, the AI accelerator 100 may have a processing-in-memory (PIM) structure performing an arithmetic operation in a memory structural device. Alternatively, the AI accelerator 100 may have a structure of a graphic processing unit (GPU), an application specific integrated circuit (ASIC) specified to deep learning operations, or a field programmable gate array (FPGA) based on a programmable logic. Hereinafter, the following embodiments will be described in conjunction with a case that the AI accelerator 100 performs a MAC operation. However, the following embodiments may be merely some examples of the present disclosure. Accordingly, the AI accelerator 100 may be configured to perform other arithmetic operations (including an accumulative adding calculation) other than the MAC operation.

Referring to FIG. 1, the AI accelerator 100 may include a first memory circuit 110, a second memory circuit 120, a multiplication circuit/adder tree 130, an accumulative addition circuit 140, an output circuit 150, a data input/output (I/O) circuit 160, a clock divider 170.

The first memory circuit 110 may include a left memory bank 110(L) and a right memory bank 110(R) which are disposed to be physically distinguished from each other. The left memory bank 110(L) and the right memory bank 110(R) may have substantially the same memory size. The left memory bank 110(L) may store left weight data W(L)s used for a MAC operation, and the right memory bank 110(R) may store right weight data W(R)s used for the MAC operation. The left memory bank 110(L) may transmit the left weight data W(L)s to the multiplication circuit/adder tree 130 in response to a control signal for controlling the MAC operation, and the right memory bank 110(R) may transmit the right weight data W(R)s to the multiplication circuit/adder tree 130 in response to a control signal for controlling the MAC operation.

The second memory circuit 120 may include a first global buffer 121 and a second global buffer 122. The first global buffer 121 may store left vector data V(L)s used for the MAC operation, and the second global buffer 122 may store right vector data V(R)s used for the MAC operation. The first global buffer 121 may transmit the left vector data V(L)s to the multiplication circuit/adder tree 130 in response to a control signal for controlling the MAC operation, and the second global buffer 122 may transmit the right vector data V(R)s to the multiplication circuit/adder tree 130 in response to a control signal for controlling the MAC operation. Although not shown in FIG. 1, the left vector data V(L)s and the right vector data V(R)s may be transmitted from the first global buffer 121 and the second global buffer 122 to the multiplication circuit/adder tree 130 through a global data I/O line (GIO).

The multiplication circuit/adder tree 130 may perform a multiplying calculation and an adding calculation using the weight data W(L)s and W(R)s and the vector data V(L)s ad V(R)s outputted from the first and second memory circuits 110 and 120 as input data, thereby generating and outputting multiplication/addition result data D_MA. The multiplication circuit/adder tree 130 may include a left multiplication circuit 131(L), a right multiplication circuit 131(R), and an integrated adder tree 132. The left multiplication circuit 131(L) may receive the left weight data W(L)s and the left vector data V(L)s from respective ones of the left memory bank 110(L) and the first global buffer 121. The left multiplication circuit 131(L) may perform a multiplying calculation on the left weight data W(L)s and the left vector data V(L)s to generate and output left multiplication result data WV(L)s. The right multiplication circuit 131(R) may receive the right weight data W(R)s and the right vector data V(R)s from respective ones of the right memory bank 110(R) and the second global buffer 122. The right multiplication circuit 131(R) may perform a multiplying calculation on the right weight data W(R)s and the right vector data V(R)s to generate and output right multiplication result data WV(R)s. The left multiplication result data WV(L)s and the right multiplication result data WV(R)s may be transmitted to the integrated adder tree 132. The integrated adder tree 132 may perform an adding calculation on the left multiplication result data WV(L)s and the right multiplication result data WV(R)s outputted from respective ones of the left multiplication circuit 131(L) and the right multiplication circuit 131(R), thereby generating and outputting the multiplication/addition result data D_MA.

The accumulative addition circuit 140 may perform an accumulative adding calculation for adding the multiplication/addition result data D_MA outputted from the multiplication circuit/adder tree 130 to latched data generated by a previous accumulative adding calculation, thereby generating and outputting accumulated data D_ACC. The accumulative addition circuit 140 may include a left accumulator 140(L) and a right accumulator 140(R). The left accumulator 140(L) and the right accumulator 140(R) may alternately receive the multiplication/addition result data D_MA from the multiplication circuit/adder tree 130. For example, the left accumulator 140(L) may receive odd-numbered multiplication/addition result data D_MA(ODD) from the multiplication circuit/adder tree 130, and the right accumulator 140(R) may receive even-numbered multiplication/addition result data D_MA(EVEN) from the multiplication circuit/adder tree 130. The left accumulator 140(L) may perform an accumulative adding calculation for adding the odd-numbered multiplication/addition result data D_MA(ODD) outputted from the multiplication circuit/adder tree 130 to the latched data generated by a previous accumulative adding calculation, thereby generating and outputting odd-numbered accumulated data D_ACC(ODD). The accumulative adding calculation of the left accumulator 140(L) may be performed in synchronization with an odd clock signal CK_ODD. The right accumulator 140(R) may perform an accumulative adding calculation for adding the even-numbered multiplication/addition result data D_MA(EVEN) outputted from the multiplication circuit/adder tree 130 to the latched data generated by a previous accumulative adding calculation, thereby generating and outputting even-numbered accumulated data D_ACC(EVEN). The accumulative adding calculation of the right accumulator 140(R) may be performed in synchronization with an even clock signal CK_EVEN.

The output circuit 150 may receive the odd-numbered accumulated data D_ACC(ODD) or the even-numbered accumulated data D_ACC(EVEN) from the accumulative addition circuit 140. The output circuit 150 may output the odd-numbered accumulated data D_ACC(ODD) or the even-numbered accumulated data D_ACC(EVEN) as MAC result data MAC_RST corresponding to a result of a final MAC operation in response to a MAC result read signal MAC_RST_RD having a first logic level such as a logic “high” level. A logic level of the MAC result read signal MAC_RST_RD may change from a logic “low” level into a logic “high” level when the odd-numbered accumulated data D_ACC(ODD) or the even-numbered accumulated data D_ACC(EVEN) generated by termination of the MAC operations on all of the weight data W(L)s and W(R)s and all of the vector data V(L)s and V(R)s are transmitted to the output circuit 150.

The data I/O circuit 160 may provide a means for data transmission between the AI accelerator 100 and an external device such as a host or a controller. The data I/O circuit 160 may include left data I/O terminals 160(L) and right data I/O terminals 160(R). The left data I/O terminals 160(L) may provide transmission paths of read data outputted from the left memory bank 110(L) or write data inputted to the left memory bank 110(L). In an embodiment, the left data I/O terminals 160(L) may include a plurality of data I/O terminals, for example, first to sixteenth data I/O terminals DQ1˜DQ16. The right data I/O terminals 160(R) may provide transmission paths of read data outputted from the right memory bank 110(R) or write data inputted to the right memory bank 110(R). In an embodiment, the right data I/O terminals 160(R) may include a plurality of data I/O terminals, for example, seventeenth to 32^{nd} data I/O terminals DQ17˜DQ32. The left data I/O terminals 160(L) and the right data I/O terminals 160(R) may provide transmission paths of the MAC result data MAC_RST outputted from the output circuit 150.

The clock divider 170 may divide a clock signal CK inputted to the AI accelerator 100 to generate and output the odd clock signal CK_ODD and the even clock signal CK_EVEN. The odd clock signal CK_ODD may be comprised of only odd pulses among pulses of the clock signal CK, and the even clock signal CK_EVEN may be comprised of only even pulses among the pulses of the clock signal CK. Thus, each of the odd clock signal CK_ODD and the even clock signal CK_EVEN may have a cycle which is twice a cycle of the clock signal CK. In an embodiment, the clock divider 170 may delay the clock signal CK by a certain time to generate and output the odd clock signal CK_ODD and the even clock signal CK_EVEN having a cycle which is twice a cycle of the clock signal CK. The clock divider 170 may transmit the odd clock signal CK_ODD to the left accumulator 140(L) of the accumulative addition circuit 140 and may transmit the even clock signal CK_EVEN to the right accumulator 140(R) of the accumulative addition circuit 140.

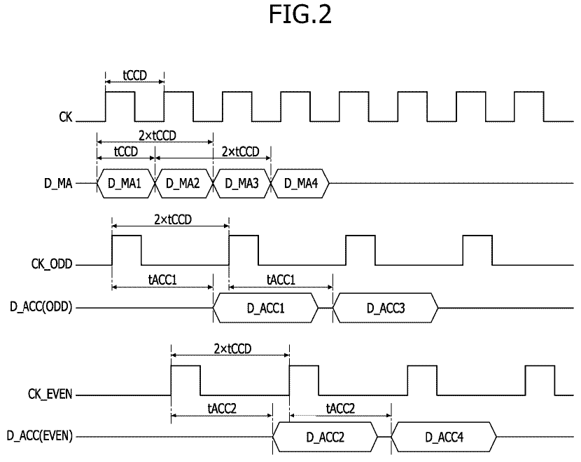

FIG. 2 is a timing diagram illustrating an accumulative adding calculation of the accumulative addition circuit 140 included in the AI accelerator 100 of FIG. 1. In the present embodiment, it may be assumed that the clock signal CK inputted to the clock divider 170 may have a cycle which is equal to a CAS to CAS delay time “tCCD” corresponding to an interval time between column addresses. In addition, it may be assumed that a time it takes the multiplication circuit/adder tree 130 to perform a multiplying calculation and an adding calculation is shorter than the CAS to CAS delay time “tCCD”.

Referring to FIGS. 1 and 2, first to fourth multiplication/addition result data D_MA1˜D_MA4 outputted from the multiplication circuit/adder tree 130 may be alternately transmitted to the left accumulator 140(L) and the right accumulator 140(R). Thus, the odd-numbered multiplication/addition result data D_MA(ODD) (i.e., the first and third multiplication/addition result data D_MA1 and D_MA3) may be transmitted to the left accumulator 140(L), and the even-numbered multiplication/addition result data D_MA(EVEN) (i.e., the second and fourth multiplication/addition result data D_MA2 and D_MA4) may be transmitted to the right accumulator 140(R). In an embodiment, the first to fourth multiplication/addition result data D_MA1˜D_MA4 may be outputted from the multiplication circuit/adder tree 130 at an interval time of the CAS to CAS delay time “tCCD”. Accordingly, the left accumulator 140(L) may receive the first and third multiplication/addition result data D_MA1 and D_MA3 at an interval time of twice the CAS to CAS delay time “tCCD”. Similarly, the right accumulator 140(R) may receive the second and fourth multiplication/addition result data D_MA2 and D_MA4 at an interval time of twice the CAS to CAS delay time “tCCD”.

The left accumulator 140(L) may be synchronized with a first pulse of the odd clock signal CK_ODD to perform an accumulative adding calculation on the first multiplication/addition result data D_MA1 and the latched data. The first pulse of the odd clock signal CK_ODD may be generated at a point in time when a certain time elapses from a point in time when a first pulse of the clock signal CK occurs. Because a first accumulative adding calculation is performed, a latch circuit of the left accumulator 140(L) may be reset to have a value of zero as the latched data. Thus, the left accumulator 140(L) may terminate the accumulative adding calculation at a point in time when a first accumulative addition time “tACC1” elapses from a point in time when the first pulse of the odd clock signal CK_ODD is generated, thereby generating first accumulated data D_ACC1 as first odd-numbered accumulated data D_ACC(ODD). The first accumulative addition time “tACC1” may mean a time it takes the left accumulator 140(L) to perform an accumulative adding calculation. The first accumulated data D_ACC1 may be used as latched data during a next accumulative adding calculation of the left accumulator 140(L).

The right accumulator 140(R) may be synchronized with a first pulse of the even clock signal CK_EVEN to perform an accumulative adding calculation on the second multiplication/addition result data D_MA2 and the latched data. The first pulse of the even clock signal CK_EVEN may be generated at a point in time when a certain time elapses from a point in time when a second pulse of the clock signal CK occurs. Because the first accumulative adding calculation is performed, a latch circuit of the right accumulator 140(R) may also be reset to have a value of zero as the latched data. Thus, the right accumulator 140(R) may terminate the accumulative adding calculation at a point in time when a second accumulative addition time “tACC2” elapses from a point in time when the first pulse of the even clock signal CK_EVEN is generated, thereby generating second accumulated data D_ACC2 as first even-numbered accumulated data D_ACC(EVEN). The second accumulative addition time “tACC2” may mean a time it takes the right accumulator 140(R) to perform an accumulative adding calculation. The second accumulated data D_ACC2 may be used as latched data during a next accumulative adding calculation of the right accumulator 140(R).

The left accumulator 140(L) may be synchronized with a second pulse of the odd clock signal CK_ODD to perform an accumulative adding calculation on the third multiplication/addition result data D_MA3 and the latched data (i.e., the first accumulated data D_ACC1). The second pulse of the odd clock signal CK_ODD may be generated at a point in time when a certain time elapses from a point in time when a third pulse of the clock signal CK occurs. The left accumulator 140(L) may terminate the accumulative adding calculation at a point in time when the first accumulative addition time “tACC1” elapses from a point in time when the second pulse of the odd clock signal CK_ODD is generated, thereby generating third accumulated data D_ACC3 as second odd-numbered accumulated data D_ACC(ODD). The third accumulated data D_ACC3 may be used as latched data during a next accumulative adding calculation of the left accumulator 140(L).

The right accumulator 140(R) may be synchronized with a second pulse of the even clock signal CK_EVEN to perform an accumulative adding calculation on the fourth multiplication/addition result data D_MA4 and the latched data (i.e., the second accumulated data D_ACC2). The second pulse of the even clock signal CK_EVEN may be generated at a point in time when a certain time elapses from a point in time when a fourth pulse of the clock signal CK occurs. The right accumulator 140(R) may terminate the accumulative adding calculation at a point in time when the second accumulative addition time “tACC2” elapses from a point in time when the second pulse of the even clock signal CK_EVEN is generated, thereby generating fourth accumulated data D_ACC4 as second even-numbered accumulated data D_ACC(EVEN). The fourth accumulated data D_ACC4 may be used as latched data during a next accumulative adding calculation of the right accumulator 140(R).

As described above, the first accumulative addition time “tACC1” it takes the left accumulator 140(L) to perform the accumulative adding calculation may be longer than the CAS to CAS delay time “tCCD” and may be shorter than twice the CAS to CAS delay time “tCCD”. Similarly, the second accumulative addition time “tACC2” it takes the right accumulator 140(R) to perform the accumulative adding calculation may also be longer than the CAS to CAS delay time “tCCD” and may be shorter than twice the CAS to CAS delay time “tCCD”. In general, in the event that the multiplication/addition result data D_MA are generated at an interval time of the CAS to CAS delay time “tCCD” and the accumulative addition time “tACC” is longer than the CAS to CAS delay time “tCCD”, a point in time when the multiplication/addition result data D_MA are transmitted to an accumulative adder of an accumulator is inconsistent with a point in time when the latched data are transmitted to the accumulative adder of the accumulator. Thus, in such a case, it may be necessary to adjust the CAS to CAS delay time “tCCD” during the MAC operation. However, in case of the AI accelerator 100 according to the present embodiment, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), a left MAC operator and a right MAC operator may be disposed to be allocated to respective ones of the left memory bank 110(L) and the right memory bank 110(R). Each of the left MAC operator and the right MAC operator may include an accumulator. In the AI accelerator 100 according to the present embodiment, the left accumulator 140(L) may be realized using an accumulator included in the left MAC operator, and the right accumulator 140(R) may be realized using an accumulator included in the right MAC operator. Thus, it may be unnecessary to additionally dispose accumulators occupying a relatively large area in the AI accelerator 100. Accordingly, it may be possible to realize compact AI accelerators.

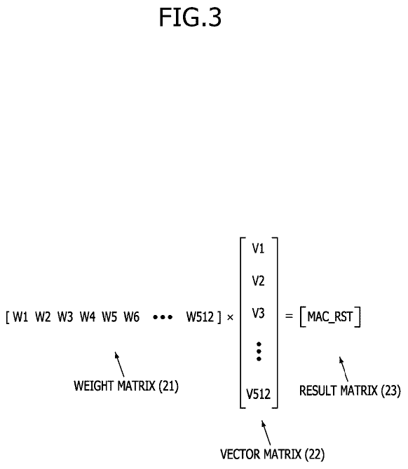

FIG. 3 illustrates an example of a matrix multiplying calculation executed by a MAC operation of the AI accelerator 100 of FIG. 1. Referring to FIG. 3, the AI accelerator 100 may perform a matrix-vector multiplying calculation on a weight matrix 21 and a vector matrix 22 to generate a result matrix 23. The present embodiment will be described in conjunction with a case that the weight matrix 21 is a ‘1×512’ matrix having one row and 512 columns, the vector matrix 22 is a ‘512×1’ matrix having 512 rows and one column, and the result matrix 23 is a ‘1×1’ matrix having one row and one column. The weight matrix 21 may have 512 elements corresponding to 512 sets of weight data W1˜W512 (i.e., first to 512^{th} weight data W1˜W512). The vector matrix 22 may also have 512 elements corresponding to 512 sets of vector data V1˜V512 (i.e., first to 512^{th} vector data V1˜V512). The result matrix 23 may have one element corresponding to one set of the MAC result data MAC_RST. The MAC result data MAC_RST of the result matrix 23 may be generated by a matrix-vector multiplying calculation on the weight data W1˜W512 and the vector data V1˜V512. Hereinafter, it may be assumed that each of the first to 512^{th} weight data W1˜W512 and each of the first to 512^{th} vector data V1˜V512 have an IEEE 754 format (i.e., 32-bit single-precision floating-point format).

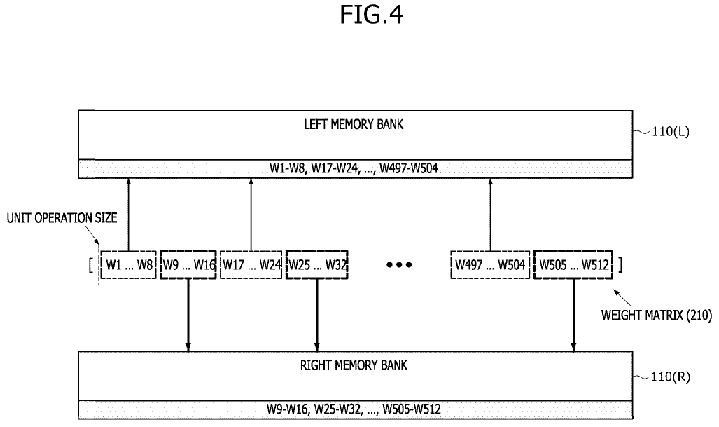

FIG. 4 illustrates a process of storing the weight data W1˜W512 of FIG. 3 into the left memory bank 110(L) and the right memory bank 110(R) included in the AI accelerator 100 of FIG. 1. As described with reference to FIG. 1, the weight data W1˜W512 used for the MAC operation may be stored in the left memory bank 110(L) and the right memory bank 110(R). Hereinafter, the weight data stored in the left memory bank 110(L) will be referred to as ‘left weight data’, and the weight data stored in the right memory bank 110(R) will be referred to as ‘right weight data’.

Referring to FIG. 4, the weight data W1˜W512 of the weight matrix 21 illustrated in FIG. 3 may be evenly allocated to the left memory bank 110(L) and the right memory bank 110(R) by a unit operation size. The unit operation size may be defined as a size of the weigh data (or the vector data) which are used for a single MAC operation of the AI accelerator 100 illustrated in FIG. 1. The unit operation size may be determined according to a hardware configuration of the multiplication circuit/adder tree 130 included in the AI accelerator 100. Hereinafter, it may be assumed that a size (i.e., the unit operation size) of the weight data processed by a single arithmetic operation of the multiplication circuit/adder tree 130 is 512 bits. As described with reference to FIG. 3, because each set of the plural sets of the weight data W1˜W512 and the plural sets of the vector data V1˜V512 has 32 bits, 16 sets of the weight data may be processed by a single MAC operation of the AI accelerator 100. In such a case, the first to 512^{th} weight data W1˜W512 may be evenly allocated to both of the left memory bank 110(L) and the right memory bank 110(R) in units of 16 sets of the weight data.

Specifically, a first group of 16 sets of the weight data (i.e., the first to sixteenth weight data W1˜W16 may be evenly allocated to and stored in the left memory bank 110(L) and the right memory bank 110(R). That is, the first to eighth weight data W1˜W8 may be stored in the left memory bank 110(L), and the ninth to sixteenth weight data W9˜W16 may be stored in the right memory bank 110(R). A second group of 16 sets of the weight data (i.e., the seventeenth to 32^{nd} weight data W17˜W32) may also be evenly allocated to and stored in the left memory bank 110(L) and the right memory bank 110(R). That is, the seventeenth to 24^{th} weight data W17˜W24 may be stored in the left memory bank 110(L), and the 25^{th} to 32^{nd} weight data W25˜W32 may be stored in the right memory bank 110(R). Similarly, a 32^{nd} group of 16 sets of the weight data (i.e., the 497^{th} to 512^{th} weight data W497˜W512) may also be evenly allocated to and stored in the left memory bank 110(L) and the right memory bank 110(R). That is, the 497^{th} to 504^{th} weight data W497˜W504 may be stored in the left memory bank 110(L), and the 505^{th} to 512^{th} weight data W505˜W512 may be stored in the right memory bank 110(R).

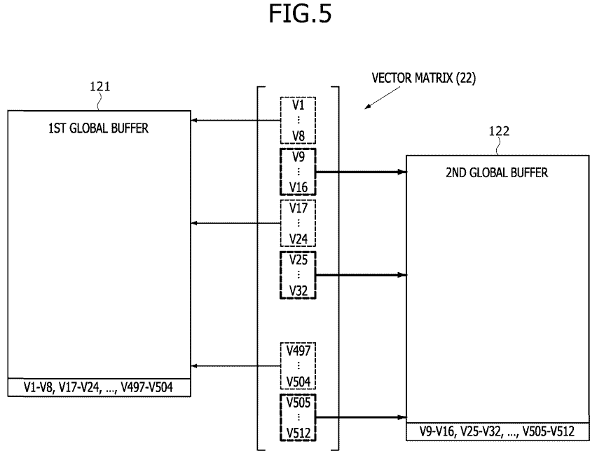

FIG. 5 illustrates a process of storing the vector data V1˜V512 of FIG. 3 into the first global buffer 121 and the second global buffer 122 included in the AI accelerator 100 of FIG. 1. Referring to FIG. 5, the vector data V1˜V512 the vector matrix 22 illustrated in FIG. 3 may be evenly allocated to the first global buffer 121 and the second global buffer 122 by the unit operation size. Because the unit operation size is defined as 512 bits in the present embodiment, the first to 512^{th} vector data V1˜V512 may be evenly allocated to both of the first global buffer 121 and the second global buffer 122 in units of 16 sets of the vector data. Specifically, a first group of 16 sets of the vector data (i.e., the first to sixteenth vector data V1˜V16 may be evenly allocated to and stored in the first global buffer 121 and the second global buffer 122. That is, the first to eighth vector data V1˜V8 may be stored in the first global buffer 121, and the ninth to sixteenth vector data V9˜V16 may be stored in the second global buffer 122. A second group of 16 sets of the vector data (i.e., the seventeenth to 32^{nd} vector data V17˜V32) may also be evenly allocated to and stored in the first global buffer 121 and the second global buffer 122. That is, the seventeenth to 24^{th} weight data V17˜V24 may be stored in the first global buffer 121, and the 25^{th} to 32^{nd} vector data W25˜W32 may be stored in the second global buffer 122. Similarly, a 32^{nd} group of 16 sets of the vector (i.e., the 497^{th} to 512^{th} vector data V497˜V512) may also be evenly allocated to and stored in the first global buffer 121 and the second global buffer 122. That is, the 497^{th} to 504^{th} vector data V497˜V504 may be stored in the first global buffer 121, and the 505^{th} to 512^{th} vector data V505˜V512 may be stored in the second global buffer 122.

In case of the present embodiment, because a single MAC operation is performed using 16 sets of the weight data and 16 sets of the vector data as input data, it may be necessary to iteratively perform the MAC operation 32 times in order to generate the MAC result data MAC_RST of the result matrix 23 illustrated in FIG. 3. A first MAC operation of the 32 MAC operations may be performed using the first group of 16 sets of the weight data W1˜W16 and the first group of 16 sets of the vector data V1˜V16 as input data. In such a case, the left memory bank 110(L) may transmit the first to eight weight data W1˜W8 to the left multiplication circuit 131(L), and the right memory bank 110(R) may transmit the ninth to sixteenth weight data W9˜W16 to the right multiplication circuit 131(R). In addition, the first global buffer 121 may transmit the first to eight vector data V1˜V8 to the left multiplication circuit 131(L), and the second global buffer 122 may transmit the ninth to sixteenth vector data V9˜V16 to the right multiplication circuit 131(R).

A second MAC operation of the 32 MAC operations may be performed using the second group of 16 sets of the weight data W17˜W32 and the second group of 16 sets of the vector data V17˜V32 as input data. In such a case, the left memory bank 110(L) may transmit the seventeenth to 24^{th} weight data W17˜W24 to the left multiplication circuit 131(L), and the right memory bank 110(R) may transmit the 25^{th} to 32^{nd} weight data W25˜W32 to the right multiplication circuit 131(R). In addition, the first global buffer 121 may transmit the seventeenth to 24^{th} vector data V17˜V24 to the left multiplication circuit 131(L), and the second global buffer 122 may transmit the 25^{th} to 32^{nd} vector data V25˜V32 to the right multiplication circuit 131(R). Similarly, a 32^{nd} MAC operation corresponding to the last MAC operation of the 32 MAC operations may be performed using the 32^{nd} group of 16 sets of the weight data W497˜W512 and the 32^{nd} group of 16 sets of the vector data V497˜V512 as input data. In such a case, the left memory bank 110(L) may transmit the 497^{th} to 504^{th} weight data W497˜W504 to the left multiplication circuit 131(L), and the right memory bank 110(R) may transmit the 505^{th} to 512^{th} weight data W505˜W512 to the right multiplication circuit 131(R). In addition, the first global buffer 121 may transmit the 497^{th} to 504^{th} vector data V497˜V504 to the left multiplication circuit 131(L), and the second global buffer 122 may transmit the 505^{th} to 512^{th} vector data V505˜V512 to the right multiplication circuit 131(R).

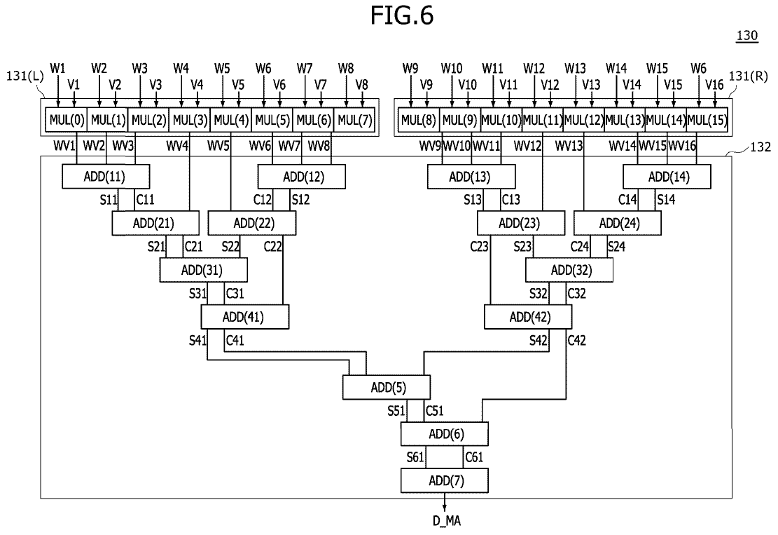

FIG. 6 is a block diagram illustrating an example of configurations and operations of the left multiplication circuit 131(L), the right multiplication circuit 131(R), and the integrated adder tree 132 included in the AI accelerator 100 of FIG. 1. Referring to FIG. 6, the left multiplication circuit 131(L) may include a plurality of multipliers, for example, first to eighth multipliers MUL(0)˜MUL(7). The first to eighth multipliers MUL(0)˜MUL(7) may receive the first to eighth weight data W1-W8 from the left memory bank 110(L), respectively. In addition, the first to eighth multipliers MUL(0)˜MUL(7) may receive the first to eighth vector data V1˜V8 from the first global buffer (121 of FIG. 1), respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The right multiplication circuit 131(R) may include a plurality of multipliers, for example, ninth to sixteenth multipliers MUL(8)˜MUL(15). The ninth to sixteenth multipliers MUL(8)˜MUL(15) may receive the ninth to sixteenth weight data W9˜W16 from the right memory bank 110(R), respectively. In addition, the ninth to sixteenth multipliers MUL(8)˜MUL(15) may receive the ninth to sixteenth vector data V9˜V16 from the second global buffer (122 of FIG. 1), respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1.

The first to eighth multipliers MUL(0)˜MUL(7) of the left multiplication circuit 131(L) may perform multiplying calculations on the first to eighth weight data W1˜W8 and the first to eighth vector data V1˜V8 to generate first to eighth multiplication result data WV1˜WV8. For example, the first multiplier MUL(0) may perform a multiplying calculation on the first weight data W1 and the first vector data V1 to generate the first multiplication result data WV1, and the second multiplier MUL(1) may perform a multiplying calculation on the second weight data W2 and the second vector data V2 to generate the second multiplication result data WV2. In the same way, the third to eighth multipliers MUL(2)˜MUL(7) may also perform multiplying calculations on the third to eighth weight data W3-W8 and the third to eighth vector data V3˜V8 to generate the third to eighth multiplication result data WV3˜WV8. The first to eighth multiplication result data WV1˜WV8 outputted from the first to eighth multipliers MUL(0)˜MUL(7) may be transmitted to the integrated adder tree 132.

The ninth to sixteenth multipliers MUL(8)˜MUL(15) of the right multiplication circuit 131(R) may perform multiplying calculations on the ninth to sixteenth weight data W9˜W15 and the ninth to sixteenth vector data V9˜V16 to generate ninth to sixteenth multiplication result data WV9˜WV16. For example, the ninth multiplier MUL(8) may perform a multiplying calculation on the ninth weight data W9 and the ninth vector data V9 to generate the ninth multiplication result data WV9, and the tenth multiplier MUL(9) may perform a multiplying calculation on the tenth weight data W10 and the tenth vector data V10 to generate the tenth multiplication result data WV10. In the same way, the eleventh to sixteenth multipliers MUL(10)˜MUL(15) may also perform multiplying calculations on the eleventh to sixteenth weight data W11˜W16 and the eleventh to sixteenth vector data V11˜V16 to generate the eleventh to sixteenth multiplication result data WV11˜WV16. The ninth to sixteenth multiplication result data WV9˜WV16 outputted from the ninth to sixteenth multipliers MUL(8)˜MUL(15) may be transmitted to the integrated adder tree 132.

The integrated adder tree 312 may perform an adding calculation on the first to eighth multiplication result data WV1˜WV8 outputted from the left multiplication circuit 131(L) and an adding calculation on the ninth to sixteenth multiplication result data WV9˜WV16 outputted from the right multiplication circuit 131(R). The integrated adder tree 312 may output the multiplication/addition result data D_MA as a result of the adding calculations. The integrated adder tree 312 may include a plurality of adders ADDs which are arrayed to have a hierarchical structure such as a tree structure. In the present embodiment, the integrated adder tree 312 may be comprised of a plurality of full-adders and a half-adder. However, the present embodiment is merely an example of the present disclosure. Accordingly, in some other embodiment, the integrated adder tree 312 may be comprised of only a plurality of half-adders. In the present embodiment, four full-adders ADD(11)˜ADD(14) may be disposed in a first stage located at a highest level of the integrated adder tree 312, and four full-adders ADD(21)˜ADD(24) may also be disposed in a second stage located at a second highest level of the integrated adder tree 312. In addition, two full-adders ADD(31) and ADD(32) may be disposed in a third stage located at a third highest level of the integrated adder tree 312, and two full-adders ADD(41) and ADD(42) may also be disposed in a fourth stage located at a fourth highest level of the integrated adder tree 312. Moreover, one full-adder ADD(5) may be disposed in a fifth stage located at a fifth highest level of the integrated adder tree 312, and one full-adder ADD(6) may also be disposed in a sixth stage located at a sixth highest level of the integrated adder tree 312. Furthermore, one half-adder ADD(7) may be disposed in a seventh stage located at a lowest level of the integrated adder tree 312.

The first full-adder ADD(11) in the first stage may perform an adding calculation on the first to third multiplication result data WV1˜WV3 outputted from the first to third multipliers MUL(0)˜MUL(2) of the left multiplication circuit 131(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 131(L), thereby generating and outputting added data S12 and a carry C12. The third full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 131(R), thereby generating and outputting added data S13 and a carry C13. The fourth full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 131(R), thereby generating and outputting added data S14 and a carry C14.

The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 131(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 131(L), thereby generating and outputting added data S22 and a carry C22. The third full-adder ADD(23) in the second stage may perform an adding calculation on the added data S13 and the carry C13 outputted from the third full-adder ADD(13) in the first stage and the twelfth multiplication result data WV12 outputted from the twelfth multiplier MUL(11) of the right multiplication circuit 131(R), thereby generating and outputting added data S23 and a carry C23. The fourth full-adder ADD(24) in the second stage may perform an adding calculation on the added data S14 and the carry C14 outputted from the fourth full-adder ADD(14) in the first stage and the thirteenth multiplication result data WV13 outputted from the thirteenth multiplier MUL(12) of the right multiplication circuit 131(R), thereby generating and outputting added data S24 and a carry C24.

The first full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The second full-adder ADD(32) in the third stage may perform an adding calculation on the added data S23 outputted from the third full-adder ADD(23) in the second stage and the added data S24 and the carry C24 outputted from the fourth full-adder ADD(24) in the second stage, thereby generating and outputting added data S32 and a carry C32.

The first full-adder ADD(41) in the fourth stage may perform an adding calculation on the added data S31 and the carry C31 outputted from the first full-adder ADD(31) in the third stage and the carry C(22) outputted from the second full-adder ADD(22) in the second stage, thereby generating and outputting added data S41 and a carry C41. The second full-adder ADD(42) in the fourth stage may perform an adding calculation on the carry (C23) outputted from the third full-adder ADD(23) in the second stage and the added data S32 and the carry C32 outputted from the second full-adder ADD(32) in the third stage, thereby generating and outputting added data S42 and a carry C42.

The full-adder ADD(5) in the fifth stage may perform an adding calculation on the added data S41 and the carry C41 outputted from the first full-adder ADD(41) in the fourth stage and the added data S42 outputted from the second full-adder ADD(42) in the fourth stage, thereby generating and outputting added data S51 and a carry C51. The full-adder ADD(6) in the sixth stage may perform an adding calculation on the added data S51 and the carry C51 outputted from the full-adder ADD(5) in the fifth stage and the carry C42 outputted from the second full-adder ADD(42) in the fourth stage, thereby generating and outputting added data S61 and a carry C61. The half-adder ADD(7) in the seventh stage may perform an adding calculation on the added data S61 and the carry C61 outputted from the full-adder ADD(6) in the sixth stage, thereby generating and outputting the multiplication/addition result data D_MA. The multiplication/addition result data D_MA outputted from the half-adder ADD(7) in the seventh stage may be transmitted to the accumulative addition circuit 140.

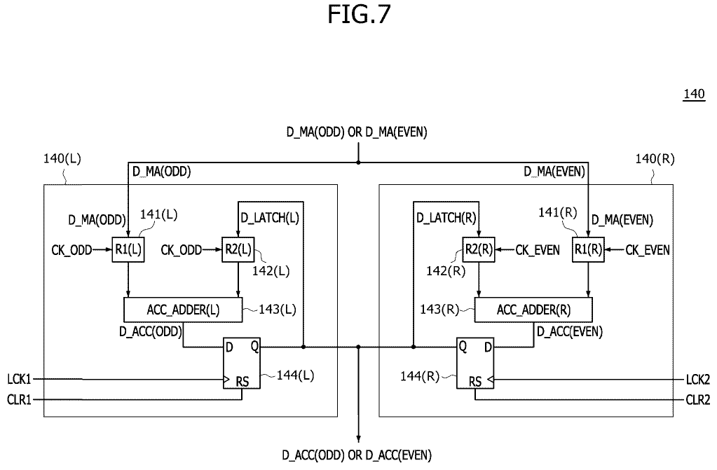

FIG. 7 is a block diagram illustrating an example of configurations and operations of the left accumulator 140(L) and the right accumulator 140(R) constituting the accumulative addition circuit 140 included in the AI accelerator 100 of FIG. 1. Referring to FIG. 7, the left accumulator 140(L) may include a first left register (R1(L)) 141(L), a second left register (R2(L)) 142(L), a left accumulative adder (ACC_ADDER(L)) 143(L), and a left latch circuit 144(L). The first left register 141(L) may receive the odd-numbered multiplication/addition result data D_MA(ODD) from the multiplication circuit/adder tree (130 of FIG. 1). The first left register 141(L) may be synchronized with the odd clock signal CK_ODD outputted from the clock divider (170 of FIG. 1) to transmit the odd-numbered multiplication/addition result data D_MA(ODD) to the left accumulative adder 143(L). The second left register 142(L) may receive left latched data D_LATCH(L) from the left latch circuit 144(L). The left latched data D_LATCH(L) may correspond to the odd-numbered accumulated data D_ACC(ODD) which are transmitted from the left accumulative adder 143(L) to the left latch circuit 144(L) and are latched by the left latch circuit 144(L) during a previous MAC operation. The second left register 142(L) may be synchronized with the odd clock signal CK_ODD outputted from the clock divider (170 of FIG. 1) to transmit the left latched data D_LATCH(L) to the left accumulative adder 143(L). In an embodiment, the second left register 142(L) may include an implied bit datum of “1.” into the left latched data D_LATCH(L) and may transmit the left latched data D_LATCH(L) including the implied bit datum to the left accumulative adder 143(L). In an embodiment, each of the first left register 141(L) and the second left register 142(L) may include at least one flip-flop.

The left accumulative adder 143(L) may perform an adding calculation on the odd-numbered multiplication/addition result data D_MA(ODD) outputted from the first left register 141(L) and the left latched data D_LATCH(L) outputted from the second left register 142(L) to generate the odd-numbered accumulated data D_ACC(ODD). The left accumulative adder 143(L) may transmit the odd-numbered accumulated data D_ACC(ODD) to an input terminal D of the left latch circuit 144(L). The left latch circuit 144(L) may latch the odd-numbered accumulated data D_ACC(ODD), which are inputted through the input terminal D, in response to a first latch clock signal LCK1 having a first logic level (e.g., a logic “high” level) inputted to a clock terminal of the left latch circuit 144(L). In addition, the left latch circuit 144(L) may output the latched data of the odd-numbered accumulated data D_ACC(ODD) through an output terminal Q of the left latch circuit 144(L) in response to the first latch clock signal LCK1 having the first logic level (e.g., a logic “high” level). Output data of the left latch circuit 144(L) may be fed back to the second left register 142(L) and may also be transmitted to the output circuit (150 of FIG. 1). When the left latch circuit 144(L) terminates latch operations of the MAC operations, the left latch circuit 144(L) may be reset in response to a first clear signal CLR1 having a logic “high” level.

The right accumulator 140(R) may include a first right register (R1(R)) 141(R), a second right register (R2(R)) 142(R), a right accumulative adder (ACC_ADDER(R)) 143(R), and a right latch circuit 144(R). The first right register 141(R) may receive the even-numbered multiplication/addition result data D_MA(EVEN) from the multiplication circuit/adder tree (130 of FIG. 1). The first right register 141(R) may be synchronized with the even clock signal CK_EVEN outputted from the clock divider (170 of FIG. 1) to transmit the even-numbered multiplication/addition result data D_MA(EVEN) to the right accumulative adder 143(R). The second right register 142(R) may receive right latched data D_LATCH(R) from the right latch circuit 144(R). The right latched data D_LATCH(R) may correspond to the even-numbered accumulated data D_ACC(EVEN) which are transmitted from the right accumulative adder 143(R) to the right latch circuit 144(R) and are latched by the right latch circuit 144(R) during a previous MAC operation. The second right register 142(R) may be synchronized with the even clock signal CK_EVEN outputted from the clock divider (170 of FIG. 1) to transmit the right latched data D_LATCH(R) to the right accumulative adder 143(R). In an embodiment, the second right register 142(R) may include an implied bit datum of “1.” into the right latched data D_LATCH(R) and may transmit the right latched data D_LATCH(R) including the implied bit datum to the right accumulative adder 143(R). In an embodiment, each of the first right register 141(R) and the second right register 142(R) may include at least one flip-flop.

The right accumulative adder 143(R) may perform an adding calculation on the even-numbered multiplication/addition result data D_MA(EVEN) outputted from the first right register 141(R) and the right latched data D_LATCH(R) outputted from the second right register 142(R) to generate the even-numbered accumulated data D_ACC(EVEN). The right accumulative adder 143(R) may transmit the even-numbered accumulated data D_ACC(EVEN) to an input terminal D of the right latch circuit 144(R). The right latch circuit 144(R) may latch the even-numbered accumulated data D_ACC(EVEN), which are inputted through the input terminal D, in response to a second latch clock signal LCK2 having the first logic level (e.g., a logic “high” level) inputted to a clock terminal of the right latch circuit 144(R). In addition, the right latch circuit 144(R) may output the latched data of the even-numbered accumulated data D_ACC(EVEN) through an output terminal Q of the right latch circuit 144(R) in response to the second latch clock signal LCK2 having the first logic level (e.g., a logic “high” level). Output data of the right latch circuit 144(R) may be fed back to the second right register 142(R) and may also be transmitted to the output circuit (150 of FIG. 1). When the right latch circuit 144(R) terminates latch operations of the MAC operations, the right latch circuit 144(R) may be reset in response to a second clear signal CLR2 having a logic “high” level.

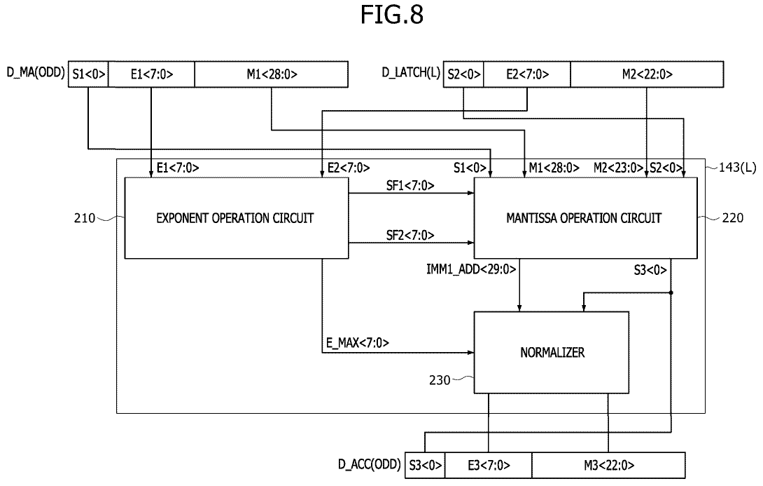

FIG. 8 is a block diagram illustrating an example of a configuration of the left accumulative adder 143(L) included in the left accumulator 140(L) shown in FIG. 7. The following descriptions on the left accumulative adder 143(L) may be equally applied to the right accumulative adder 143(R). In the present embodiment, it may be assumed that each of the first to 512^{th} weight data W1˜W512 and each of the first to 512^{th} vector data V1˜V512 have a 32-bit single-precision floating-point format, as described with reference to FIG. 3. Thus, each of the first to 512^{th} weight data W1˜W512 and each of the first to 512^{th} vector data V1˜V512 may be comprised of a sign datum having one bit, first exponent data having 8 bits, and mantissa data having 23 bits. The number of bits included in the mantissa data may increase during the adding calculation of the integrated adder tree 132 included in the multiplication circuit/adder tree 130. In the present embodiment, it may be assumed that the number of bits included in the mantissa data increases by six bits due to generation of carry bits during the adding calculation of the integrated adder tree 132 included in the multiplication circuit/adder tree 130. Accordingly, the odd-numbered multiplication/addition result data D_MA(ODD) may be comprised of a first sign datum S1<0> having one bit, first exponent data E1<7:0> having 8 bits, and first mantissa data M1<28:0> having 29 bits. Because the left latched data D_LATCH(L) are normalized during a previous additive adding calculation, the left latched data D_LATCH(L) may be comprised of a second sign datum S2<0> having one bit, second exponent data E2<7:0> having 8 bits, and second mantissa data M2<22:0> having 23 bits. An implied bit datum may be included in the second mantissa data M2<22:0> having 23 bits of the left latched data D_LATCH(L) before the second mantissa data M2<22:0> are inputted to the left accumulative adder 143(L). Thus, second mantissa data M2<23:0> having 24 bits may be inputted to the left accumulative adder 143(L).

Referring to FIG. 8, the left accumulative adder 143(L) may include an exponent operation circuit 210, a mantissa operation circuit 220, and a normalizer 230. The exponent operation circuit 210 may receive the first exponent data E1<7:0> of the odd-numbered multiplication/addition result data D_MA(ODD) from the first left register 141(L) and may also receive the second exponent data E2<7:0> of the left latched data D_LATCH(L) from the second left register 142(L). The exponent operation circuit 210 may perform an exponent operation on the first exponent data E1<7:0> and the second exponent data E2<7:0>. The exponent operation circuit 210 may generate and output maximum exponent data E_MAX<7:0>, first shift data SF1<7:0>, and second shift data SF2<7:0> as a result of the exponent operation. The maximum exponent data E_MAX<7:0> may correspond to data having a larger value out of the first shift data SF1<7:0> and the second shift data SF2<7:0>. The first shift data SF1<7:0> may have a first shift value corresponding to the number of bits that the first mantissa data M1<28:0> of the odd-numbered multiplication/addition result data D_MA(ODD) has to be shifted. The second shift data SF2<7:0> may have a second shift value corresponding to the number of bits that the second mantissa data M2<23:0> of the left latched data D_LATCH(L) has to be shifted. The first shift data SF1<7:0> and the second shift data SF2<7:0> outputted from the exponent operation circuit 210 may be transmitted to the mantissa operation circuit 220. The maximum exponent data E_MAX<7:0> outputted from the exponent operation circuit 210 may be transmitted to the normalizer 230.

The mantissa operation circuit 220 may receive the first sign datum S1<0> and the first mantissa data M1<28:0> of the odd-numbered multiplication/addition result data D_MA(ODD) from the first left register 141(L). The mantissa operation circuit 220 may also receive the second sign datum S2<0> and the second mantissa data M2<23:0> of the left latched data D_LATCH(L) from the second left register 142(L). In addition, the mantissa operation circuit 220 may receive the first shift data SF1<7:0> and the second shift data SF2<7:0> from the exponent operation circuit 210. The mantissa operation circuit 220 may perform a mantissa operation on the first mantissa data M1<28:0> and the second mantissa data M2<23:0> to generate a third sign datum S3<0> of the odd-numbered accumulated data D_ACC(ODD) and a first interim mantissa addition data IMM1_ADD<29:0>. The third sign datum S3<0> of the odd-numbered accumulated data D_ACC(ODD) and the first interim mantissa addition data IMM1_ADD<29:0> may be transmitted to the normalizer 230.

The normalizer 230 may receive the third sign datum S3<0> and the first interim mantissa addition data IMM1_ADD<29:0> from the mantissa operation circuit 220. In addition, the normalizer 230 may receive the maximum exponent data E_MAX<7:0> from the exponent operation circuit 210. The normalizer 230 may perform a normalization operation using the maximum exponent data E_MAX<7:0>, the first interim mantissa addition data IMM1_ADD<29:0>, and the third sign datum S3<0> as input data, thereby generating and outputting third exponent data E3<7:0> having 8 bits and third mantissa data M3<22:0> having 23 bits of the odd-numbered accumulated data D_ACC(ODD). The third sign datum S3<0> outputted from the mantissa operation circuit 220 and the third exponent data E3<7:0> and the third mantissa data M3<22:0> outputted from the normalizer 230 may be transmitted to the input terminal D of the left latch circuit 144(L), as described with reference to FIG. 7.

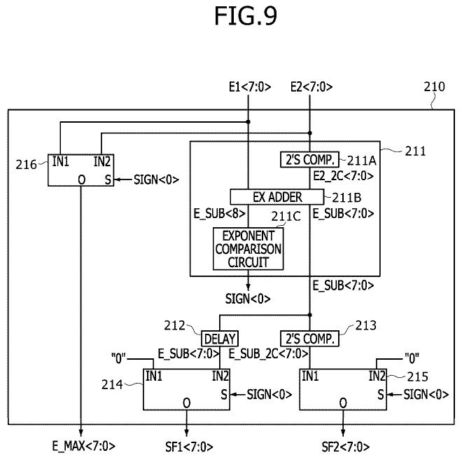

FIG. 9 is a block diagram illustrating an example of a configuration of the exponent operation circuit 210 included in the left accumulative adder 143(L) of FIG. 8. Referring to FIG. 9, the exponent operation circuit 210 may include an exponent subtraction circuit 211, a delay circuit 212, a 2's complement circuit 213, a first selector 214, a second selector 215, and a third selector 216. In an embodiment, each of the first to third selectors 214, 215, and 216 may include a 2-to-1 multiplexer. The exponent subtraction circuit 211 may include a 2's complement processor 211A, an exponent adder 211B, and an exponent comparison circuit 211C. In the present embodiment, the exponent adder 211B may be comprised of an adder for adding integers.

The exponent subtraction circuit 211 may receive the first exponent data E1<7:0> of the odd-numbered multiplication/addition result data D_MA(ODD) and the second exponent data E2<7:0> of the left latched data D_LATCH(L). The exponent subtraction circuit 211 may generate 2's complement data of the second exponent data E2<7:0> in order to perform an arithmetic operation (E1<7:0>-E2<7:0>) for subtracting the second exponent data E2<7:0> from the first exponent data E1<7:0>. Thereafter, the exponent subtraction circuit 211 may add the 2's complement data of the second exponent data E2<7:0> to the first exponent data E1<7:0>. More specifically, the first exponent data E1<7:0> may be transmitted to a first input terminal of the exponent adder 211B, and the second exponent data E2<7:0> may be transmitted to the 2's complement processor 211A. The 2's complement processor 211A may calculate a 2's complement value of the second exponent data E2<7:0> to generate and output 2's complement data E2_2C<7:0> of the second exponent data E2<7:0>. The 2's complement data E2_2C<7:0> of the second exponent data E2<7:0> may be transmitted to a second input terminal of the exponent adder 211B.

The exponent adder 211B may add the 2's complement data E2_2C<7:0> of the second exponent data E2<7:0> to the first exponent data E1<7:0> to generate exponent subtraction data E_SUB<8:0> having 9 bits. The exponent adder 211B may separate the exponent subtraction data E_SUB<8:0> into two parts of a most significant bit (MSB) datum E_SUB<8> and 8-bit low-order data E_SUB<7:0> obtained by removing the MSB datum E_SUB<8> from the exponent subtraction data E_SUB<8:0>. The exponent adder 211B may transmit the MSB datum E_SUB<8> to the exponent comparison circuit 211C and may transmit the 8-bit low-order data E_SUB<7:0> to the delay circuit 212 and the 2's complement circuit 213.

The exponent comparison circuit 211C may compare a value of the first exponent data E1<7:0> with a value of the second exponent data E2<7:0> using the MSB datum E_SUB<8> outputted from the exponent adder 211B and may generate and output a sign signal SIGN<0> as the comparison result. Specifically, when a value of the first exponent data E1<7:0> is greater than a value of the second exponent data E2<7:0>, roundup may occur during the adding calculation of the exponent adder 211B. In such a case, the MSB datum E_SUB<8> may have a binary number of “1”. When the MSB datum E_SUB<8> has a binary number of “1”, the exponent comparison circuit 211C may output the sign signal SIGN<0> having a logic “low” level (e.g., a binary number of “0”) which denotes that the 8-bit low-order data E_SUB<7:0> are a positive number. In such a case, the second mantissa data M2<23:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. In contrast, when a value of the first exponent data E1<7:0> is less than a value of the second exponent data E2<7:0>, no roundup occurs during the adding calculation of the exponent adder 211B. In such a case, the MSB datum E_SUB<8> may have a binary number of “0”. When the MSB datum E_SUB<8> has a binary number of “0”, the exponent comparison circuit 211C may output the sign signal SIGN<0> having a logic “high” level (e.g., a binary number of “1”) which denotes that the 8-bit low-order data E_SUB<7:0> are a negative number. In such a case, the first mantissa data M1<28:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. The sign signal SIGN<0> outputted from the exponent comparison circuit 211C may be transmitted to selection terminals S of the first to third selectors 214, 215, and 216.

The delay circuit 212 may delay the 8-bit low-order data E_SUB<7:0>, which are outputted from the exponent adder 211B of the exponent subtraction circuit 211, by a certain delay time and may output the delayed data of the 8-bit low-order data E_SUB<7:0>. In an embodiment, the certain delay time may correspond to a period it takes the 2's complement circuit 213 to perform an arithmetic operation for calculating the 2's complement data of the 8-bit low-order data E_SUB<7:0>. The 8-bit low-order data E_SUB<7:0> outputted from the delay circuit 212 may be transmitted to a second input terminal IN2 of the first selector 214. The 2's complement circuit 213 may calculate a 2's complement value of the 8-bit low-order data E_SUB<7:0> outputted from the exponent adder 211B, thereby generating and outputting 2's complement data E_SUB_2C<7:0>. The 2's complement data E_SUB_2C<7:0> of the 8-bit low-order data E_SUB<7:0> may have an absolute value of a difference value between the first exponent data E1<7:0> and the second exponent data E2<7:0>. The 2's complement circuit 213 may transmit the 2's complement data E_SUB_2C<7:0> of the 8-bit low-order data E_SUB<7:0> to a first input terminal IN1 of the second selector 215.

The first selector 214 may receive a datum of “0” through a first input terminal IN1 of the first selector 214. In addition, the first selector 214 may receive the 8-bit low-order data E_SUB<7:0> from the delay circuit 212 through the second input terminal IN2 of the first selector 214. The second selector 215 may receive the 2's complement data E_SUB_2C<7:0> from the 2's complement circuit 213 through the first input terminal IN1 of the second selector 215. In addition, the second selector 215 may receive a datum of “0” through a second input terminal IN2 of the second selector 215. Each of the first and second selectors 214 and 215 may output one of two sets of input data according to the sign signal SIGN<0> inputted to the selection terminal S thereof. Hereinafter, data, which are outputted from the first selector 214 through an output terminal O of the first selector 214, will be referred to as the first shift data SF1<7:0>. In addition, data, which are outputted from the second selector 215 through an output terminal O of the second selector 215, will be referred to as the second shift data SF2<7:0>.

When the sign signal SIGN<0> has a datum of “0” (i.e., when the second mantissa data M2<23:0> has to be shifted), each of the first selector 214 and the second selector 215 may selectively output the data inputted through the first input terminal IN1. That is, the first selector 214 may selectively output the datum of “0” as the first shift data SF1<7:0> through the output terminal O of the first selector 214, and the second selector 215 may selectively output the 2's complement data E_SUB_2C<7:0> as the second shift data SF2<7:0> through the output terminal O of the second selector 215. When the sign signal SIGN<0> has a datum of “1” (i.e., when the first mantissa data M1<28:0> has to be shifted), each of the first selector 214 and the second selector 215 may selectively output the data inputted through the second input terminal IN2. That is, the first selector 214 may selectively output the 8-bit low-order data E_SUB<7:0> as the first shift data SF1<7:0> through the output terminal O of the first selector 214, and the second selector 215 may selectively output the datum of “0” as the second shift data SF2<7:0> through the output terminal O of the second selector 215. The first shift data SF1<7:0> and the second shift data SF2<7:0> outputted from respective ones of the first and second selectors 214 and 215 may be transmitted to the mantissa operation circuit 220.

The third selector 216 may receive the first exponent data E1<7:0> of the odd-numbered multiplication/addition result data D_MA(ODD) through a first input terminal IN1 of the third selector 216 and may also receive the second exponent data E2<7:0> of the left latched data D_LATCH(L) through a second input terminal IN2 of the third selector 216. The third selector 216 may selectively output one set of data having a larger value out of the first exponent data E1<7:0> and the second exponent data E2<7:0> through an output terminal O of the third selector 216 according to the sign signal SIGN<0> inputted through a selection terminal S of the third selector 216. Hereinafter, data, which are outputted from the third selector 216 through the output terminal O of the third selector 216, will be referred to as the maximum exponent data E_MAX<7:0>. When the sign signal SIGN<0> has a datum of “0” which denotes a positive number, it may correspond to a case that a value of the first exponent data E1<7:0> is greater than a value of the second exponent data E2<7:0>. In such a case, the third selector 216 may output the first exponent data E1<7:0> as the maximum exponent data E_MAX<7:0>. In contrast, when the sign signal SIGN<0> has a datum of “1” which denotes a negative number, it may correspond to a case that a value of the second exponent data E2<7:0> is greater than a value of the first exponent data E1<7:0>. In such a case, the third selector 216 may output the second exponent data E2<7:0> as the maximum exponent data E_MAX<7:0>. The third selector 216 may transmit the maximum exponent data E_MAX<7:0> to the normalizer 230.

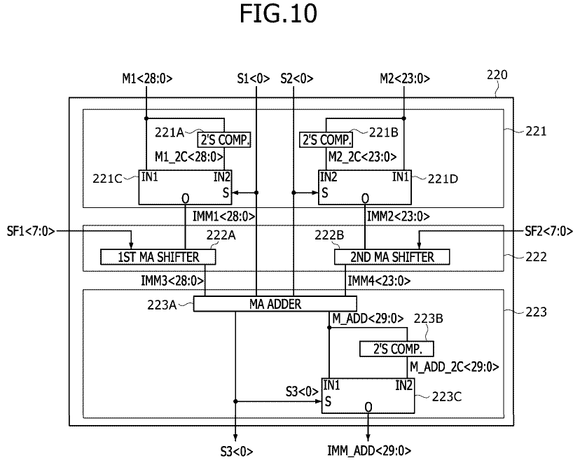

FIG. 10 is a block diagram illustrating an example of a configuration of the mantissa operation circuit 220 included in the left accumulative adder 143(L) of FIG. 8. Referring to FIG. 10, the mantissa operation circuit 220 may include a negative number processing circuit 221, a mantissa shift circuit 222, and a mantissa addition circuit 223. The negative number processing circuit 221 may include a first 2's complement circuit 221A, a second 2's complement circuit 221B, a first selector 221C, and a second selector 221D. The mantissa shift circuit 222 may include a first mantissa shifter 222A and a second mantissa shifter 222B. The mantissa addition circuit 223 may include a mantissa adder 223A, a third 2's complement circuit 223B, and a third selector 223C.

The first 2's complement circuit 221A of the negative number processing circuit 221 may receive the first mantissa data M1<28:0> of the odd-numbered multiplication/addition result data D_MA(ODD). The first 2's complement circuit 221A may calculate a 2's complement value of the first mantissa data M1<28:0> to generate and output 2's complement data M1_2C<28:0> of the first mantissa data M1<28:0>. The first selector 221C may receive the first mantissa data M1<28:0> of the odd-numbered multiplication/addition result data D_MA(ODD) through a first input terminal IN1 of the first selector 221C. The first selector 221C may also receive the 2's complement data M1_2C<28:0> from the first 2's complement circuit 221A through a second input terminal IN2 of the first selector 221C. In addition, the first selector 221C may receive the first sign datum S1<0> of the odd-numbered multiplication/addition result data D_MA(ODD) through a selection terminal S of the first selector 221C. When the first sign datum S1<0> has a binary number of “0” denoting a positive number, the first selector 221C may output the first mantissa data M1<28:0> inputted through the first input terminal IN1 through the output terminal O of the first selector 221C. In contrast, when the first sign datum S1<0> has a binary number of “1” denoting a negative number, the first selector 221C may output the 2's complement data M1_2C<28:0> inputted through the second input terminal IN2 through the output terminal O of the first selector 221C. Hereinafter, the output data of the first selector 221C will be referred to as first interim mantissa data IMM1<28:0>.

The second 2's complement circuit 221B of the negative number processing circuit 221 may receive the second mantissa data M2<23:0> of the left latched data D_LATCH(L). The second 2's complement circuit 221B may calculate a 2's complement value of the second mantissa data M2<23:0> to generate and output 2's complement data M2_2C<23:0> of the second mantissa data M2<23:0>. The second selector 221D may receive the second mantissa data M2<23:0> of the second mantissa data M2<23:0> of the left latched data D_LATCH(L) through a first input terminal IN1 of the second selector 221D. The first selector 221C may also receive the 2's complement data M2_2C<23:0> from the second 2's complement circuit 221B through a second input terminal IN2 of the second selector 221D. In addition, the second selector 221D may receive the second sign datum S2<0> of the left latched data D_LATCH(L) through a selection terminal S of the second selector 221D. When the second sign datum S2<0> has a binary number of “0” denoting a positive number, the second selector 221D may output the second mantissa data M2<23:0> inputted through the first input terminal IN1 through the output terminal O of the second selector 221D. In contrast, when the second sign datum S2<0> has a binary number of “1” denoting a negative number, the second selector 221D may output the 2's complement data M2_2C<23:0> inputted through the second input terminal IN2 through the output terminal O of the second selector 221D. Hereinafter, the output data of the second selector 221D will be referred to as second interim mantissa data IMM2<23:0>.

The first mantissa shifter 222A of the mantissa shift circuit 222 may receive the first interim mantissa data IMM1<28:0> from the first selector 221C of the negative number processing circuit 221. In addition, the first mantissa shifter 222A may receive the first shift data SF1<7:0> from the first selector 214 of the exponent operation circuit 210. The first mantissa shifter 222A may shift the first interim mantissa data IMM1<28:0> by the number of bits corresponding to an absolute value of the first shift data SF1<7:0> to output the shifted data of the first interim mantissa data IMM1<28:0>. Hereinafter, the output data of the first mantissa shifter 222A will be referred to as third interim mantissa data IMM3<28:0>. When the first shift data SF1<7:0> have a value of “0”, the third interim mantissa data IMM3<28:0> may be equal to the first interim mantissa data IMM1<28:0>. In contrast, when the first shift data SF1<7:0> are the 8-bit low-order data E_SUB<7:0> of the exponent subtraction data E_SUB<8:0>, the third interim mantissa data IMM3<28:0> may be generated by shifting the first interim mantissa data IMM1<28:0> by the number of bits corresponding to an absolute value of the 8-bit low-order data E_SUB<7:0> of the exponent subtraction data E_SUB<8:0>. The third interim mantissa data IMM3<28:0> outputted from the first mantissa shifter 222A may be transmitted to the mantissa addition circuit 223.

The second mantissa shifter 222B of the mantissa shift circuit 222 may receive the second interim mantissa data IMM2<23:0> from the second selector 221D of the negative number processing circuit 221. In addition, the second mantissa shifter 222B may receive the second shift data SF2<7:0> from the second selector 215 of the exponent operation circuit 210. The second mantissa shifter 222B may shift the second interim mantissa data IMM2<23:0> by the number of bits corresponding to an absolute value of the second shift data SF2<7:0> to output the shifted data of the second interim mantissa data IMM2<23:0>. Hereinafter, the output data of the second mantissa shifter 222B will be referred to as fourth interim mantissa data IMM4<23:0>. When the second shift data SF2<7:0> have a value of “0”, the fourth interim mantissa data IMM4<23:0> may be equal to the second interim mantissa data IMM2<23:0>. In contrast, when the second shift data SF2<7:0> are the 2's complement data E_SUB_2C<7:0> of the 8-bit low-order data E_SUB<7:0>, the fourth interim mantissa data IMM4<23:0> may be generated by shifting the second interim mantissa data IMM2<23:0> by the number of bits corresponding to an absolute value of the 2's complement data E_SUB_2C<7:0> of the 8-bit low-order data E_SUB<7:0>. The fourth interim mantissa data IMM4<23:0> outputted from the second mantissa shifter 222B may be transmitted to the mantissa addition circuit 223.

The mantissa adder 223A of the mantissa addition circuit 223 may receive the third interim mantissa data IMM3<28:0> from the first mantissa shifter 222A of the mantissa shift circuit 222 and may also receive the fourth interim mantissa data IMM4<23:0> from the second mantissa shifter 222B of the mantissa shift circuit 222. In addition, the mantissa adder 223A may receive the first sign datum S1<0> and the second sign datum S2<0>. The mantissa adder 223A may generate and output a third sign datum S3<0>. In addition, the mantissa adder 223A may add the third interim mantissa data IMM3<28:0> to the fourth interim mantissa data IMM4<23:0> to generate and output mantissa addition data M_ADD<29:0>. When both of the first sign datum S1<0> and the second sign datum S2<0> have a binary number of “O” denoting a positive number, the mantissa adder 223A may output a binary number of “0” as the third sign datum S3<0>. When both of the first sign datum S1<0> and the second sign datum S2<0> have a binary number of “1” denoting a negative number, the mantissa adder 223A may output a binary number of “1” as the third sign datum S3<0>. When one of the first and second sign data S1<0> and S2<0> has a binary number of “0” and the other has a binary number of “1”, the mantissa adder 223A may output a binary number of “0” as the third sign datum S3<0> if roundup occurs during the adding calculation on the third and fourth interim mantissa data IMM3<28:0> and IMM4<23:0> and may output a binary number of “1” as the third sign datum S3<0> if no roundup occurs during the adding calculation on the third and fourth interim mantissa data IMM3<28:0> and IMM4<23:0>. The third sign datum S3<0> outputted from the mantissa adder 223A may correspond to a sign datum of the odd-numbered accumulated data D_ACC(ODD). The third sign datum S3<0> outputted from the mantissa adder 223A may also be transmitted to a selection terminal S of the third selector 223C. The mantissa addition data M_ADD<29:0> outputted from the mantissa adder 223A may be transmitted to the third 2's complement circuit 223B and the third selector 223C.

The third 2's complement circuit 223B of the mantissa addition circuit 223 may receive the mantissa addition data M_ADD<29:0> from the mantissa adder 223A. The third 2's complement circuit 223B may calculate a 2's complement value of the mantissa addition data M_ADD<29:0> to generate and output 2's complement data M_ADD_2C<29:0> of the mantissa addition data M_ADD<29:0>. The third selector 223C may receive the mantissa addition data M_ADD<29:0> from the mantissa adder 223A through a first input terminal IN1 of the third selector 223C and may also receive the 2's complement data M_ADD_2C<29:0> from the third 2's complement circuit 223B through a second input terminal IN2 of the third selector 223C. In addition, the third selector 223C may receive the third sign datum S3<0> from the mantissa adder 223A through a selection terminal S of the third selector 223C. When the third sign datum S3<0> has a binary number of “0” denoting a positive number, the third selector 223C may output the mantissa addition data M_ADD<29:0> through an output terminal O of the third selector 223C. In contrast, when the third sign datum S3<0> has a binary number of “1” denoting a negative number, the third selector 223C may output the 2's complement data M_ADD_2C<29:0> through the output terminal O of the third selector 223C. hereinafter, the output data of the third selector 223C will be referred to as interim mantissa addition data IMM_ADD<29:0>.

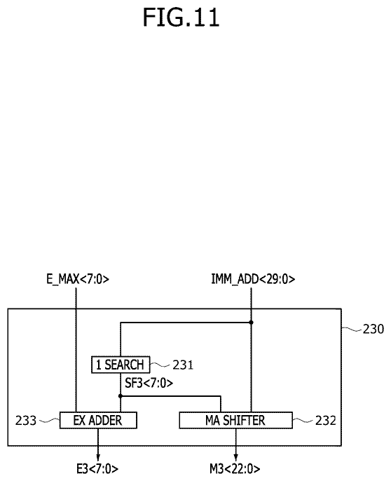

FIG. 11 is a block diagram illustrating an example of a configuration of the normalizer 230 included in the left accumulative adder 143(L) of FIG. 8. Referring to FIG. 11, the normalizer 230 may include a “1” search circuit 231, a mantissa shifter 232, and an exponent adder 233. The “1” search circuit 231 of the normalizer 230 may receive the interim mantissa addition data IMM_ADD<29:0> from the third selector (223C of FIG. 10) of the mantissa addition circuit (223 of FIG. 10). The “1” search circuit 231 may search a position where a binary number of “1” is first located in a right direction from a leftmost bit of the interim mantissa addition data IMM_ADD<29:0> and may generate third shift data SF3<7:0> as the search result. The third shift data SF3<7:0> may have a value corresponding to the number of bits for shifting the interim mantissa addition data IMM_ADD<29:0> such that the interim mantissa addition data IMM_ADD<29:0> have a standard form of “1.mantissa”. In an embodiment, the number of bits included in the third shift data may be arbitrarily set. In the present embodiment, it may be assumed that the third shift data SF3<7:0> are set to have 8 bits. The third shift data SF3<7:0> outputted from the “1” search circuit 231 may be transmitted to the mantissa shifter 232 and the exponent adder 233.

The mantissa shifter 232 of the normalizer 230 may perform a shifting operation on the interim mantissa addition data IMM_ADD<29:0> such that the interim mantissa addition data IMM_ADD<29:0> have a standard form of “1.mantissa”. The mantissa shifter 232 may receive the third shift data SF3<7:0> from the “1” search circuit 231 and may also receive the interim mantissa addition data IMM_ADD<29:0> from the third selector (223C of FIG. 10) of the mantissa addition circuit (223 of FIG. 10). The mantissa shifter 232 may shift the interim mantissa addition data IMM_ADD<29:0> by the number of bits corresponding to a value of the third shift data SF3<7:0>, thereby generating the third mantissa data M3<22:0> of the odd-numbered accumulated data D_ACC(ODD) outputted from the left accumulative adder 143(L). Although not illustrated in FIG. 11, a rounding process may be performed during the shifting operation of the mantissa shifter 232.

The exponent adder 233 of the normalizer 230 may change a value of the maximum exponent data E_MAX<7:0> to compensate for variation of the interim mantissa addition data IMM_ADD<29:0> which is due to the shifting operation for shifting the interim mantissa addition data IMM_ADD<29:0> by the number of bits corresponding to a value of the third shift data SF3<7:0>. The exponent adder 233 may receive the maximum exponent data E_MAX<7:0> from the third selector (216 of FIG. 9) of the exponent operation circuit (210 of FIG. 9) and may also receive the third shift data SF3<7:0> from the “1” search circuit 231. The exponent adder 233 may perform an adding calculation on the maximum exponent data E_MAX<7:0> and the third shift data SF3<7:0> to generate the third exponent data E3<7:0> of the odd-numbered accumulated data D_ACC(ODD) outputted from the left accumulative adder 143(L).

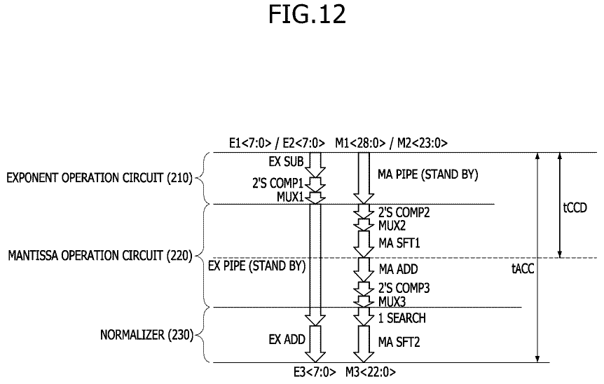

FIG. 12 illustrates an operation of processing the exponent data and the mantissa data during an accumulative adding calculation of the left accumulative adder 143(L) described with reference to FIGS. 8 to 11. Referring to FIGS. 8 to 11 and 12, the exponent operation circuit 210 may sequentially perform an exponent subtraction operation EX_SUB on the first exponent data E1<7:0> and the second exponent data E2<7:0>, a first 2's complement calculation operation 2'S_COMP1, and a first selection operation MUX1. As described with reference to FIG. 9, the exponent subtraction operation EX_SUB may correspond to an operation which is performed by the exponent subtraction circuit 211 to generate the sign signal SIGN<0> and the 8-bit low-order data E_SUB<7:0> of the exponent subtraction data E_SUB<8:0>. The first 2's complement calculation operation 2'S_COMP1 may correspond to an operation which is performed by the 2's complement circuit 213 calculating a 2's complement value of the 8-bit low-order data E_SUB<7:0> to generate the 2's complement data E_SUB_2C<7:0>. The first selection operation MUX1 may correspond to an operation which is performed by the first and second selectors 214 and 215 to generate the first shift data SF1<7:0> and the second shift data SF2<7:0>. While the operations of the exponent operation circuit 210 are performed, the first mantissa data M1<28:0> and the second mantissa data M2<23:0> may be on standby in a mantissa pipe MA_PIPE.

After all of the operations of the exponent operation circuit 210 terminate, the mantissa operation circuit 220 may sequentially perform a second 2's complement calculation operation 2'S_COMP2 on the first mantissa data M1<28:0> and the second mantissa data M2<23:0>, a second selection operation MUX2, a first mantissa shift operation MA_SFT1, a mantissa addition operation MA_ADD, a third 2's complement calculation operation 2'S_COMP3, and a third selection operation MUX3. As described with reference to FIG. 10, the second 2's complement calculation operation 2'S_COMP2 may correspond to an operation which is performed by the first and second 2's complement circuits 221A and 221B of the negative number processing circuit 221 to generate the 2's complement data M1_2C<28:0> of the first mantissa data M1<28:0> and the 2's complement data M2_2C<23:0> of the second mantissa data M2<23:0>. The second selection operation MUX2 may correspond to an operation which is performed by the first and second selectors 221C and 221D of the negative number processing circuit 221 to generate the first interim mantissa data IMM1<28:0> and the second interim mantissa data IMM2<23:0>. The first mantissa shift operation MA_SFT1 may correspond to an operation which is performed by the first and second mantissa shifters 222A and 222B of the mantissa shift circuit 222 to generate the third interim mantissa data IMM3<28:0> and the fourth interim mantissa data IMM4<23:0>. The mantissa addition operation MA_ADD may correspond to an operation which is performed by the mantissa adder 223A of the mantissa addition circuit 223 to generate the third sign datum S3<0> and the mantissa addition data M_ADD<29:0>. The third 2's complement calculation operation 2'S_COMP3 may correspond to an operation which is performed by the third 2's complement circuit 223B of the mantissa addition circuit 223 to generate the 2's complement data M_ADD_2C<29:0> of the mantissa addition data M_ADD<29:0>. The third selection operation MUX3 may correspond to an operation which is performed by the third selector 223C of the mantissa addition circuit 223 to generate the interim mantissa addition data IMM_ADD<29:0>. While the operations of the mantissa operation circuit 220 are performed, no exponent processing operation is performed and the maximum exponent data E_MAX<7:0> generated by the exponent operation circuit (210 of FIG. 8) may be on standby in an exponent pipe EX_PIPE.

After all of the operations of the mantissa operation circuit 220 terminate, the normalizer 230 may sequentially perform a “1” searching operation 1_SEARCH, an exponent addition operation EX_ADD, and a second mantissa shift operation MA_SFT2. As described with reference to FIG. 11, the “1” searching operation 1_SEARCH may correspond to an operation which is performed by the “1” search circuit 231 of the normalizer 230 to generate the third shift data SF3<7:0>. The exponent addition operation EX_ADD may correspond to an operation which is performed by the exponent adder 233 of the normalizer 230 to generate the third exponent data E3<7:0> of the odd-numbered accumulated data D_ACC(ODD). The second mantissa shift operation MA_SFT2 may correspond to an operation which is performed by the mantissa shifter 232 of the normalizer 230 to generate the third mantissa data M3<22:0> of the odd-numbered accumulated data D_ACC(ODD). The exponent addition operation EX_ADD and the second mantissa shift operation MA_SFT2 may be performed independently. Meanwhile, the maximum exponent data E_MAX<7:0> generated by the exponent operation circuit (210 of FIG. 8) may be on standby in the exponent pipe EX_PIPE until the “1” searching operation 1_SEARCH terminates.

As described above, while the exponent data are processed by the exponent operation circuit 210, the mantissa data may be on standby. In contrast, while the mantissa data are processed by the mantissa operation circuit 220, the exponent data may be on standby. The exponent data may be on standby until the normalizer 230 terminates the “1” searching operation 1_SEARCH. The exponent addition operation EX_ADD and the second mantissa shift operation MA_SFT2 may be performed independently. A time (i.e., an accumulative addition time “tACC”) it takes the left accumulative adder (143(L) of FIG. 7) of the left accumulator (140(L) of FIG. 7) to generate and output the odd-numbered accumulated data D_ACC(ODD) using the odd-numbered multiplication/addition result data D_MA(ODD) and the left latched data D_LATCH(L) as input data may correspond to a time it takes to perform all of the operations of the exponent operation circuit 210, the mantissa operation circuit 220, and the normalizer 230. That is, after the accumulative addition time “tACC” elapses from a point in time when the odd-numbered multiplication/addition result data D_MA(ODD) and the left latched data D_LATCH(L) are inputted to the left accumulative adder 143(L), the odd-numbered accumulated data D_ACC(ODD) may be outputted from the left accumulative adder 143(L). The odd-numbered accumulated data D_ACC(ODD) may be used as the left latched data D_LATCH(L) which are accumulatively added to the odd-numbered multiplication/addition result data D_MA(ODD) inputted to the left accumulative adder 143(L) in a next step. This means that the left latched data D_LATCH(L) are able to be inputted to the left accumulative adder 143(L) at an interval time of the accumulative addition time “tACC”. In contrast, the odd-numbered multiplication/addition result data D_MA(ODD) may be inputted to the left accumulative adder 143(L) at an interval time of the CAS to CAS delay time “tCCD”. That is, in the event that the odd-numbered multiplication/addition result data D_MA(ODD) are inputted to the left accumulative adder 143(L) at an interval time of the CAS to CAS delay time “tCCD”, the left latched data D_LATCH(L) cannot be inputted to the left accumulative adder 143(L) with the odd-numbered multiplication/addition result data D_MA(ODD) due to a previous accumulative adding calculation which has not terminated yet. Thus, the AI accelerator 100 according to the present embodiment may be configured such that each of the left accumulative adder 143(L) and the right accumulative adder 143(R) receives the multiplication/addition result data at an interval time of twice the CAS to CAS delay time “tCCD”. In such a case, if the accumulative addition time “tACC” is not longer than twice the CAS to CAS delay time “tCCD”, the multiplication/addition result data and the latched data may be inputted to each of the left accumulative adder 143(L) and the right accumulative adder 143(R) together.

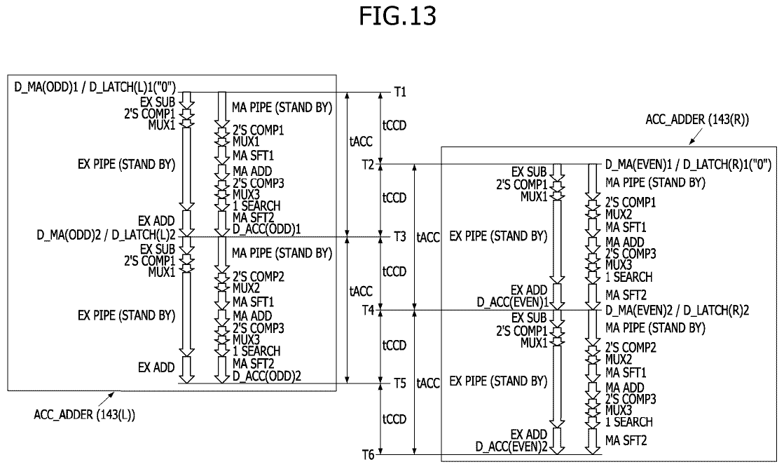

FIG. 13 illustrates operation timings of the left accumulative adder 143(L) and the right accumulative adder 143(R) shown in FIG. 7. In the present embodiment, it may be assumed that the accumulative addition time “tACC” is set to be twice the CAS to CAS delay time “tCCD” (i.e., “2×tCCD”) which corresponds to a maximum value. Referring to FIGS. 7 and 13, the left accumulative adder 143(L) may receive first odd-numbered multiplication/addition result data D_MA(ODD)1 and first left latched data D_LATCH(L)1 at a first point in time “T1”. The first odd-numbered multiplication/addition result data D_MA(ODD)1 may correspond to first multiplication/addition result data outputted from the multiplication circuit/adder tree (130 of FIG. 1). The first point in time “T1” may be a moment when a first pulse of the odd clock signal CK_ODD occurs, as described with reference to FIG. 2. The left latch circuit 144(L) may have a reset state at the first point in time “T1” because the present accumulative adding calculation is a first accumulative adding calculation of the left accumulator 140(L). Thus, the first left latched data D_LATCH(L)1 having a reset value of “0” may be inputted to the left accumulative adder 143(L). At the first point in time “T1”, the left accumulative adder 143(L) may commence to perform an accumulative adding calculation on the first odd-numbered multiplication/addition result data D_MA(ODD)1 and the first left latched data D_LATCH(L)1. At a third point in time “T3” when the accumulative addition time “tACC” (i.e., “2×tCCD”) elapses from the first point in time “T1”, the left accumulative adder 143(L) may output first odd-numbered accumulated data D_ACC(ODD)1. The first odd-numbered accumulated data D_ACC(ODD)1 may be used as second left latched data D_LATCH(L)2 during a next accumulative adding calculation of the left accumulative adder 143(L).

At a second point in time “T2” when the CAS to CAS delay time “tCCD” elapses from the first point in time “T1”, the right accumulative adder 143(R) may receive first even-numbered multiplication/addition result data D_MA(EVEN)1 and first right latched data D_LATCH(R)1. The first even-numbered multiplication/addition result data D_MA(EVEN)1 may correspond to second multiplication/addition result data outputted from the multiplication circuit/adder tree (130 of FIG. 1). The second point in time “T2” may be a moment when a first pulse of the even clock signal CK_EVEN occurs, as described with reference to FIG. 2. The right latch circuit 144(R) may have a reset state at the second point in time “T2” because the present accumulative adding calculation is a first accumulative adding calculation of the right accumulator 140(R). Thus, the first right latched data D_LATCH(R)1 having a reset value of “0” may be inputted to the right accumulative adder 143(R). At the second point in time “T2”, the right accumulative adder 143(R) may commence to perform an accumulative adding calculation on the first even-numbered multiplication/addition result data D_MA(EVEN)1 and the first right latched data D_LATCH(R)1. At a fourth point in time “T4” when the accumulative addition time “tACC” (i.e., “2×tCCD”) elapses from the second point in time “T2”, the right accumulative adder 143(R) may output first even-numbered accumulated data D_ACC(EVEN)1. The first even-numbered accumulated data D_ACC(EVEN)1 may be used as second right latched data D_LATCH(R)2 during a next accumulative adding calculation of the right accumulative adder 143(R).

At the third point in time “T3” when the CAS to CAS delay time “tCCD” elapses from the second point in time “T2”, the left accumulative adder 143(L) may receive second odd-numbered multiplication/addition result data D_MA(ODD)2 and the second left latched data D_LATCH(L)2. The second odd-numbered multiplication/addition result data D_MA(ODD)2 may correspond to third multiplication/addition result data outputted from the multiplication circuit/adder tree (130 of FIG. 1). The third point in time “T3” may be a moment when a second pulse of the odd clock signal CK_ODD occurs, as described with reference to FIG. 2. Because the first odd-numbered accumulated data D_ACC(ODD)1 are latched in the left latch circuit 144(L) by a previous step, the first odd-numbered accumulated data D_ACC(ODD)1 corresponding to the second left latched data D_LATCH(L)2 may be inputted to the left accumulative adder 143(L). At the third point in time “T3”, the left accumulative adder 143(L) may commence to perform an accumulative adding calculation on the second odd-numbered multiplication/addition result data D_MA(ODD)2 and the second left latched data D_LATCH(L)2. At a fifth point in time “T5” when the accumulative addition time “tACC” (i.e., “2×tCCD”) elapses from the third point in time “T3”, the left accumulative adder 143(L) may output second odd-numbered accumulated data D_ACC(ODD)2. The second odd-numbered accumulated data D_ACC(ODD)2 may be used as third left latched data (not shown) during a next accumulative adding calculation of the left accumulative adder 143(L).

At the fourth point in time “T4” when the CAS to CAS delay time “tCCD” elapses from the third point in time “T3”, the right accumulative adder 143(R) may receive second even-numbered multiplication/addition result data D_MA(EVEN)2 and the second right latched data D_LATCH(R)2. The second even-numbered multiplication/addition result data D_MA(EVEN)2 may correspond to fourth multiplication/addition result data outputted from the multiplication circuit/adder tree (130 of FIG. 1). The fourth point in time “T4” may be a moment when a second pulse of the even clock signal CK_EVEN occurs, as described with reference to FIG. 2. Because the first even-numbered accumulated data D_ACC(EVEN)1 are latched in the right latch circuit 144(R) by a previous step, the first even-numbered accumulated data D_ACC(EVEN)1 corresponding to the second right latched data D_LATCH(R)2 may be inputted to the right accumulative adder 143(R). At the fourth point in time “T4”, the right accumulative adder 143(R) may commence to perform an accumulative adding calculation on the second even-numbered multiplication/addition result data D_MA(EVEN)2 and the second right latched data D_LATCH(R)2. At a sixth point in time “T6” when the accumulative addition time “tACC” (i.e., “2×tCCD”) elapses from the fourth point in time “T4”, the right accumulative adder 143(R) may output second even-numbered accumulated data D_ACC(EVEN)2. The second even-numbered accumulated data D_ACC(EVEN)2 may be used as third right latched data (not shown) during a next accumulative adding calculation of the right accumulative adder 143(R).

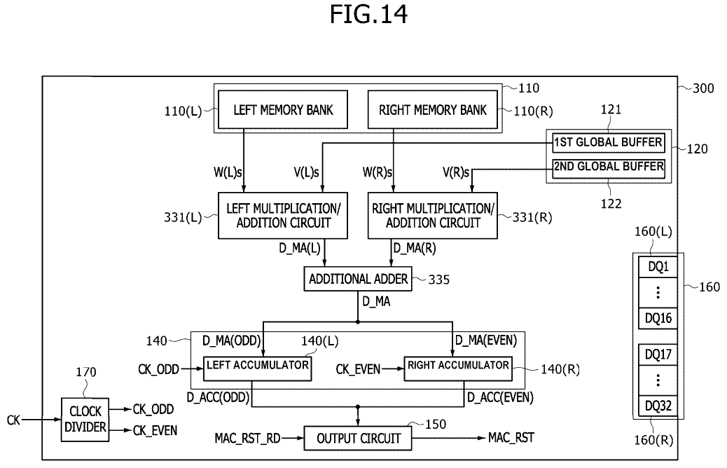

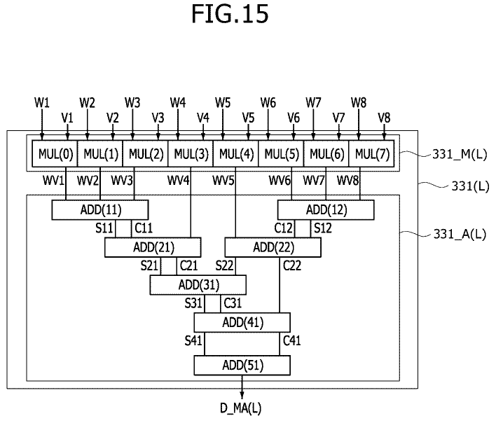

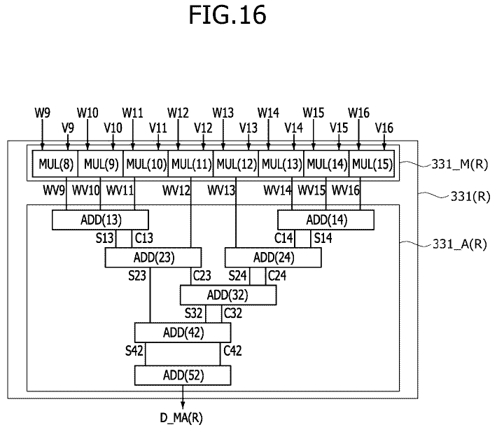

FIG. 14 is a block diagram illustrating an AI accelerator 300 according to another embodiment of the present disclosure. FIGS. 15 and 16 are block diagrams illustrating configurations of a left multiplication/addition circuit 331(L) and a right multiplication/addition circuit 331(R) included in the AI accelerator 300 of FIG. 14, respectively. In FIG. 14, the same reference numerals or symbols as used in FIG. 1 may denote the same elements. Thus, descriptions of the same elements as set forth in the embodiment of FIG. 1 will be omitted in the present embodiment. First, referring to FIG. 14, the AI accelerator 300 may include the first memory circuit 110, the second memory circuit 120, the left multiplication/addition circuit 331(L), the right multiplication/addition circuit 331(R), an additional adder 335, the accumulative addition circuit 140, the output circuit 150, the data I/O circuit 160, and the clock divider 170. The AI accelerator 300 may be different from the AI accelerator 100 described with reference to FIG. 1 in terms of a point that the AI accelerator 300 includes the left multiplication/addition circuit 331(L), the right multiplication/addition circuit 331(R), and the additional adder 335.

Specifically, the left multiplication/addition circuit 331(L) may include a left multiplication circuit 331_M(L) and a left adder tree 331_A(L), as illustrated in FIG. 15. The left multiplication circuit 331_M(L) may include a plurality of multipliers, for example, first to eighth multipliers MUL(0)˜MUL(7). The first to eighth multipliers MUL(0)˜MUL(7) may receive first to eighth weight data W1˜W8 from a left memory bank 110(L) of the first memory circuit 110, respectively. In addition, the first to eighth multipliers MUL(0)˜MUL(7) may receive first to eighth vector data V1˜V8 from a first global buffer 121 of the second memory circuit 120, respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The first to eighth multipliers MUL(0)˜MUL(7) may perform multiplying calculations on the first to eighth weight data W1˜W8 and the first to eighth vector data V1˜V8 to generate first to eighth multiplication result data WV1˜WV8, respectively. The first to eighth multiplication result data WV1˜WV8 may be transmitted to the left adder tree 331_A(L).

The left adder tree 331_A(L) may perform an adding calculation on the first to eighth multiplication result data WV1˜WV8 outputted from the left multiplication circuit 331_M(L). The left adder tree 331_A(L) may generate and output left multiplication/addition result data D_MA(L) as a result of the adding calculation. The left adder tree 331_A(L) may include a plurality of adders ADDs which are arrayed to have a hierarchical structure such as a tree structure. In the present embodiment, the left adder tree 331_A(L) may be comprised of a plurality of full-adders and a half-adder. However, the present embodiment is merely an example of the present disclosure. Accordingly, in some other embodiment, the left adder tree 331_A(L) may be comprised of only a plurality of half-adders. In the present embodiment, two full-adders ADD(11) and ADD(12) may be disposed in a first stage located at a highest level of the left adder tree 331_A(L), and two full-adders ADD(21) and ADD(22) may also be disposed in a second stage located at a second highest level of the left adder tree 331_A(L). In addition, one full-adder ADD(31) may be disposed in a third stage located at a third highest level of the left adder tree 331_A(L), and one full-adder ADD(41) may also be disposed in a fourth stage located at a fourth highest level of the left adder tree 331_A(L). Moreover, one half-adder ADD(51) may be disposed in a fifth stage located at a lowest level of the left adder tree 331_A(L).

The first full-adder ADD(11) in the first stage may perform an adding calculation on the first to third multiplication result data WV1˜WV3 outputted from the first to third multipliers MUL(0)˜MUL(2) of the left multiplication circuit 331_M(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 331_M(L), thereby generating and outputting added data S12 and a carry C12. The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 331_M(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 331_M(L), thereby generating and outputting added data S22 and a carry C22.

The full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The full-adder ADD(41) in the fourth stage may perform an adding calculation on the added data S31 and the carry C31 outputted from the full-adder ADD(31) in the third stage and the carry C(22) outputted from the second full-adder ADD(22) in the second stage, thereby generating and outputting added data S41 and a carry C41. The half-adder ADD(51) in the fifth stage may perform an adding calculation on the added data S41 and the carry C41 outputted from the full-adder ADD(41) in the fourth stage, thereby generating and outputting the left multiplication/addition result data D_MA(L). The left multiplication/addition result data D_MA(L) outputted from the half-adder ADD(51) in the fifth stage of the left multiplication circuit 331_M(L) may be transmitted to the additional adder 335.

The right multiplication/addition circuit 331(R) may include a right multiplication circuit 331_M(R) and a right adder tree 331_A(R), as illustrated in FIG. 16. The right multiplication circuit 331_M(R) may include a plurality of multipliers, for example, ninth to sixteenth multipliers MUL(8)˜MUL(15). The ninth to sixteenth multipliers MUL(8)˜MUL(15) may receive ninth to sixteenth weight data W9˜W16 from a right memory bank 110(R) of the first memory circuit 110, respectively. In addition, the ninth to sixteenth multipliers MUL(8)˜MUL(15) may receive ninth to sixteenth vector data V9˜V16 from a second global buffer 122 of the second memory circuit 120, respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1. The ninth to sixteenth multipliers MUL(8)˜MUL(15) of the right multiplication circuit 331_M(R) may perform multiplying calculations on the ninth to sixteenth weight data W9˜W16 and the ninth to sixteenth vector data V9˜V16 to generate ninth to sixteenth multiplication result data WV9˜WV16, respectively. The ninth to sixteenth multiplication result data WV9˜WV16 may be transmitted to the right adder tree 331_A(R).

The right adder tree 331_A(R) may perform an adding calculation on the ninth to sixteenth multiplication result data WV9˜WV16 outputted from the right multiplication circuit 331_M(R). The right adder tree 331_A(R) may generate and output right multiplication/addition result data D_MA(R) as a result of the adding calculation. The right adder tree 331_A(R) may include a plurality of adders ADDs which are arrayed to have a hierarchical structure such as a tree structure. In the present embodiment, the right adder tree 331_A(R) may be comprised of a plurality of full-adders and a half-adder. However, the present embodiment is merely an example of the present disclosure. Accordingly, in some other embodiment, the right adder tree 331_A(R) may be comprised of only a plurality of half-adders. In the present embodiment, two full-adders ADD(13) and ADD(14) may be disposed in a first stage located at a highest level of the right adder tree 331_A(R), and two full-adders ADD(23) and ADD(24) may also be disposed in a second stage located at a second highest level of the right adder tree 331_A(R). In addition, one full-adder ADD(32) may be disposed in a third stage located at a third highest level of the right adder tree 331_A(R), and one full-adder ADD(42) may also be disposed in a fourth stage located at a fourth highest level of the right adder tree 331_A(R). Moreover, one half-adder ADD(52) may be disposed in a fifth stage located at a lowest level of the right adder tree 331_A(R).

The first full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 331_M(R), thereby generating and outputting added data S13 and a carry C13. The second full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 331_M(R), thereby generating and outputting added data S14 and a carry C14. The first full-adder ADD(23) in the second stage may perform an adding calculation on the added data S13 and the carry C13 outputted from the first full-adder ADD(13) in the first stage and the twelfth multiplication result data WV12 outputted from the twelfth multiplier MUL(11) of the right multiplication circuit 331_M(R), thereby generating and outputting added data S23 and a carry C23. The second full-adder ADD(24) in the second stage may perform an adding calculation on the added data S14 and the carry C14 outputted from the second full-adder ADD(14) in the first stage and the thirteenth multiplication result data WV13 outputted from the thirteenth multiplier MUL(12) of the right multiplication circuit 331_M(R), thereby generating and outputting added data S24 and a carry C24.

The full-adder ADD(32) in the third stage may perform an adding calculation on the carry 23 outputted from the first full-adder ADD(23) in the second stage and the added data S24 and the carry C24 outputted from the second full-adder ADD(24) in the second stage, thereby generating and outputting added data S32 and a carry C32. The full-adder ADD(42) in the fourth stage may perform an adding calculation on the added data S32 and the carry C32 outputted from the full-adder ADD(32) in the third stage and the added data S(23) outputted from the first full-adder ADD(23) in the second stage, thereby generating and outputting added data S42 and a carry C42. The half-adder ADD(52) in the fifth stage may perform an adding calculation on the added data S42 and the carry C42 outputted from the full-adder ADD(42) in the fourth stage, thereby generating and outputting the right multiplication/addition result data D_MA(R). The right multiplication/addition result data D_MA(R) outputted from the half-adder ADD(52) in the fifth stage of the right multiplication circuit 331_M(R) may be transmitted to the additional adder 335.

Referring again to FIG. 14, the first accumulative addition time “tACC1” it takes the left accumulator 140(L) of the AI accelerator 300 to perform the accumulative adding calculation may be longer than the CAS to CAS delay time “tCCD” and may be shorter than twice the CAS to CAS delay time “tCCD”, like the AI accelerator 100 described with reference to FIG. 1. Similarly, the second accumulative addition time “tACC2” it takes the right accumulator 140(R) of the AI accelerator 300 to perform the accumulative adding calculation may also be longer than the CAS to CAS delay time “tCCD” and may be shorter than twice the CAS to CAS delay time “tCCD”. As such, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), the left accumulator 140(L) may be realized using an accumulator included in a left MAC operator and the right accumulator 140(R) may be realized using an accumulator included in a right MAC operator. Thus, it may be unnecessary to additionally dispose accumulators occupying a relatively large area in the AI accelerator 300. Accordingly, it may be possible to realize compact AI accelerators.

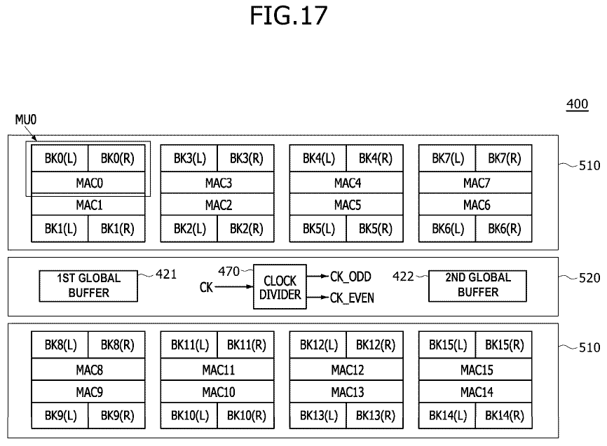

FIG. 17 is a block diagram illustrating an AI accelerator 400 according to yet another embodiment of the present disclosure. Referring to FIG. 17, the AI accelerator 400 may include a memory/arithmetic region 510 and a peripheral region 520. The memory/arithmetic region 510 may include a plurality of memory banks BKs and a plurality of MAC operators MACs. The peripheral region 520 may include a first global buffer 421, a second global buffer 422, and a clock divider 470. Although not shown in FIG. 17, a data I/O circuit may be disposed in the peripheral region 520, and the data I/O circuit disposed in the peripheral region 520 may include left data I/O terminals and right data I/O terminals, like the data I/O circuit 160 described with reference to FIG. 1. In the present embodiment, it may be assumed that the plurality of memory banks BKs include first to sixteenth memory banks BK0˜BK15. In addition, it may be assumed that the plurality of MAC operators MACs include first to sixteenth MAC operators MAC0˜MAC15.

Each of the first to sixteenth memory banks BK0˜BK15 may be divided into a left memory bank disposed in a left region and a right memory bank disposed in a right region. Accordingly, the first to sixteenth memory banks BK0˜BK15 may include first to sixteenth left memory banks BK0(L)˜BK15(L) and first to sixteenth right memory banks BK0(R)˜BK15(R). For example, the first memory bank BK0 may include the first left memory bank BK0(L) disposed in the left region and the first right memory bank BK0(R) disposed in the right region, and the second memory bank BK1 may include the second left memory bank BK1(L) disposed in the left region and the second right memory bank BK1(R) disposed in the right region. Similarly, the sixteenth memory bank BK15 may include the sixteenth left memory bank BK15(L) disposed in the left region and the sixteenth right memory bank BK15(R) disposed in the right region. In the present embodiment, the first to sixteenth left memory banks BK0(L)˜BK15(L) may be disposed to be adjacent to the first to sixteenth right memory banks BK0(R)˜BK15(R), respectively. For example, the first left memory bank BK0(L) and the first right memory bank BK0(R) may be disposed to be adjacent to each other and to share a row decoder with each other. The second left memory bank BK1(L) and the second right memory bank BK1(R) may also be disposed to be adjacent to each other. In the same way, the sixteenth left memory bank BK15(L) and the sixteenth right memory bank BK15(R) may also be disposed to be adjacent to each other.

The first to sixteenth MAC operators MAC0˜MAC15 may be disposed to be allocated to the first to sixteenth memory banks BK0˜BK15, respectively. For example, the first MAC operator MAC0 may be allocated to both of the first left memory bank BK0(L) and the first right memory bank BK0(R). In addition, the second MAC operator MAC1 may be allocated to both of the second left memory bank BK1(L) and the second right memory bank BK1(R). Similarly, the sixteenth MAC operator MAC15 may be allocated to both of the sixteenth left memory bank BK15(L) and the sixteenth right memory bank BK15(R). Each of the first to sixteenth MAC operators MAC0˜MAC15 and one of the first to sixteenth memory banks may constitute one MAC unit MU. For example, as illustrated in FIG. 17, the first left memory bank BK0(L), the first right memory bank BK0(R), and the first MAC operator MAC0 may constitute a first MAC unit MU0. Although not indicated in FIG. 17, each of second to sixteenth MAC units may also be configured in the same way as described above. A MAC operator included in a certain MAC unit may receive left weight data from a left memory bank included in the certain MAC unit and may receive right weight data from a right memory bank included in the certain MAC unit. Thus, the first MAC operator MAC0 may receive left weight data from the first left memory bank BK0(L) and may receive right weight data from the first right memory bank BK0(R).

The first global buffer 421 may transmit left vector data to each of the first to sixteenth MAC operators MAC0˜MAC15. The second global buffer 422 may transmit right vector data to each of the first to sixteenth MAC operators MAC0˜MAC15. The clock divider 470 may divide a clock signal CK, which is inputted to the AI accelerator 400, to generate and output an odd clock signal CK_ODD and an even clock signal CK_EVEN. The odd clock signal CK_ODD may be transmitted to a left accumulator in each of the first to sixteenth MAC operators MAC0˜MAC15. The even clock signal CK_ODD may be transmitted to a right accumulator in each of the first to sixteenth MAC operators MAC0˜MAC15. The first global buffer 421, the second global buffer 422, and the clock divider 470 may have substantially the same configurations as the first global buffer 121, the second global buffer 122, and the clock divider 170 of the AI accelerator 100 described with reference to FIG. 1, respectively.

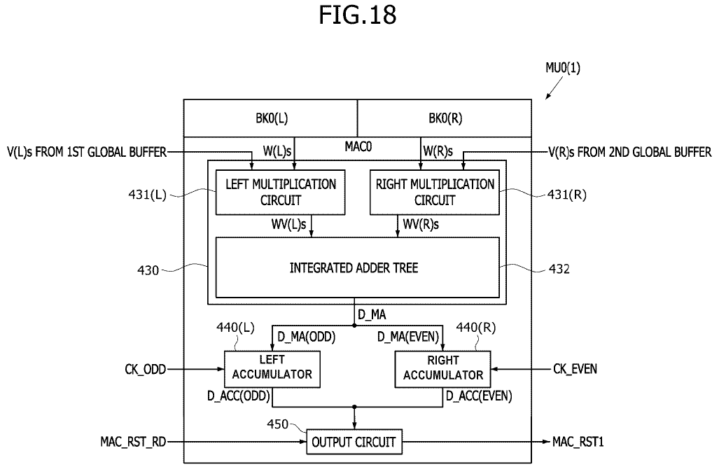

FIG. 18 is a block diagram illustrating a first MAC unit MU0(1) corresponding to an example of the first MAC unit MU0 included in the AI accelerator 400 of FIG. 17. The following descriptions for the first MAC unit MU0(1) may be equally applied to each of the remaining MAC units. Referring to FIG. 18, the first MAC unit MU0(1) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a multiplication circuit/adder tree 430, a left accumulator 440(L), a right accumulator 440(R), and an output circuit 450. The multiplication circuit/adder tree 430 may include a left multiplication circuit 431(L), a right multiplication circuit 431(R), and an integrated adder tree 432. The left multiplication circuit 431(L), the right multiplication circuit 431(R), the integrated adder tree 432, the left accumulator 440(L), the right accumulator 440(R), and the output circuit 450 constituting the first MAC operator MAC0 may have substantially the same configurations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively. Accordingly, the left multiplication circuit 431(L), the right multiplication circuit 431(R), the integrated adder tree 432, the left accumulator 440(L), the right accumulator 440(R), and the output circuit 450 constituting the first MAC operator MAC0 may perform substantially the same operations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively.

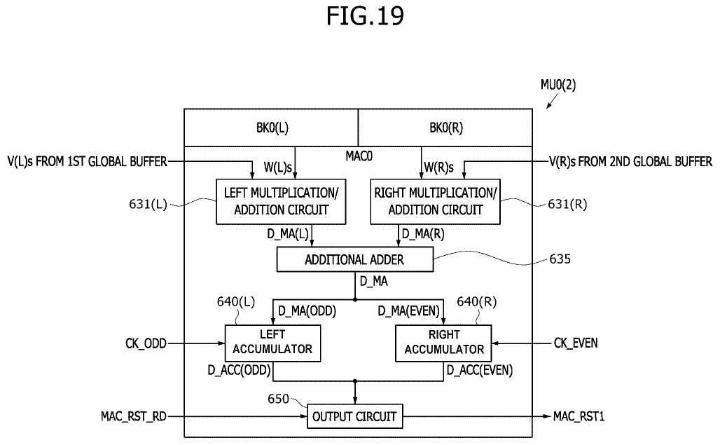

FIG. 19 is a block diagram illustrating a first MAC unit MU0(2) corresponding to another example of the first MAC unit MU0 included in the AI accelerator 400 of FIG. 17. The following descriptions for the first MAC unit MU0(2) may be equally applied to each of the remaining MAC units. Referring to FIG. 19, the first MAC unit MU0(2) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a left multiplication/addition circuit 631(L), a right multiplication/addition circuit 631(R), an additional adder 635, a left accumulator 640(L), a right accumulator 640(R), and an output circuit 650. The left multiplication/addition circuit 631(L), the right multiplication/addition circuit 631(R), the additional adder 635, the left accumulator 640(L), the right accumulator 640(R), and the output circuit 650 constituting the first MAC operator MAC0 may have substantially the same configurations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively. Accordingly, the left multiplication/addition circuit 631(L), the right multiplication/addition circuit 631(R), the additional adder 635, the left accumulator 640(L), the right accumulator 640(R), and the output circuit 650 constituting the first MAC operator MAC0 may perform substantially the same operations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively.

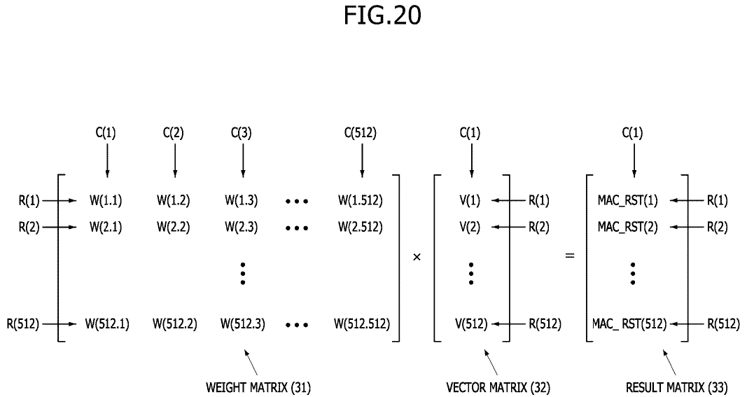

FIG. 20 illustrates a matrix multiplying calculation executed by a MAC operation of the AI accelerator 400 of FIG. 17. Referring to FIG. 20, the AI accelerator 400 may perform a MAC operation which is executed by a matrix multiplying calculation for multiplying a ‘M×N’ weight matrix 31 by a ‘N×1’ vector matrix 32 (where, “M” and “N” are natural numbers which are equal to or greater than two). The term “matrix multiplying calculation” may be construed as having the same meaning as the term “MAC operation”. The AI accelerator 400 may generate and output a ‘M×1’ result matrix 33 as a result of the MAC operation on the ‘M×N’ weight matrix 31 and the ‘N×1’ vector matrix 32. Hereinafter, it may be assumed that the weight matrix 31 has 512 rows (i.e., first to 512^{th} rows R(1)˜R(512)) and 512 columns (i.e., first to 512^{th} columns C(1)˜C(512)) and the vector matrix 32 has 512 rows (i.e., first to 512^{th} rows R(1)˜R(512)) and one column (i.e., a first column C(1)). Accordingly, the result matrix 33 generated by the matrix multiplying calculation on the weight matrix 31 and the vector matrix 32 may have 512 rows (i.e., first to 512^{th} rows R(1)˜R(512)) and one column (i.e., a first column C(1)). The weight matrix 31 may have 262,144 sets of weight data W(1.1)˜W(1.512), . . . , and W(512.1)˜W(512.512) as elements. The vector matrix 32 may have 512 sets of vector data V(1)˜V(512) as elements. The result matrix 33 generated by the MAC operation may have 512 sets of MAC result data MAC_RST(1)˜MAC_RST(512) as elements.

The AI accelerator 400 according to the present embodiment may have a plurality of memory banks BKs and a plurality of MAC operators MACs. Thus, a plurality of MAC operations may be simultaneously performed by the plurality of MAC operators MACs. Specifically, the first to sixteenth MAC operators MAC0˜MAC15 of the AI accelerator 400 may perform a first MAC operation on the weight data W(1.1)˜W(1.512), . . . , and W(16.1)˜W(16.512) arrayed in the first to sixteenth rows R(1)˜R(16) of the weight matrix 31 and the vector data V(1)˜V(512) arrayed in the first to sixteenth rows R(1)˜R(512) of the vector matrix 32, thereby generating and output sixteen sets of MAC result data (i.e., first to sixteenth MAC result data MAC_RST(1)˜MAC_RST(16)), respectively. Subsequently, the first to sixteenth MAC operators MAC0˜MAC15 of the AI accelerator 400 may perform a second MAC operation on the weight data W(17.1)˜W(17.512), . . . , and W(32.1)˜W(32.512) arrayed in the seventeenth to 32^{nd} rows R(17)˜R(32) of the weight matrix 31 and the vector data V(1)˜V(512) arrayed in the first to sixteenth rows R(1)˜R(512) of the vector matrix 32, thereby generating sixteen sets of MAC result data (i.e., seventeenth to 32^{nd} MAC result data MAC_RST(17)˜MAC_RST(32)), respectively. In the same way, the first to sixteenth MAC operators MAC0˜MAC15 of the AI accelerator 400 may perform third to 32^{nd} MAC operations to generate 33^{rd} to 512^{th} MAC result data MAC_RST(33)˜N MAC_RST(512).

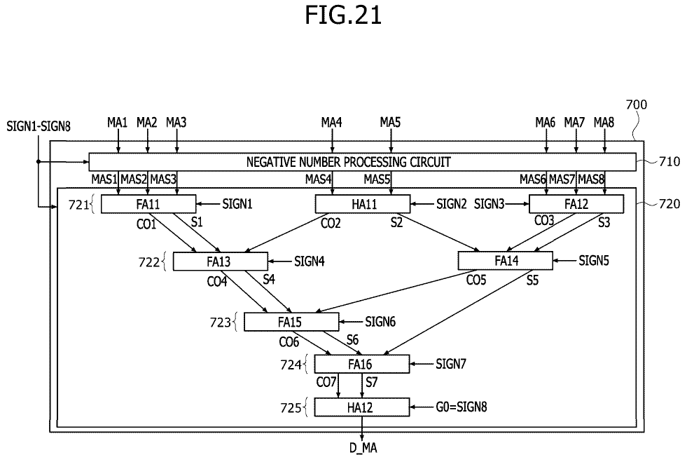

FIG. 21 is a block diagram illustrating an adder circuit according to an embodiment of the present disclosure. An adder circuit 700 may be applied to an adder circuit used in many of the examples of artificial intelligence accelerators described with reference to FIGS. 1 through 20.

Referring to FIG. 21, an adder circuit 700 may receive mantissa data of a plurality of floating point data as input data. The adder circuit 700 may receive eight mantissa data, i.e., first to eighth mantissa data MA1-MA8, as input data. However, this is merely an example, and a larger or small number of mantissa data may be input to the adder circuit 700. The first to eighth mantissa data MA1-MA8 may be included in the first to eighth floating point data, respectively. The first to eighth mantissa data MA1-MA8 may be a positive or negative number, a positive number or a negative number referring to a positive value or a negative value, respectively. The floating point data having positive mantissa data, among the first to the eighth mantissa data MA1-MA8, may have a sign data value of “0”. On the other hand, the floating point data having negative mantissa data, among the first to eighth mantissa data MA1-MA8, may have a sign data value of “1”. The adder circuit 700 may add all of the first to eighth mantissa data MA1-MA8 and may output mantissa addition data D_MA generated as a result of the addition. In one embodiment, the adder circuit 700 may include a negative number processing circuit 710 and an adder tree 720.

The negative number processing circuit 710 may perform negative number processing on the negative mantissa data, among the first to eighth mantissa data MA1-MA8. Conventionally, the negative number processing for the negative mantissa data may be performed by the 2's complement processing. However, the negative number processing circuit 710 may perform the negative number processing by only performing an inversion processing of the negative mantissa data without performing the 2's complement processing. Accordingly, the negative number processing circuit 710 may only include logic for inverting the first to eighth mantissa data MA1-MA8 and might not include logic for performing a “+1” operation (i.e., adding a “1”) required for the 2's complement processing. Accordingly, the circuit area for implementing the negative number processing circuit 710 may be reduced.

More specifically, the negative number processing circuit 710 may receive the first to eighth mantissa data MA1-MA8 and first to eighth sign data SIGN1-SIGN8 as input data. The first sign data SIGN1 may be the sign data of the first floating-point data that include the first mantissa data MA1. In other words, the first sign data SIGN1 may represent the sign of the first mantissa data MA1. Similarly, the eighth sign data SIGN8 may be the sign data of the eighth floating point data that include the eighth mantissa data MA8. In other words, the eighth sign data SIGN8 may represent the sign of the eighth mantissa data MA8. The negative number processing circuit 710 may output first to eighth selected mantissa data MAS1-MAS8. The first to eighth selected mantissa data MAS1-MAS8 may be mantissa data or inverted mantissa data based on the values of the first to eighth sign data SIGN1-SIGN8. The negative number processing circuit 710 may transmit the first to eighth selected mantissa data MAS1-MAS8 to the adder tree 720.

The adder tree 720 may perform an addition operation on the first to eighth selected mantissa data MAS1-MAS8 that may be output from the negative number processing circuit 710. The adder tree 720 may output the mantissa addition data D_MA. The adder tree 720 may have a plurality of stages. More specifically, the adder tree 720 may include a first stage 721, a second stage 722, a third stage 723, a fourth stage 724, and a fifth stage 725, which are sequentially arranged from highest to lowest. With the exception of the fifth stage 725 that is the lowest stage, the remaining stages (i.e., the first to fourth stages 721-724) may include at least one full-adder. The first stage 721 to the fourth stage 724 may or might not include a half-adder. In this example, a single half-adder may be disposed in the first stage 721. And in the final stage, the fifth stage 725, another single half-adder may be disposed.

In the first stage 721 of the adder tree 720, as illustrated in FIG. 21, a first full-adder FA11, a first half-adder HA11, and a second full-adder FA12 may be disposed. At the second stage 722 of the adder tree 720, a third full adder FA13 and a fourth full adder FA14 may be disposed. At the third stage 723 of the adder tree 720, a fifth full-adder FA15 may be disposed. At the fourth stage 724 of the adder tree 720, a sixth full-adder FA16 may be disposed. And at the fifth stage 725 of the adder tree 720, a second half-adder HA12 may be disposed. The first full adder FA11, the second full adder FA12, and the first half-adder FA11 of the first stage 721 may operate in parallel. The third full-adder FA13 and fourth full-adder FA14 of the second stage 722 may also operate in parallel.

Eight adders included in the adder tree 720 may receive first to eighth sign data SIGN1-SIGN8, respectively. The first full adder FA11 may receive the first sign data SIGN1. The first half-adder HA11 may receive second sign data SIGN2. The second full-adder FA12 may receive third sign data SIGN3. The third full-adder FA13 may receive fourth sign data SIGN4. The fourth full-adder FA14 may receive fifth sign data SIGN5. The fifth full-adder FA15 may receive sixth sign data SIGN6. The sixth full-adder FA16 may receive seventh sign data SIGN7. And the second half-adder HA12 may receive the eighth sign data SIGN8.

The first full-adder FA11 of the first stage 721 may receive first to third selected mantissa data MAS1-MAS3 that are output from the negative number processing circuit 710. The first full-adder FA11 may perform an addition operation on the first to third selected mantissa data MAS1-MAS3 and an LSB addition operation on carry data. The first full-adder FA11 may output first summation data S1 and first carry output data CO1. The first half-adder HA11 of the first stage 721 may receive fourth and fifth selected mantissa data MAS4 and MAS5 that are output from the negative number processing circuit 710. The first half-adder HA11 may perform an addition operation on the fourth and fifth selected mantissa data MAS4 and MAS5 and may perform an LSB addition operation on carry data. The first half-adder HA11 may output second summation data S2 and second carry output data CO2. The second full-adder FA12 of the first stage 721 may receive sixth to eighth selected mantissa data MAS6-MAS8 that are output from the negative number processing circuit 710. The second full-adder FA12 may perform an addition operation on the sixth to eighth selected mantissa data MAS6-MAS8 and may perform an LSB addition operation on carry data. The second full-adder FA12 may output third summation data S3 and third carry output data CO3.

The third full-adder FA13 of the second stage 722 may receive the first summation data S1 and the first carry output data CO1 that are output from the first full-adder FA11 of the first stage 721 and may receive the second carry output data CO2 that are output from the first half-adder HA11 of the first stage 721. The third full adder FA13 may perform an addition operation on the first summation data S1, the first carry output data CO1, and the second carry output data CO2 and may perform an LSB addition operation of carry data. The third full adder FA13 may output fourth summation data S4 and fourth carry output data CO4. The fourth full-adder FA14 of the second stage 722 may receive the second summation data S2 that are output from the first half-adder HA11 of the first stage 721 and may receive the third summation data S3 and the third carry output data CO3 that are output from the second full-adder FA12 of the first stage 721. The fourth full-adder FA14 may perform an addition operation on the second summation data S2, the third summation data S3, and the third carry output data CO3 and may perform an LSB addition operation on carry data. The fourth full-adder FA14 may output fifth summation data S5 and fifth carry output data CO5.

The fifth full-adder FA15 of the third stage 723 may receive the fourth summation data S4 and the fourth carry output data CO4 that are output from the third full-adder FA13 of the second stage 722 and may receive the fifth carry output data CO5 that are output from the fourth full-adder FA14 of the second stage 722. The fifth full-adder FA15 may perform an addition operation on the fourth summation data S4, the fourth carry output data CO4, and the fifth carry output data CO5 and may perform an LSB addition operation on carry data. The fifth full-adder FA15 may output sixth summation data S6 and sixth carry output data CO6.

The sixth full-adder FA16 of the fourth stage 724 may receive the fifth summation data S5 that are output from the fourth full-adder FA14 of the second stage 722 and may receive the sixth summation data S6 and the sixth carry output data CO6 that are output from the fifth full-adder FA15 of the third stage 723. The sixth full-adder FA16 may perform an addition operation on the fifth summation data S5, the sixth summation data S6, and the sixth carry output data CO6 and may perform an LSB addition operation on carry data. The sixth full-adder FA16 may output seventh summation data S7 and seventh carry output data CO7.

The second half-adder HA12 of the fifth stage 725 may receive the seventh summation data S7 and the seventh carry output data CO7 that are output from the sixth full adder FA16 of the fourth stage 724. The second half-adder HA12 may perform an addition operation on the seventh summation data S7, the seventh carry output data CO7, and the eighth sign data SIGN8 to output the mantissa addition data D_MA. In one embodiment, the second half-adder HA12 may comprise a prefix adder, such as a Kogge-Stone adder. The prefix adder may divide an addition operation into a plurality of stages and may parallelize the carry generation logic and the carry propagation logic in each stage to perform the addition operation on the seventh summation data S7, the seventh carry output data CO7, and the eighth sign data SIGN8. In this case, the eighth sign data SIGN8 may be input to the second half-adder HA12 as a first carry generation logic value GO of the prefix adder.

The first to sixth full adders FA11-FA16 and the first half-adder HA11 of the adder tree 720 may perform an addition operation on input data to generate and output the first through seventh summation data S1-S7. Although not shown in FIG. 21, the first to sixth full adders FA11-FA16 and first half-adder HA11 of the adder tree 720 may perform an addition operation on the input data to generate first to seventh carry data (not shown in FIG. 1). The first to sixth full adders FA11-FA16 and the first half-adder HA11 of the adder tree 720 may perform LSB addition operations on the first to seventh carry data to generate and output the first to seventh carry output data CO1-CO7. The LSBs added to the first to seventh carry data may have the value of the first to seventh sign data SIGN1-SIGN7, respectively. In one embodiment, when “F”-th (“F” is a natural number from among “1” to “7”) sign data SIGN“F” is “0”, “F”-th carry output data CO“F” may be generated by adding new LSB with a value of “0” to “F”-th carry data. On the other hand, when the “F”-th sign data SIGN“F” is “1”, the “F”-th carry output data CO“F” may be generated by adding new LSB with a value of “1” to the “F”-th carry data. The second half-adder HA12 may perform an addition operation by adding the seventh summation data S7, the seventh carry output data CO7 that are output from the sixth full adder FA16, and the eighth sign data SIGN8.

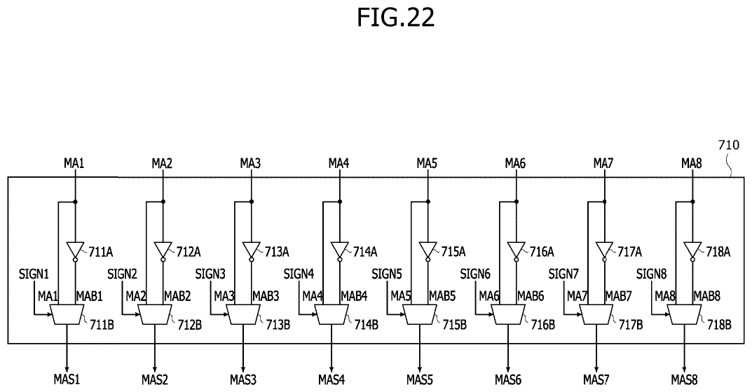

FIG. 22 is a circuit diagram illustrating one example of a negative number processing circuit included in the adder circuit of FIG. 21.

Referring to FIG. 22, the negative number processing circuit 710 may include a plurality of inverters and a plurality of selectors. The number of inverters and the number of selectors comprising the negative number processing circuit 710 may be equal to the number of mantissa data that are transmitted to the negative number processing circuit 710. Accordingly, the negative number processing circuit 710 may include first to eighth inverters 711A-718A and first to eighth selectors 711B-718B. The first to eighth inverters 711A-718A may receive the first to eighth mantissa data MA1-MA8, respectively. The first to eighth inverters 711A-718A may invert the values of the first to eighth mantissa data MA1-MA8 to output first to eighth inverted mantissa data MAB1-MAB8. In one embodiment, the first to eighth selectors 711B-718B may be 2:1 multiplexers. The first to eighth selectors 711B-718B may have a first input terminal, a second input terminal, a selection terminal, and an output terminal. The first to eighth selectors 711B-718B may receive the first to eighth mantissa data MA1-MA8 through the first input terminals, respectively. The first to eighth selectors 711B-718B may receive output data of the first to eighth inverters 711A-718A, i.e., the first to eighth inverted mantissa data MAB1-MAB8, through the second input terminals, respectively. The first to eighth selectors 711B-718B may receive the first to eighth sign data SIGN1-SIGN8 through the selective terminals, respectively. The first to eighth selectors 711B-718B may output the first to eighth selected mantissa data MAS1-MAS8 through the output terminals, respectively.

When sign data SIGN is “0” (i.e., positive mantissa data), the first to eighth selectors 711B-718B may output the mantissa data MA that are input to the first input terminal as the selected mantissa data MAS. When the sign data SIGN is “1” (i.e., negative mantissa data), the first to eighth selectors 711B-718B may output the inverted mantissa data MAB that are input to the second input terminal as the selected mantissa data MAS. For example, when the first sign data SIGN1 is “0”, the first selector 711B may output the first mantissa data MA1 as the first selected mantissa data MAS1. When the first sign data SIGN1 is “1”, the first selector 711B may output the first inverted mantissa data MAB1 as the first selected mantissa data MAS1. When the second sign data SIGN2 is “0”, the second selective output 712B may output the second mantissa data MA2 as the second selected mantissa data MAS2. When the second sign data SIGN2 is “1”, the second selective output 712B may output the second inverted mantissa data MAB2 as the second selected mantissa data MAS2. The third to eighth selectors 713B-718B may output the third to eighth selected mantissa data MAS3-MAS8 in the same manner as the first and second selectors 711B and 712B.

As described so far, the negative number processing circuit 710 may output the inverted mantissa data only for negative mantissa data and may output positive mantissa data based on the sign of the first to eighth sign data SIGN1-SIGN8. In the case of performing the “2” compensation processing for the negative mantissa data, inversion processes and “+1” operations may be performed. Thus, even if negative number processing is performed in the negative number processing circuit 710, “+1” operations, corresponding to the number of negative mantissa data, may be omitted. For example, when the first, fourth, seventh, and eighth mantissa data MA1, MA4, MA7, MA8 are negative, the first, fourth, seventh, and eighth selected mantissa data MAS1, MAS4, MAS7, MAS8 may consist of the first, fourth, seventh, and eighth inverted mantissa data MAB1, MAB4, MAB7, MAB8. In this case, in the negative number processing circuit 710, only the inversion processing has been performed for the first, fourth, seventh, and eighth selected mantissa data MAS1, MAS4, MAS7, MAS8, among the inversion processing and “+1” operation processing of the 2's complement processing, so that the four “+1” operations are omitted. The four omitted “+1” operations in the negative number processing circuit 710 may be performed through a LSB addition operation and the input data addition operation for the carry data in the adder tree 720.

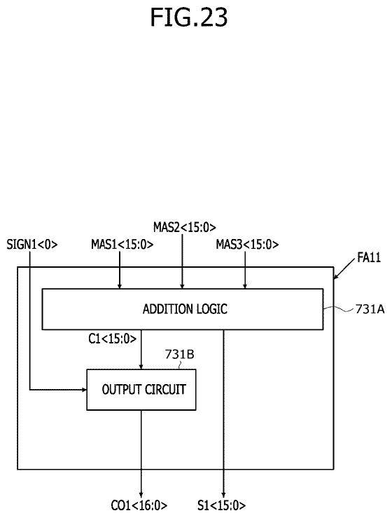

FIG. 23 is a block diagram illustrating one example of a first full-adder of an adder tree included in the adder circuit of FIG. 21. Hereinafter, it is assumed that the mantissa data MA and the selected mantissa data MAS are each 16-bit binary stream.

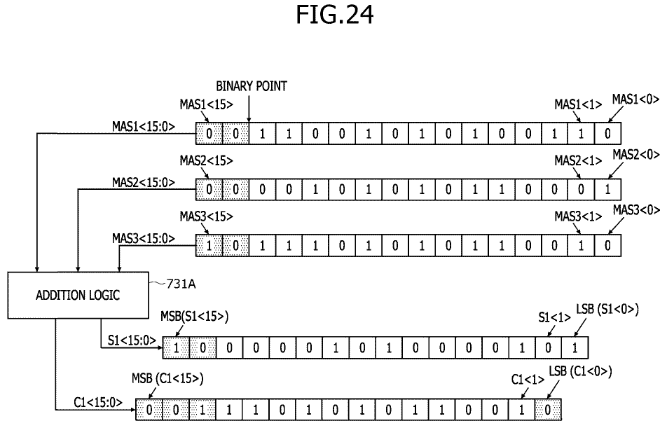

Referring to FIG. 23, the first full-adder FA11 may include an addition logic 731A and an output circuit 731B. The addition logic 731A of the first full-adder FA11 may receive the first selected mantissa data MAS1<15:0>, the second selected mantissa data MAS2<15:0>, and the third selected mantissa data MAS3<15:0> that are output from the negative number processing circuit (710 in FIG. 21). Then, the output circuit 731B of the first full-adder FA11 may receive the first sign data SIGN1. The addition logic 731A of the first full-adder FA11 may perform an addition operation on the first selected mantissa data MAS1<15:0>, the second selected adder data MAS2<15:0>, and the third selected mantissa data MAS3<15:0> and may output first summation data S1<15:0> and first carry data C1<15:0>. The process of generating the first summation data S1<15:0> and the first carry data C1<15:0> in the addition logic 731A of the first full-adder FA11 will be described in more detail below with reference to FIG. 24. The first summation data S1<15:0>, which is output from the addition logic 731A of the first full-adder FA11, may be output from the first full-adder FA11. The first carry data C1<15:0> that are output from the addition logic 731A of the first full-adder FA11 may be input to the output circuit 731B.

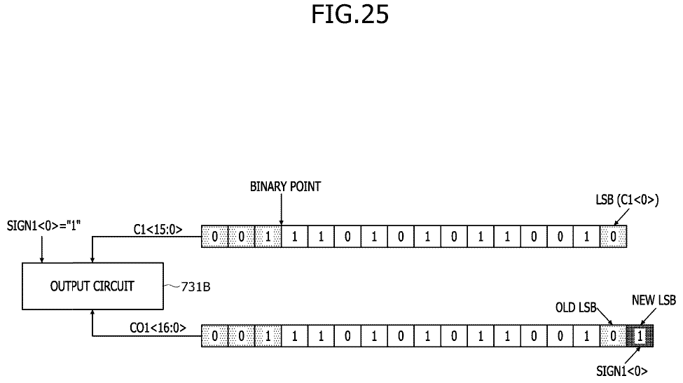

The output circuit 731B of the first full-adder FA11 may generate the first carry output data CO1<16:0> by adding a new LSB to the first carry data C1<15:0> that are input from the addition logic 731A. Accordingly, the first carry output data CO1<16:0> may consist of 17 bits, which is 1 bit greater than the number of bits in the first carry data C1<15:0>. The LSB added to the first carry data C1<15:0> may have the same value as the value of the first sign data SIGN1<0> (i.e., “0” or “1”). The process of generating the first carry output data CO1<16:0> in the output circuit 731B of the first full-adder FA11 will be described in more detail below with reference to FIG. 25. The first carry output data CO1<16:0> generated in the output circuit 731B of the first full-adder FA11 may be output from the first full-adder FA11.

FIG. 24 is a diagram illustrating an addition operation of an adding logic included in the first full-adder of FIG. 23. And FIG. 25 is a diagram illustrating a LSB addition process of an output circuit included in the first full-adder of FIG. 23. Hereinafter, it is assumed that first selected mantissa data MAS1<15:0>, second selected mantissa data MAS2<15:0>, and third selected mantissa data MAS3<15:0>, which are input to the addition logic 731A, may have values of “00.1100 1010 1001 10,” “00.0010 1010 0100 01,” and “10.1110 1010 1100 10,” respectively. In the first selected mantissa data MAS1<15:0>, the second selected mantissa data MAS2<15:0>, and the third selected mantissa data MAS3<15:0>, the number of bits to the left of the binary point is “2” and the number of bits to the right of the binary point is “14”.

First, referring to FIG. 24, the addition logic 731A of the first full-adder FA11 may receive the first selected mantissa data MAS1<15:0>, the second selected mantissa data MAS2<15:0>, and the third selected mantissa data MAS3<15:0> and may output first summation data S1<15:0> and first carry data C1<15:0>. When “X” is a natural number from among 1 to 16, a “X”-th bit S1<X−1> of the first summation data S1<15:0> may have a summation value resulting from adding a value of a “X”-th bit MAS1<X−1> of the first selected mantissa data MAS1<X−1>, a value of a “X”-th bit MAS2<X−1> of the second selected mantissa data MAS2<15:0>, and a value of a “X”-th bit MAS3<X−1> of the third selected mantissa data MAS3<15:0>. A carry value generated by this addition process might not be reflected in the first summation data S1<15:0>. A “X”-th bit C1<X−1> of the first carry data C1<15:0> may be a carry value generated as a result of adding the value of the “X”-th bit MAS1<X−1> of the first selected mantissa data (MAS1<15:0>), the value of the “X”-th bit MAS2<X−1> of the second selected mantissa data MAS2<X−1>, and the value of the “X”-th bit MAS3<X−1> of the third selected mantissa data MAS3<15:0>.

As illustrated in FIG. 24, a value of a first bit (i.e., LSB) S1<0> of the first summation data S1<15:0> may be a value of “1”, which is a summation value resulting from adding “0”, which is a value of a first bit MAS1<0> of the first selected mantissa data MAS1<15:0>, “0”, which is a value of a first bit MAS2<0> of the second selected mantissa data MAS2<15:0>, and “1”, which is a value of a first bit MAS3<0> of the third selected mantissa data MAS3<15:0>. A value of the second bit S1<1> of the first summation data S1<15:0> may be “0”, which is a summation value resulting from adding “1”, which is a value of a second bit MAB1<1> of the first selected mantissa data MAS1<15:0>, “0”, which is a value of a second bit MAS1<1> of the second selected mantissa data MAS2<15:0>, and “1”, which is a value of a second bit MAS2<1> of the third selected mantissa data MAS2<1>. The carry value “1” may be generated during this addition operation, but the carry value is not reflected in the first summation data S1<15:0>. Similarly, a value of the sixteenth bit (i.e., MSB) S1<15> of the first summation data S1<15:0> may be a value of “0”, which is a summation value resulting from adding “0”, which is a value of a sixteenth bit MAB1<15> of the first selected mantissa data MAS1<15:0>, “0”, which is a value of a sixteenth bit MAS2<15> of the second selected mantissa data MAS2<15:0>, and “1”, which is a value of a sixteenth bit MAS3<15> of the third selected mantissa data MAS3<15:0>. In this way, the addition logic 731A of the first full-adder FA11 may output “10.0000 1010 0001 01” as the first summation data S1<15:0>.

A value of a first bit (i.e., LSB) C1<0> of the first carry data C1<15:0> may be “0”, which is the carry value generated as a result of adding “0”, which is the value of the first bit MAS1<0> of the first selected mantissa data MAS1<15:0>, “1”, which is the value of the first bit MAS2<0> of the second selected mantissa data MAS2<15:0>, and “0”, which is the value of the first bit MAS3<0> of the third selected mantissa data MAS3<15:0>. A value of a second bit C1<1> of the first carry data C1<15:0> may be “1”, which is the carry value generated as a result of adding “1”, which is the value of the second bit MAS1<1> of the first selected mantissa data MAS1<15:0>, “0”, which is the value of the second bit MAS2<1> of the second selected mantissa data MAS2<15:0>, and “1”, which is the value of the second bit MAS3<1> of the third selected mantissa data MAS3<15:0>. Similarly, a value of the sixteenth bit (i.e., MSB) C1<15> of the first carry data C1<15:0> may be “0”, which is the carry value generated as a result of adding “0”, which is the value of the sixteenth bit MAS1<15> of the first selected mantissa data MAS1<15:0>, “0”, which is the value of the sixteenth bit MAS2<15> of the second selected mantissa data MAS2<15:0>, and “1”, which is the value of the sixteenth bit MAS3<15> of the third selected mantissa data MAS3<15:0>. In this way, the addition logic 731A of the first full-adder FA11 may output the first carry data C1<15:0> of “001.1101 0101 1001 0”.

The first summation data S1<15:0> may have the same format as the first selected mantissa data MAS1<15:0>, the second selected mantissa data MAS2<15:0>, and the third selected mantissa data MAS3<15:0>, with 2 bits to the left of the binary point and 14 bits to the right of the binary point. On the other hand, the first carry data C1<15:0>, which consists of carry values generated during the addition operation, may have the format of 3 bits to the left of the binary point and 13 bits to the right of the binary point. In other words, based on the binary point, the first carry data C1<15:0> may increase the number of bits to the left of the binary point by one compared to the first summation data S1<15:0>, while the number of bits to the right of the binary point decreases by one. Accordingly, the position of the LSB C1<0> of the first carry data C1<15:0> may be the same as the position of the second bit S1<1> of the first summation data S1<15:0> with respect to the binary point.

Referring next to FIG. 25, the output circuit 731B of the first full-adder FA11 may receive first carry data C1<15:0> and may output first carry out data CO1<16:>. The first carry out data CO1<16:> may be generated by adding a new LSB having the value of first sign data SIGN1<0> to the lower bit position (represented as “NEW LSB” in FIG. 25) of the LSB position (represented as “OLD LSB” in FIG. 25) of the first carry data C1<16:0> based on the binary point. Accordingly, the first carry output data CO1<16:0> may have a size of 17 bits, which is 1 bit greater than the first carry data C1<15:0> of 16 bits. The number of bits to the left of the binary point in the first carry output data CO1<16:0> may be the same as the number of bits to the left of the binary point in the first carry data C1<15:0>. On the other hand, the number of bits to the right of the binary point of the first carry output data CO1<16:0> may be one more than the number of bits to the right of the binary point of the first carry data C1<15:0>. In one embodiment, when the first sign data SIGN1<0> is “1”, the output circuit 731B receiving the first carry data C1<15:0> of “001.1101 0101 1001 0” may output the first carry output data CO1<16:0> of “001.1101 0101 1001 01”.

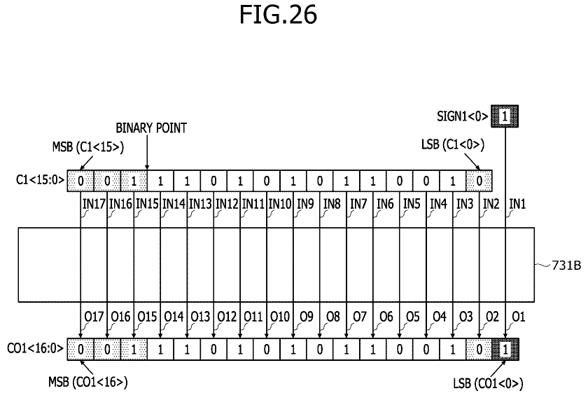

FIG. 26 is a diagram illustrating one example of an output circuit included in the first full-adder of FIG. 23.

Referring to FIG. 26, an output circuit 731B of the first full-adder FA11 may be implemented with a plurality of input and output interconnection lines, without including any additional logic circuits. Specifically, the output circuit 731B of the first full-adder FA11 may have first to seventeenth input lines IN1-IN17 and first to seventeenth output lines O1-O17. The first to seventeenth input lines IN1-IN17 may each be directly coupled to the first to seventeenth output lines O1-O17, respectively, in the output circuit 731B. Data input to the output circuit 731B through the first input line IN1 may be output from the output circuit 731B through the first output line O1. Data input to the output circuit 731B through the second input line IN2 may be output from the output circuit 731B through the second output line O2. Data input to the output circuit 731B through the third input line IN3 may be output from the output circuit 731B through the third output line O3. Similarly, data input to the output circuit 731B through the seventeenth input line IN17 may be output from the output circuit 731B through the seventeenth output line O17.

The output circuit 731B may be configured such that the first sign data SIGN1<0> may be input through the first input line IN1, and each bit of the 16 bits of the first carry data C1<15:0> may be input through the second to seventeenth input lines IN2-IN17. Accordingly, the LSB C1<0> of the first carry data C1<15:0> may be input to the output circuit 731B through the second input line IN2. The second to fifteenth bits of the first carry data C1<15:0> may be input to the output circuit 731B through the third to sixteenth input lines IN3-IN16, respectively. And the MSB C1<15> of the first carry data C1<15:0> may be input to the output circuit 731B through the seventeenth input line IN17.

The first sign data SIGN<0> input through the first input line IN1 may be output from the output circuit 731B as the LSB CO1<0> of the first carry output data CO1<16:0> through the first output line O1. The LSB C1<0> of the first carry data C1<15:0> input through the second input line IN2 may be output from the output circuit 731B as a second bit of the first carry output data CO1<16:0> through the second output line O2. The MSB C1<15> of the first carry data C1<15:0> input through the seventeenth input line IN17 may be output from the output circuit 731B as a MSB CO1<16> of the first carry output data CO1<16:0> through the seventeenth output line O17. In the same manner, the second to fifteenth bits of the first carry data C1<15:0> input through the third to sixteenth input lines IN3-IN16 may be output from the output circuit 731B as the third to sixteenth bits of the first carry output data CO1<16:0> through the third to sixteenth output lines O3-016.

The configuration and operation of the first full-adder FA11 described with reference to FIGS. 23 to 26 may be equally applied to the second full-adder FA12 of FIG. 21, which is included in the adder tree 720 of the adder circuit 700. Accordingly, the second full-adder FA12 in FIG. 21 may include an adder logic and an output circuit. The adder logic of the second full-adder FA12 of FIG. 21 may receive sixth to eighth selected mantissas data MAS6-MAS8 and a third sign data SIGN3 as input. The addition logic of the second full-adder FA12 in FIG. 21 may perform an addition operation on the sixth to eighth selected mantissa data MAS6-MAS8 to generate second summation data S2 and second carry data. The output circuit of the second full-adder FA12 of FIG. 21 may add new LSB having the value of the second sign data to the second carry data to generate the second carry output data CO2.

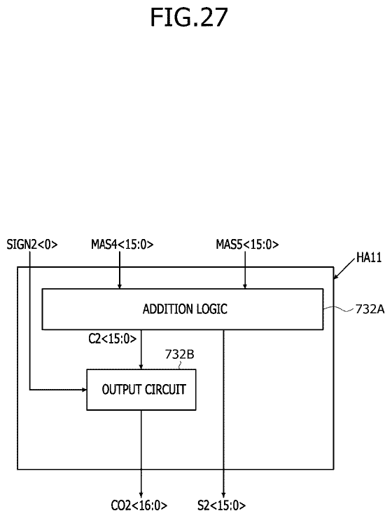

FIG. 27 is a block diagram illustrating one example of a first half-adder of an adder tree included in the adder circuit of FIG. 21.

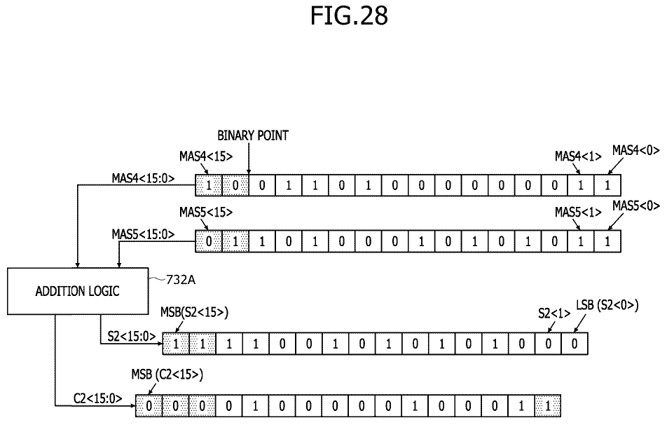

Referring to FIG. 27, a first half-adder HA11 may include an addition logic 732A and an output circuit 732B. The addition logic 732A of the first half-adder HA11 may receive as input the fourth selected mantissa data MAS4<15:0> and the fifth selected mantissa data MAS5<15:0> that are output from the negative number processing circuit 710 in FIG. 21. Also, the output circuit 732B of the first half-adder HA11 may receive as input the second sign data SIGN2<0>. The addition logic 732A of the first half-adder HA11 may perform an addition operation on the fourth selected mantissa data MAS4<15:0> and the fifth selected mantissa data MAS5<15:0> to output second summation data S2<15:0> and second carry data C2<15:0>. The process of generating the second summation data S2<15:0> and the second carry data C2<15:0> in the addition logic 732A of the first half-adder HA11 will be described in more detail below with reference to FIG. 28. The second summation data S2<15:0> that is output from the addition logic 732A may be output from the first half-adder HA11. The second carry data C2<15:0> that is output from the addition logic 732A may be transferred to the output circuit 732B.

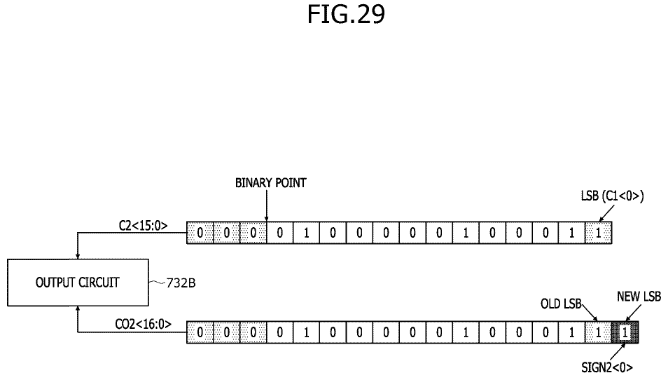

The output circuit 732B of the first half-adder HA11 may generate second carry output data CO2<16:0> by adding a new LSB to the second carry data C2<15:0> that is transmitted from the addition logic 732A. Accordingly, the second carry output data CO2<16:0> may consist of 17 bits, which is 1 bit greater than the number of bits in the second carry data C2<15:0> (i.e., 16 bits). The new LSB that is added to the second carry data C2<15:0> may have the same value as the value of the second sign data SIGN2<0>. The process of generating the second carry output data CO2<16:0> in the output circuit 732B of the first half-adder HA11 will be described in more detail below with reference to FIG. 29. The second carry output data CO2<16:0> that is generated in the output circuit 732B may be output from the first half-adder HA11. The output circuit 732B of the first half-adder HA11 may be configured in the same manner as the output circuit 731B of the first full adder FA11 described with reference to FIG. 26.

FIG. 28 is a diagram illustrating an addition operation of an adding logic included in the first half-adder of FIG. 27. And FIG. 29 is a diagram illustrating a LSB addition process of an output circuit included in the first half-adder of FIG. 27. Hereinafter, it may be assumed that the fourth selected mantissa data MAS4<15:0> and the fifth selected mantissa data MAS5<15:0> input to the addition logic 732A have values of “10.0110 1000 0000 11” and “01.1010 0010 1010 11”, respectively. Also, it may be assumed that the second sign data SIGN2<0> input to the output circuit 732B is “1”.

First, referring to FIG. 28, the addition logic 732A of the first half-adder HA11 may receive the fourth selected mantissa data MAS4<15:0> and the fifth selected mantissa data MAS5<15:0> and may output second summation data S2<15:0> and second carry data C2<15:0>. When “X” is a natural number from among 1 to 16, a “X”-th bit S2<X−1> of the second summation data S2<15:0> that is output from the addition logic 732A may have the value resulting from adding a value of a “X”-th bit MAS4<X−1> of the fourth selected mantissa data MAS4<15:0> and a value of a “X”-th bit MAS5<X−1> of the fifth selected mantissa data MAS5<15:0>. A carry value generated during this addition process might not be reflected in the second summation data S2<15:0>. The addition logic 732A may output “11.1100 1010 1010 1010 00” as the second summation data S2<15:0>. A “X”-th bit C2<X−1> of the second carry data C2<15:0> that is output from the addition logic 732A may have a carry value generated as a result of adding the value of the “X”-th bit MAS4<X−1> of the fourth selected mantissa data MAS4<15:0> and the value of the “X”-th bit MAS5<X−1> of the fifth selected mantissa data MAS5<15:0>. The addition logic 732A may output the second carry data C2<15:0> of “000.0100 0001 0001 0001 1”. As in the case of the first full-adder FA11, the second summation data S2<15:0> may have the same format as the fourth selected mantissa data MAS4<15:0> and the fifth selected mantissa data MAS5<15:0>, which is two bits to the left of the binary point and 14 bits to the right of the binary point. The second carry data C2<15:0> may have the format of 3 bits to the left of the binary point and 13 bits to the right of the binary point.

Referring next to FIG. 29, the output circuit 732B of the first half-adder HA11 may be configured to generate the second carry out data CO2<16:0> by adding a new LSB having a value of second sign data SIGN2<0> to a lower bit position (labeled “NEW LSB” in FIG. 29) of a LSB position (labeled “OLD LSB” in FIG. 29) of the second carry data C2<15:0> based on a binary point. As a result, the second carry output data CO2<16:0> may have a size of 17 bits, which is 1 bit greater than the second carry data C2<15:0> of 16 bits. The number of bits to the left of the binary point in the second carry output data CO2<16:0> may be the same as the number of bits to the left of the binary point in the second carry data C2<15:0>. On the other hand, the number of bits to the right of the binary point of the second carry output data CO2<16:0> may be one more than the number of bits to the right of the binary point of the second carry data C2<15:0>. In an embodiment, when the second sign data SIGN2<0> is “1”, the output circuit 731B that receives the second carry data C2<15:0> of “000.0100 0001 0001 1” may output the second carry output data CO2<16:0> of “000.0100 0001 0001 11”.

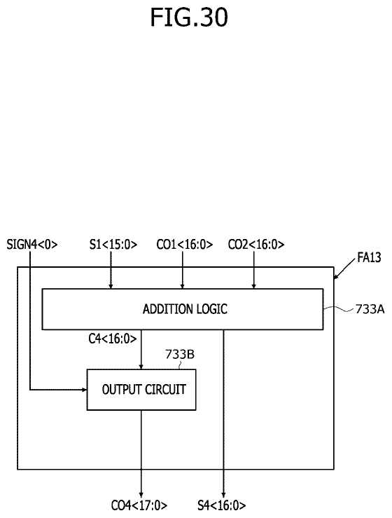

FIG. 30 is a block diagram illustrating one example of a third full-adder of an adder tree included in the adder circuit of FIG. 21.

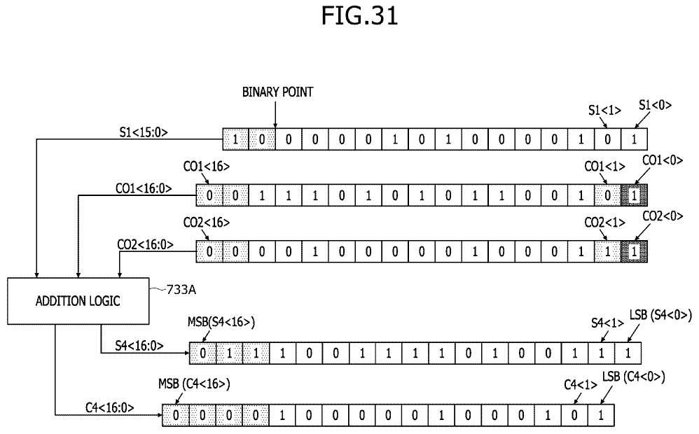

Referring to FIG. 30, the third full-adder FA13 may include an addition logic 733A and an output circuit 733B. The addition logic 733A of the third full-adder FA13 may receive first summation data S1<15:0> and first carry output data CO1<16:0> that are output from the first full-adder FA11, and second carry output data CO2<16:0> that is output from the first half-adder HA11. Also, the output circuit 733B of the third full-adder FA13 may receive fourth sign data SIGN4<0>. The addition logic 733A of the third full-adder FA13 may perform an addition on the first summation data S1<15:0>, the first carry output data CO1<16:0>, and the second carry output data CO2<16:0> to output the fourth summation data S4<16:0> and the fourth carry data C4<16:0>. The process of generating the fourth summation data S4<16:0> and the fourth carry data C4<16:0> in the addition logic 733A of the third full-adder FA13 will be described in more detail below with reference to FIG. 31. The fourth summation data S4<16:0> that is output from the addition logic 733A may be output from the third full-adder FA13. The fourth carry data C4<16:0> that is output from the addition logic 733A may be transmitted to the output circuit 733B of the third full-adder FA13.

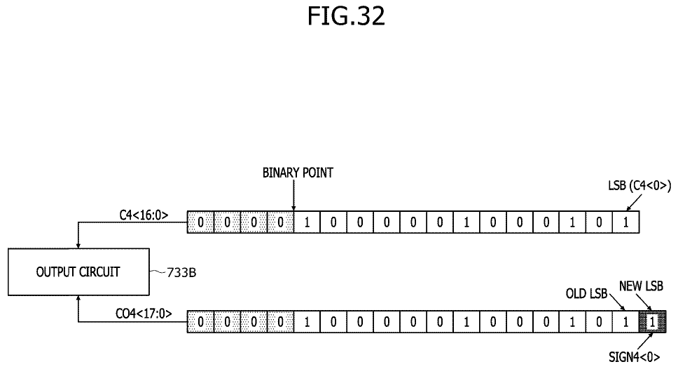

The output circuit 733B of the third full-adder FA13 may generate fourth carry output data CO4<17:0> by adding a new LSB to the fourth carry data C4<16:0> that is transmitted from the addition logic 733A. Accordingly, the fourth carry output data CO4<17:0> may consist of 18 bits, which is 1 bit greater than the number of bits in the fourth carry data C4<16:0> (i.e., 17 bits). The new LSB added to the fourth carry data C4<16:0> may have the same value as the value of the fourth sign data SIGN4<0>. The process of generating the fourth carry output data CO4<17:0> in the output circuit 733B of the third full-adder FA13 will be described in more detail below with reference to FIG. 32. The fourth carry output data CO4<17:0> generated by the output circuit 733B of the third full-adder FA13 may be output from the third full-adder FA13.

FIG. 31 is a diagram illustrating an addition operation of an adding logic included in the third full-adder of FIG. 30. And FIG. 32 is a diagram illustrating a LSB addition process of the output circuit included in the third full-adder of FIG. 30. Hereinafter, it may be assumed that the third full-adder FA13 may receive first summation data S1<15:0> of “10.0000 1010 0001 01”, first carry output data CO1<16:0> of “001.1101 0101 1001 01”, second carry output data CO2<16:0> of “000.0100 0001 0001 11”, and fourth sign data SIGN4<0> of “1”.

First, referring to FIG. 31, the addition logic 733A of the third full-adder FA13 may receive the first selected mantissa data MAS1<15:0>, the first carry output data CO1<16:0>, and the second carry output data CO2<16:0> and may output fourth summation data S4<16:0> and fourth carry data C4<16:0>. When “X” is a natural number from among 1 to 16, a “X”-th bit S4<X−1> of the fourth summation data S4<16:0> that is output from the addition logic 733A may have a value of a LSB of the data resulting from adding a value of a “X”-th bit S1<X−1> of the first summation data S1<16:0>, a value of a “X”-th bit CO1<X−1> of the first carry output data CO1<16:0>, and a value of a “X”-th bit CO2<X−1> of the second carry output data (CO2<16:0>). And the seventeenth bit S4<16>, which is a MSB of the fourth summation data S4<16:0> output from the addition logic 733A may have a summation value resulting from adding a value of a seventeenth bit CO1<16> of the first carry output data CO1<16> and a value of a seventeenth bit CO2<16> of the second carry output data CO2<16:0>. A carry value generated by this addition might not be reflected in the fourth summation data S4<16:0>.

As illustrated in FIG. 31, a value of a first bit (i.e., LSB) S4<0> of the fourth summation data S4<16:0> may be a value of “1”, which is a summation value resulting from adding “1”, which is a value of a first bit S1<15> of the first summation data S1<16:0>, “1”, which is a value of a first bit CO1<0> of the first carry output data CO1<16:0>, and “1”, which is a value of a first bit CO2<0> of the second carry output data CO2<16:0>. A carry value “1” may be generated by this addition, but it is not reflected in the fourth summed data S4<16:0>. A value of a second bit S4<1> of the fourth summation data S4<16:0> may be a value “1”, which is a summation value resulting from adding “0”, which is a value of a second bit (S1<1>) of the first summation data S1<15:0>, “0”, which is a value of a second bit CO1<1> of the first carry output data CO1<16:0>, and “1”, which is a value of a second bit CO2<1> of the second carry output data CO2<16:0>. Similarly, a value of the seventeenth bit (i.e., MSB) S4<16> of the fourth summation data S4<16:0> may be a value of “1”, which is a summation value resulting from adding “0”, which is a seventeenth bit CO1<16> of the first carry output data CO1<16>, and “0”, which is a seventeenth bit CO2<16> of the second carry output data CO2<16:0>. In this way, the addition logic 733A may output “011.1001 1110 1001 11” as the fourth summation data (S4<16:0>).

A “X”-th bit C4<X−1> of the fourth carry data C4<16:0> may be a carry value generated as a result of adding the value of the “X”-th bit S4<X−1> of the first summation data S1<15:0>, the value of the “X”-th bit (CO1<X−1>) of the first carry output data CO1<16:0>, and the value of the “X”-th bit CO2<X−1> of the second carry output data CO2<16:0>. The seventeenth bit (i.e., MSB) C4<16> of the fourth carry data C4<16:0> may be a carry value generated as a result of adding the value of the seventeenth bit (CO1<16>) of the first carry output data CO1<16:0>) and the value of the seventeenth bit CO2<16> of the second carry output data CO2<16:0>.

As illustrated in FIG. 31, a value of a first bit (i.e., LSB) (C4<0>) of the fourth carry data C4<16:0> may be a value of “1”, which is a carry value resulting from adding “1”, which is a value of a first bit S1<0> of the first summation data (S1<15:0>), “1”, which is a value a first bit CO1<0> of the first carry output data CO1<16:0>, and “1”, which is a value a first bit (CO2<0>) of the second carry output data CO2<16:0>. A value of a second bit C4<1> of the fourth carry data C4<16:0> may be a value of “0”, which is a carry value resulting from adding “0”, which is a value of a second bit S1<1> of the first summation data S1<15:0>, “0”, which is a value of a second bit CO1<1> of the first carry output data CO1<16:0>, and “1”, which is a value of a second bit (CO2<1>) of the second carry output data CO2<16:0>. Similarly, a value of a seventeenth bit (i.e., MSB) C4<16> of the fourth carry data C4<16:0> may be a value of “0”, which is a carry value resulting from adding “0”, which is a MSB CO1<16> of the first carry output data CO1<16>, and “0”, which is a MSB CO2<16> of the second carry output data (CO2<16:0>). In this way, the addition logic 733A may output the fourth carry data C4<16:0> of “0000.1000 0010 0010 1”.

The fourth summation data S4<16:0> may have the same format as the first carry output data CO1<16:0> and the second carry output data CO2<16:0>, which is 3 bits to the left of the binary point and 14 bits to the right of the binary point. On the other hand, the fourth carry data C4<16:0>, which consists of the carry values generated by the addition operation, may have the format of 4 bits to the left of the binary point and 13 bits to the right of the binary point. In other words, in the case of the fourth carry data C4<16:0>, the number of bits to the left of the binary point may be increased by one compared to the fourth sum data S4<16:0>, while the number of bits to the right of the binary point is decreased by one. Accordingly, the position of the LSB C4<0> of the fourth carry data C4<16:0> may be the same as the position of the second bit S4<1> of the fourth summation data S4<16:0> with respect to the binary point.

Referring next to FIG. 32, the output circuit 733B of the third full-adder FA13 may be configured to generate the fourth carry output data CO2<17:0> by adding a new LSB having a value of fourth sign data SIGN4<0> to a lower bit position (labeled “NEW LSB” in FIG. 32) of a LSB position (labeled “OLD LSB” in FIG. 32) of the fourth carry data C4<17:0> based on the binary point. As a result, the fourth carry output data CO4<17:0> may have a size of 18 bits, which is 1 bit greater than the fourth carry data C4<16:0> of 17 bits. The number of bits to the left of the binary point in the fourth carry output data CO4<17:0> may be the same as the number of bits to the left of the binary point in the fourth carry data C4<16:0>. On the other hand, the number of bits to the right of the binary point of the fourth carry output data CO4<17:0> may be one more than the number of bits to the right of the binary point of the fourth carry data C4<16:0>. In an embodiment, when the fourth sign data SIGN4<0> is “1”, the output circuit 733B that may receive the fourth carry data C4<16:0> of “0000.1000 0010 0010 1” may output the fourth carry output data CO4<17:0> of “0000.1000 0010 0010 11”.

The configuration and operation of the third full-adder FA13 described with reference to FIGS. 30 through 32 may be equally applied to the fifth full-adder (FA15 in FIG. 21), which is included in the adder tree 720 of the adder circuit 700. Accordingly, the fifth full-adder (FA15 in FIG. 21) may include an adder logic and an output circuit. The adder logic of the fifth full-adder (FA15 of FIG. 21) may receive fourth summation data S4, fourth carry output data CO4, fifth carry output data CO5, and sixth sign data SIGN6 as inputs. The adder logic of the fifth full-adder (FA15 in FIG. 21) may perform an addition operation on the fourth summation data S4, the fourth carry output data CO4, and the fifth carry output data CO5 to generate the sixth summation data S6 and the sixth carry data. The output circuit of the fifth full-adder (FA15 in FIG. 21) may generate the sixth carry output data CO6 by adding a new LSB having the value of the sixth sign data SIGN6 to the sixth carry data.

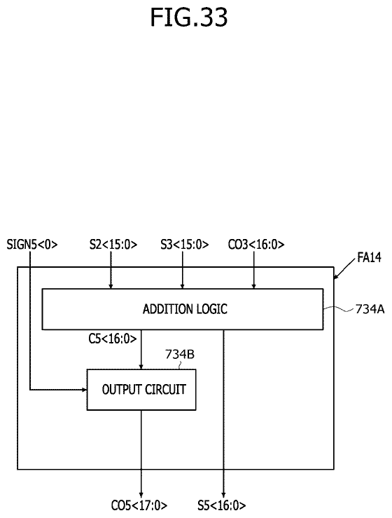

FIG. 33 is a block diagram illustrating one example of a fourth full-adder of an adder tree included in the adder circuit of FIG. 21. The description of the fourth full-adder FA14 below may be equally applied to the sixth full-adder (FA16 in FIG. 21), which receives fifth summation data S5, sixth summation data S6, sixth carry output data CO6, and seventh sign data SIGN7 as inputs, and outputs seventh summation data S7 and seventh carry output data CO7.

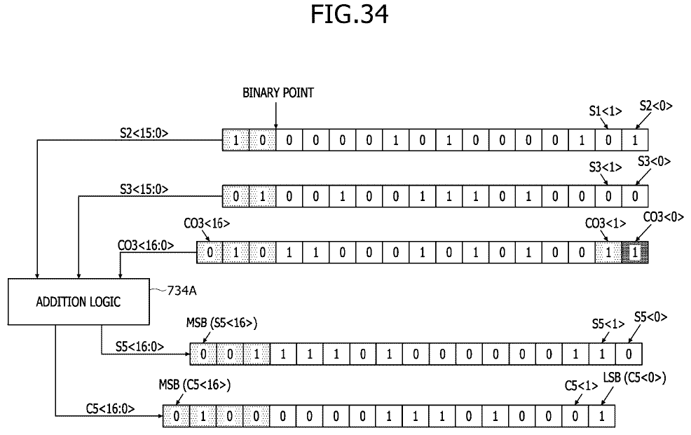

Referring to FIG. 33, the fourth full adder FA14 may include an addition logic 734A and an output circuit 734B. The addition logic 734A of the fourth full-adder FA14 may receive as input the second summation data S2<15:0> that is output from the first half-adder (HA11 in FIG. 21), the third summation data S3<15:0> that is output from the second full-adder (FA12 in FIG. 21), and the third carry output data CO3<16:0> that is output from the second full-adder (FA12 in FIG. 21). Also, the output circuit 734B of the fourth full-adder FA14 may receive fifth sign data SIGN5<0>. The addition logic 734A of the fourth full-adder FA14 may perform an addition operation on the second summation data S2<15:0>, the third summation data S3<15:0>, and the third carry output data CO3<16:0> to output fifth summation data S5<16:0> and fifth carry data C5<16:0>. The process of generating the fifth summation data S5<16:0> and the fifth carry data C5<16:0> in the addition logic 734A of the fourth full-adder FA14 will be described in more detail below with reference to FIG. 34. The fifth summation data S5<16:0> that is output from the addition logic 734A may be output from the fourth full-adder FA14. The fifth carry data C5<16:0> that is output from the addition logic 734A may be transmitted to the output circuit 734B of the fourth full-adder FA14.

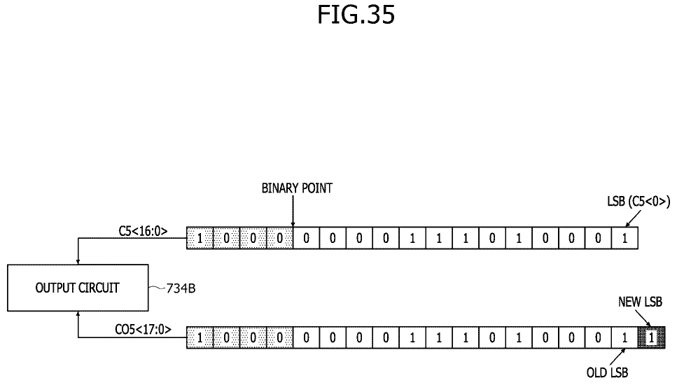

The output circuit 734B of the fourth full-adder FA14 may generate fifth carry data C5<16:0> by adding a new LSB to the fifth carry data C5<16:0>. Accordingly, the fifth carry output data CO5<17:0> may consist of 18 bits, which is 1 bit greater than the number of bits in the fifth carry data C5<16:0> (i.e., 17 bits). The new LSB added to the fifth carry data C5<16:0> may have the same value as the value of the fifth sign data SIGN5<0>. The process of generating the fifth carry output data CO5<17:0> in the output circuit 734B of the fourth full-adder FA14 will be described in more detail below with reference to FIG. 35. The fifth carry output data CO5<17:0> generated in the output circuit 734B may be output from the fourth full-adder FA14.

FIG. 34 is a diagram illustrating an addition operation of an adding logic included in the fourth full-adder of FIG. 33. And FIG. 35 is a diagram illustrating a LSB addition process of an output circuit included in the fourth full-adder of FIG. 33. Hereinafter, it may be assumed that the fourth full-adder FA14 receives second summation data S2<15:0> of “11.1100 1010 1010 00”, third summation data S3<15:0> of “01.0010 0111 0100 00”, third carry output data CO3<16:0> of “010.1100 0101 0100 11”, and fifth sign data SIGN5<0> of “1”.

First, referring to FIG. 34, the addition logic 734A of the fourth full-adder (FA14 in FIG. 33) may receive the second summation data S2<15:0>, the third summation data S3<15:0>, and the third carry output data CO3<16:0> and may output fifth summation data S5<16:0> and fifth carry data C5<15:0>. When “X” is a natural number from among 1 to 16, the “X”-th bit S5<X−1> of the fifth summation data S5<16:0> may have a summation value resulting from adding a value of a “X”-th bit S2<X−1> of the second summation data S2<15:0>, a value of a “X”-th bit S3<X−1> of the third summation data S3<15:0>, and a value of a “X”-th bit CO3<X−1> of the third carry output data CO3<16:0>. A “X+1” bit S5<X> of the fifth summation data S5<16:0> that may be output from the addition logic 734A has a value of the “X+1” bit CO3<X> of the third carry output data CO3<16:0>.

As illustrated in FIG. 34, a value of a first bit S5<0> (i.e., LSB) of the fifth carry output data S5<16:0> may have a value of “0”, which is a summation value resulting from adding “1”, which is a value of a first bit S2<0> of the second carry output data S2<15:0>, “0”, which is a value of a first bit S3<0> of the third carry output data S3<15:0>, and “1”, which is a value of a first bit CO3<0> of the third carry output data CO3<16:0>. The first bit CO3<0> of the third carry output data CO3<16:0> may be the new LSB added in the second full-adder (FA12 in FIG. 21). A carry value “1” may be generated by this addition, but it is not reflected in the fifth summed data S5<16:0>. A value of a second bit S5<1> of the fifth summation data S5<16:0> may be a value of “1”, which is a summation value resulting from adding “0”, which is a value of a second bit S2<1> of the second carry output data S2<15:0>, “0”, which is a value of a second bit S3<1> of the third carry output data S3<15:0>, and “1”, which is a value of a second bit CO3<1> of the third carry output data CO3<16:0>. A value of a seventeenth bit (i.e., MSB) S5<16> of the fifth summation data S5<16:0> may be a value of “0”, which is a value of the seventeenth bit CO3<16> of the third carry output data CO3<16>. In the same manner, the addition logic 734A may output “001.1110 1000 0001 10” as the fifth carry data S5<16:0>.

A “X”-th bit C5<X−1> of the fifth carry data C5<16:0> may have a carry value of the “X”-th bit S2<X−1> of the second summation data S2<15:0>, the value of the “X”-th bit S2<X−1> of the third summation data (S3<15:0>), and the value of the “X”-th bit CO3<X−1> of the third carry output data CO3<16:0>. A “X”-th bit (i.e., MSB) C5<X> of the fifth carry data C5<16:0> may have a value of “0”.

As illustrated in FIG. 34, a value of a first bit (i.e., LSB) C5<0> of the fifth carry data C5<16:0> may be “1”, which is a carry value resulting from adding “1”, which is a value of a first bit S2<0> of the second carry output data S2<15:0>, “0”, which is a value of a first bit S3<0> of the third carry output data S3<15:0>, and “1”, which is a value of a first bit CO3<0> of the third carry output data CO3<16:0>. A value of a second bit C5<1> of the fifth carry data C5<16:0> may be “0”, which is a carry value resulting from adding “0”, which is a value of a second bit S2<1> of the second carry output data S2<15:0>, “0”, which is a value of a second bit S3<1> of the third carry output data S3<15:0>, and “1”, which is a value of a second bit CO3<1> of the third carry output data CO3<16:0>. The value of the seventeenth bit (i.e., MSB) C5<16> of the fifth carry data C5<16:0> may be “0”. In this way, the addition logic 734A may output the fifth carry data C5<16:0> of “0100.0000 1110 1000 1”.

The fifth summation data S5<16:0> may have the same format as the third carry output data CO3<16:0>, which is 3 bits to the left of the binary point and 14 bits to the right of the binary point. On the other hand, the fifth carry data C5<16:0>, which consists of the carry values generated during the addition operation, may have the format of 4 bits to the left of the binary point and 13 bits to the right of the binary point. In other words, in the case of the fifth carry data C5<16:0>, the number of bits to the left of the binary point may be increased by one compared to the fifth sum data S5<16:0>, while the number of bits to the right of the binary point is decreased by one. Accordingly, the position of the LSB C4<0> of the fifth carry data C5<16:0> may be the same as the position of the second bit S5<1> of the fifth summation data S5<16:0> with respect to the binary point.

Referring next to FIG. 35, the output circuit 734B of the fourth full-adder FA14 may be configured to generate a fifth carry output data CO5<17:0> by adding a new LSB having a value of fifth sign data SIGN5<0> to a lower bit position (labeled “NEW LSB” in FIG. 35) of a LSB position (labeled “OLD LSB” in FIG. 35) of the fifth carry data C5<16:0> based on a binary point. Accordingly, the fifth carry output data CO5<17:0> may have a size of 18 bits, which is an increase of 1 bit of the LSB compared to the fifth carry data C5<16:0> of 17 bits. The number of bits to the left of the binary point in the fifth carry output data CO5<17:0> may be the same as the number of bits to the left of the binary point in the fifth carry data C5<16:0>. On the other hand, the number of bits to the right of the binary point of the fifth carry output data CO5<17:0> may be one more than the number of bits to the right of the binary point of the fifth carry data C5<16:0>. In an embodiment, when the fifth sign data SIGN5<0> is “1”, the output circuit 734B receiving the fifth carry data C5<16:0> of “0000.1000 0010 0010 1” may output the fifth carry output data CO5<17:0> of “0000.1000 0010 0010 11”.

The configuration and operation of the fourth full-adder FA14 described with reference to FIGS. 33 through 35 may be equally applied to the sixth full-adder (FA16 in FIG. 21), which is included in the adder tree 720 of the adder circuit 700. Accordingly, the sixth full-adder (FA16 in FIG. 21) may include an adder logic and an output circuit. The adder logic of the sixth full-adder (FA16 in FIG. 21) may receive the fifth summation data (S5 in FIG. 21), the sixth summation data (S6 in FIG. 21), the sixth carry output data (CO6 in FIG. 21), and the seventh sign data (SIGN7 in FIG. 21) as inputs. The adder logic of the sixth full-adder (FA16 in FIG. 21) may perform an addition operation on the fifth summation data (S5 in FIG. 21), the sixth summation data (S6 in FIG. 21), and the sixth carry output data (CO6 in FIG. 21) to generate the seventh summation data (S7 in FIG. 21) and the seventh carry data (SIGN7 in FIG. 21). The output circuit of the sixth full-adder (FA16 in FIG. 21) may add a new LSB having the value of the seventh sign data (SIGN7 in FIG. 21) to the seventh carry data to generate the seventh carry output data (CO7 in FIG. 21).

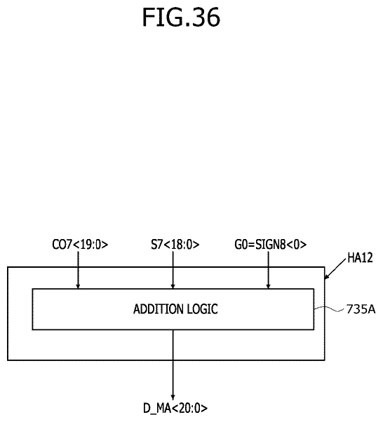

FIG. 36 is a block diagram illustrating one example of a second half-adder of an adder tree included in the adder circuit of FIG. 21.

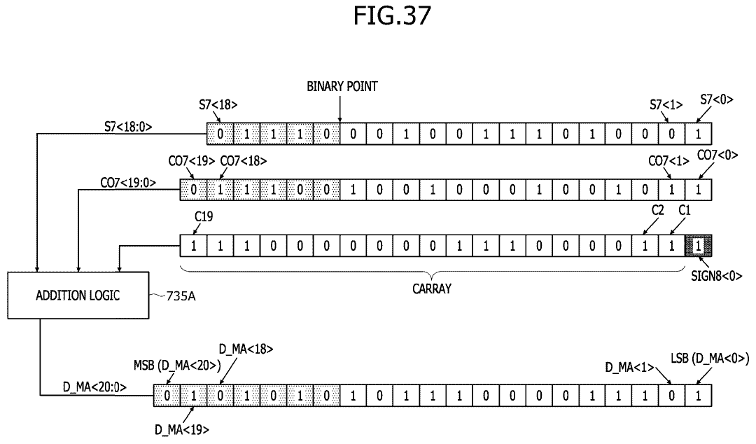

Referring to FIG. 36, the second half-adder HA12 may include an addition logic 735A. The addition logic 735A of the second half-adder HA12 may receive seventh summation data S7<18:0> and seventh carry output data CO7<19:0> that are output from the sixth full-adder (FA16 in FIG. 21). The addition logic 735A of the second half-adder HA12 may also receive eighth sign data SIGN8<0>. The addition logic 735A of the second half-adder HA12 may perform an addition on the seventh summation data S7<18:0>, the seventh carry output data CO7<19:0>, and the eighth sign data SIGN8<0> to output the mantissa addition data D_MA<20:0>. The process of generating the mantissa addition data D_MA<20:0> in the addition logic 735A of the second half-adder HA12 will be described in more detail below with reference to FIG. 37. The mantissa addition data D_MA<20:0> that is output from the addition logic 735A may be output from the second half-adder HA12.

FIG. 37 is a diagram illustrating an addition operation of an adding logic included in the second half-adder of FIG. 36. Hereinafter, it may be assumed that the addition logic 735A of the second half-adder HA12 receives the seventh summation data S7<18:0> of “0 1110.0010 0111 0100 01”, the seventh carry output data CO7<19:0> of “01 1100.1001 0001 0010 11”, and the eighth sign data SIGN8 of “1”.

Referring to FIG. 37, a first bit (i.e., LSB) D_MA<0> of the mantissa addition data D_MA<20:0> may have a value of “1”, which is a summation value resulting from adding “1”, which is a value of a first bit S7<0> of the seventh summation data S7<18:0>, “1”, which is a value of a first bit CO7<0> of the seventh carry output data CO7<10:0>, and “1”, which is a value of the eighth sign data SIGN8<0>. A carry value generated in this process may be used in an addition operation to obtain a value of a second bit D_MA<1> of the mantissa addition data D_MA<20:0>. When “Y” is a natural number from among 2 to 19, a “Y”-th bit D_MA<Y−1> of the mantissa addition data D_MA<20:0> may have a summation value resulting from adding a value of a “Y”-th bit S7<Y−1> of the seventh summation data S7<18:0>, a value of a “Y”-th bit CO7<Y−1> of the seventh carry output data (CO7<16:0>), and a carry value generated in the process of generating a value of a “Y−1”-th bit of the mantissa addition data D_MA<20:0>. A twentieth bit D_MA<19> of the mantissa addition data D_MA<20:0> may have a summation value resulting from adding a value of a twentieth bit CO7<19> of the seventh carry output data CO7<16:0>, and a carry value generated in the process of generating a value of a nineteenth bit D_MA<18> of the mantissa addition data D_MA<20:0>. A twenty-first bit (i.e., MSB) D_MA<20> of the mantissa addition data D_MA<20:0> may have a carry value generated in the process of generating the value of the twentieth bit D_MA<19> of the mantissa addition data D_MA<20:0>.

As illustrated in FIG. 37, the value of the first bit (i.e., LSB) D_MA<0> of the mantissa addition data D_MA<20:0> may have a value of “1”, which is a summation value resulting from adding “1”, which is a value of the first bit S7<0> of the seventh summation data S7<18:0>, “1”, which is a value of the first bit CO2<0> of the seventh carry output data CO7<19:0> (i.e., a new LSB added in the sixth full-adder (FA16 in FIG. 21), and “1”, which is a value of the eighth sign data SIGN8<0>. A first carry value C1 of “1” generated by this addition process may be used as an operand in the addition operation to generate the second bit D_MA<1> of the mantissa addition data D_MA<20:0>. A value of the second bit D_MA<1> of the mantissa addition data D_MA<20:0> may have a value of “0”, which is a summation value resulting from adding “0”, which is a value of a second bit S7<1> of the seventh summation data S7<18:0>, “1”, which is a value of the second bit CO2<1> of the seventh carry output data CO7<19:0>, and “1”, which is the first carry value. A second carry value C2 of “1” generated by this addition process may be used as an operand in the addition operation to generate a third bit of the mantissa addition data D_MA<20:0>. The value of the twentieth bit D_MA<19> of the mantissa addition data D_MA<20:0> may be “1”, which is a summation value resulting from adding “0”, which is a value of the twentieth bit CO7<19> of the seventh carry output data CO7<19:0>, and “1”, which is a nineteenth carry value C19. Here, the nineteenth carry value C19 may be the carry value generated by an addition operation to generate a value of the nineteenth bit D_MA<18> of the mantissa addition data D_MA<20:0>. The value of the 1st bit (i.e., MSB) D_MA<20> of the mantissa addition data D_MA<20:0> may be “0”, which is a carry value generated by an addition operation to generate the twentieth bit D_MA<19> of the mantissa addition data D_MA<20:0>. In this way, the addition logic 735A may output “010 1010.1011 1000 0111 01” as the mantissa addition data D_MA<20:0>.

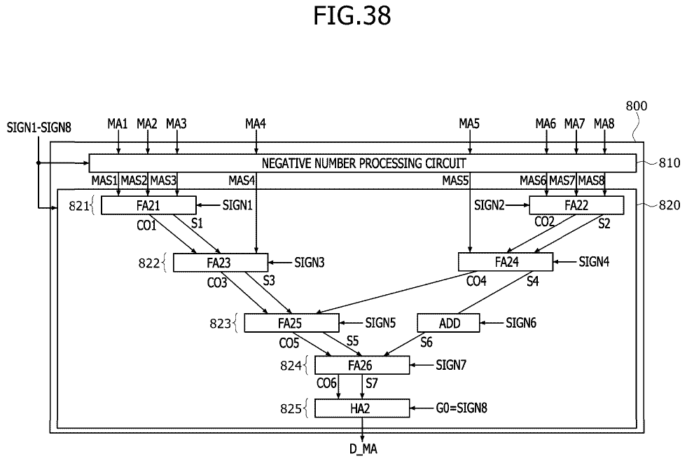

FIG. 38 is a block diagram illustrating an adder circuit according to other example of the present disclosure.

Referring to FIG. 38, the adder circuit 800 may receive a number of floating point data. Hereinafter, the adder circuit 800 will be described as receiving eight mantissa data, i.e., first to eighth mantissa data MA1-MA8, as input data. However, this is merely one example, and the number of mantissa data that are input to the adder circuit 800 can be varied. The first to eighth mantissa data MA1-MA8 may be mantissa data of the first to eighth floating point data, respectively. The first to eighth mantissa data MA1-MA8 may be positive or negative. The floating point data having positive mantissa data, among the first to the eighth mantissa data MA1-MA8, may include sign data of “0”. On the other hand, the floating point data having negative mantissa data, among the first to eighth mantissa data MA1-MA8, may include sign data of “1”. The adder circuit 800 may add all of the first to eighth mantissa data (MA1-MA8) and may output the mantissa addition data D_MA generated as a result of the addition.

In an embodiment, the adder circuit 800 may include a negative number processing circuit 810 and an adder tree 820. The negative number processing circuit 810 of the adder circuit 800 may be configured identically to the negative number processing circuit 710 described with reference to FIGS. 21 and 22. Accordingly, the negative number processing circuit 810 may output the positive mantissa data, among the first to eighth mantissa data MA1-MA8, as selected mantissa data MAS. The negative number processing circuit 810 may output an inverted mantissa data as the selected mantissa data MAS. The inverted mantissa data may be data resulting from performing an inversion processing on the negative mantissa data.

The adder tree 820 of the adder circuit 800 may include six full-adders, for example, first to sixth full-adders FA21-FA26, one adder ADD, and one half-adder HA2. Specifically, at a first stage 821 of the adder tree 820, a first full-adder FA21 and a second full-adder FA22 may be disposed. At a second stage 822 of the adder tree 820, a third full-adder FA23 and a fourth full-adder FA24 may be disposed. At a third stage 823 of the adder tree 820, a fifth full-adder FA25 and an adder ADD may be disposed. At a fourth stage 824 of the adder tree 820, a sixth full-adder FA26 may be disposed. And at a fifth stage 825, which is the last stage of the adder tree 820, a half-adder HA2 may be disposed.

Like first to sixth full-adders FA11-FA16 described with reference to FIGS. 21 to 37, each of the first to sixth full-adders FA21-FA26 that are included in the adder tree 820 may include an adding logic and an output circuit. The adder ADD included in the adder tree 820 may have two input terminals and one output terminal. And the half-adder HA2 included in the adder tree 820 may include an adder logic. Specifically, the first full-adder FA21 and the second full-adder FA22 disposed at the first stage 821 of the adder tree 820 may be configured identically to the first full-adder (FA11 of FIG. 23) described with reference to FIGS. 23 to 25. Accordingly, the first full-adder FA21 may receive the first to third selected mantissa data MAS1-MAS3 and first sign data SIGN1 as input data and may output first summation data S1 and first carry output data CO1. The first carry output data CO1 may be generated by adding a new LSB having a value of the first sign data SIGN1 to first carry data. The first carry data may be generated by the addition process of the first to third selected mantissa data MAS1-MAS3. Similarly, the second full-adder FA22 may receive the sixth to eighth selected mantissa data MAS6-MAS8 and second sign data SIGN2 as input data and may output second summation data S2 and second carry output data CO2. The second carry output data CO2 may be generated by adding an LSB having a value of the second sign data SIGN2 to second carry data. The second carry data may be generated by an addition process of the sixth to eighth selected mantissa data MAS6-MAS8.

The third full-adder FA23 and fourth full-adder FA24 disposed at the second stage 822 of the adder tree 820 and the sixth full-adder FA26 disposed at the fourth stage 824 may be configured identically to the fourth full-adder (FA14 of FIG. 33) described with reference to FIGS. 33 through 35. Accordingly, the third full-adder FA23 may receive the fourth selected mantissa data MAS4, the first summation data S1, the first carry output data CO1, and third sign data SIGN3 as input data and may output third summation data S3 and third carry output data CO3. The third carry output data CO3 may be generated by adding an LSB having a value of the third sign data SIGN3 to third carry data. The third carry data may be generated by an addition process of the fourth selected mantissa data MAS4, the first summation data S1, and the first carry output data CO1. Similarly, the fourth full-adder FA24 may receive the fifth selected mantissa data MAS5, the second summation data S2, the second carry output data CO2, and fourth sign data SIGN4 as input data and may output fourth summation data S4 and fourth carry output data CO4. The fourth carry output data CO4 may be generated by adding an LSB having a value of the fourth sign data SIGN4 to fourth carry data. The fourth carry data may be generated by an addition process of the fifth selected mantissa data MAS5, the second summation data S2, and the second carry output data CO2. Similarly, the sixth full-adder FA26 may receive the fifth summation data S5, the sixth summation data S6, the fifth carry output data CO5, and seventh sign data SIGN7 as input data and may output seventh summation data S7 and sixth carry output data CO6. The sixth carry output data CO6 may be generated by adding an LSB having a value of the seventh sign data SIGN7 to sixth carry data. The sixth carry data may be generated by an addition process of the fifth summation data S5, the sixth summation data S6, and the fifth carry output data CO5.

The fifth full-adder FA25 disposed at the third stage 823 of the adder tree 820 may be configured identically to the third full-adder (FA13 in FIG. 30) described with reference to FIGS. 30 to 32. Accordingly, the fifth full-adder FA25 may receive the third summation data S3, the third carry output data CO3, the fourth carry output data CO4, and fifth sign data SIGN5 as input data and may output fifth summation data S5 and fifth carry output data CO5. The fifth carry output data CO5 may be generated by adding an LSB having a value of the fifth sign data SIGN5 to fifth carry data. The fifth carry data may be generated by an addition of the third summation data S3, the third carry output data CO3, and the fourth carry output data CO4. The adder ADD disposed at the third stage 823 of the adder tree 820 may receive the fourth summation data S4 and sixth sign data SIGN6 as input data. The adder ADD may perform an addition operation on the fourth summation data S4 and the sixth sign data SIGN6 and may output sixth summation data S6.

The half-adder HA2 disposed at the fifth stage 825 of the adder tree 820 may be configured identically to the second half-adder (HA12 in FIG. 36) described with reference to FIGS. 36 and 37. Accordingly, the half-adder HA2 may be configured as a prefix adder, such as a Kogge-Stone adder. In this case, eighth sign data SIGN8 may be input to the half-adder HA2 as a first carry generation logic value GO of the prefix adder. More specifically, the half-adder HA2 may receive the seventh summation data S7 and the sixth carry output data CO6 that are output from the sixth full-adder FA26. The half-adder HA2 also may receive eighth sign data SIGN8 as the first carry generation logic value GO. The half-adder HA2 may perform an addition on the seventh summation data S7, the sixth carry output data CO6, and the eighth sign data SIGN8 to output the mantissa addition data D_MA. The mantissa addition data D_MA output from the half-adder (HA2) may be output from the adder tree 820.

When mantissa data is negative, inverted mantissa data may be input to the adder tree 820. Accordingly, the “+1” operation in the negative number processing circuit 810 may be omitted based on the number of negative mantissa data. When mantissa data is positive, sign data of the mantissa data may have a value of “0”. When mantissa data is negative, sign data of the mantissa data may have a value of “1”. In other words, for positive mantissa data, adding a new LSB having a value “0” of the sign data might not affect the result of an addition operation. On the other hand, for negative mantissa data, up to six “+1” operations may be performed by adding LSBs having a value “1” of the sign data to the carry data in the first to sixth full-adders FA21-FA26 of the adder tree 820. And in the adder ADD of the adder tree 820, up to one “+1” operation may be performed by adding a value of the sixth sign data SIGN6 to the fourth summed data S4. Also, in the half-adder HA2, up to one “+1” operation may be performed by adding a value of the eighth sign data SIGN8 to the seventh summed data S7 and the sixth carry output data CO6.

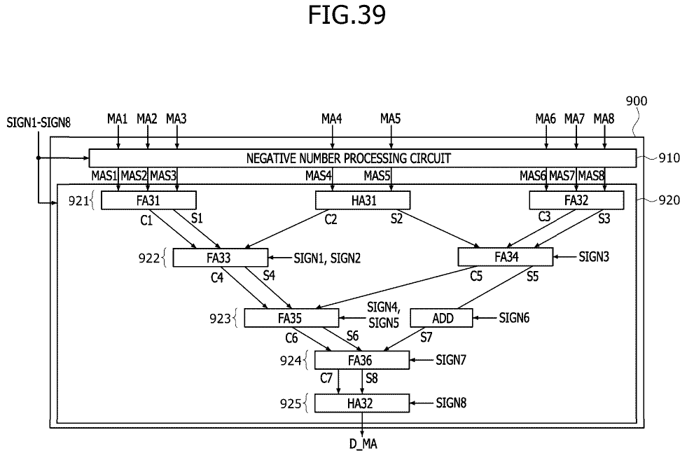

FIG. 39 is a block diagram illustrating an adder circuit according to another example of the present disclosure.

Referring to FIG. 39, the adder circuit 900 may receive as input data a number of floating point data. Hereinafter, the adder circuit 900 will be described as receiving eight mantissa data, i.e., the first to eighth mantissa data MA1-MA8, as input data. However, this is merely one example, and the number of mantissa data that are input to the adder circuit 900 can be varied. The first to eighth mantissa data MA1-MA8 may be mantissa data of the first to eighth floating point data, respectively. The first to the eighth mantissa data MA1-MA8 may be positive or negative. The floating point data having positive mantissa data, among the first to the eighth mantissa data MA1-MA8, may include sign data of “0”. On the other hand, the floating point data having negative mantissa data, among the first to eighth mantissa data MA1-MA8, may include a sign data of “1”. The adder circuit 900 may add all of the first to eighth mantissa data MA1-MA8 and may output mantissa addition data D_MA generated as a result of the addition.

In an embodiment, the adder circuit 900 may include a negative number processing circuit 910 and an adder tree 920. The negative number processing circuit 910 of the adder circuit 900 may be configured identically to the negative number processing circuit 710 described with reference to FIGS. 21 and 22. Accordingly, the negative number processing circuit 910 may output the positive mantissa data, among the first to eighth mantissa data MA1-MA8, as selected mantissa data MAS. The negative number processing circuit 910 may output an inverted mantissa data as the selected mantissa data MAS. The inverted mantissa data may be data resulting from performing an inversion processing on the negative mantissa data.

The adder tree 920 may perform an addition operation on the first to eighth selected mantissa data MAS1-MAS8 that are output from the negative number processing circuit 910. The adder tree 920 may output mantissa add data D_MA. The adder tree 920 may include first to fifth stages 921-925. As illustrated in FIG. 38, in the first stage 921 of the adder tree 920, a first full adder FA31, a first half-adder HA31, and a second full adder FA32 may be disposed. At the second stage 922 of the adder tree 920, a third full adder FA33 and a fourth full adder FA34 may be disposed. At the third stage 923 of the adder tree 920, a fifth full-adder FA35 and an adder ADD may be disposed. At the fourth stage 924 of the adder tree 920, a sixth full-adder FA36 may be disposed. And at the fifth stage 925 of the adder tree 920, a second half-adder HA32 may be disposed. The first full adder FA31, the second full adder FA32, and the first half-adder FA31 of the first stage 921 may be operated in parallel. The third full-adder FA33 and fourth full-adder FA34 of the second stage 922 may also be operated in parallel.

The third through sixth full adders FA33-FA36, the adder ADD, and the second half-adder HA32 of the adder tree 920 may receive at least one sign data SIGN. In an embodiment, the adders included in the adder tree 920 may each receive a number of sign data equal to the number of carry data being input, and the adder ADD included in the adder tree 920 may receive one sign data. More specifically, the third full-adder FA33, which receives first carry data C1 and second carry data C2, may receive first sign data SIGN1 and second sign data SIGN2. The fourth full-adder FA34, which receives third carry data C3, may receive third sign data SIGN3. The fifth full-adder FA35, which receives fourth carry data C4 and fifth carry data C5, may receive fourth sign data SIGN4 and fifth sign data SIGN5. The adder ADD may receive sixth sign data SIGN6. The sixth full-adder FA36, which receives sixth carry data C6, may receive seventh sign data SIGN7. And the second half-adder HA32, which receives seventh carry data C7, may receive eighth sign data SIGN8.

The first full-adder FA31 and the second full-adder FA32 of the first stage 921 may be configured identically to the addition logic (731A in FIG. 23) of the first full-adder (FA11 in FIG. 23) described with reference to FIG. 23, i.e., the first full-adder FA31 and the second full-adder FA32, may have the same structure as the structure of the first full-adder (FA11 in FIG. 23) with the output circuit (731B in FIG. 23) removed. Accordingly, the first full-adder FA31 may receive the first to third selected mantissa data MAS1-MAS3 that are output from the negative number processing circuit 910. The first full-adder FA31 may perform an addition operation on the first to third selected mantissa data MAS1-MAS3 and may output first summation data S1 and the first carry data C1. Similarly, the second full-adder FA32 may receive the sixth to eighth selected mantissa data MAS6-MAS8 that are output from the negative number processing circuit 910. The second full-adder FA32 may perform an addition operation on the sixth to eighth selected mantissa data MAS6-MAS8 and may output third summation data S3 and the third carry data C3. The first half-adder HA31 of the first stage 921 may be configured identically to the addition logic (732A in FIG. 27) of the first half-adder (HA11 in FIG. 27) described with reference to FIG. 27. Accordingly, the first half-adder HA31 may receive the fourth selected mantissa data MAS4 and the fifth selected mantissa data MAS5 that are output from the negative number processing circuit 910. The first half-adder HA31 may perform an addition operation on the fourth selected mantissa data MAS4 and the fifth selected mantissa data MAS5 and may output second summation data S2 and the second carry data C2.

The third full-adder FA33 of the second stage 922 may receive the first summation data S1 and the first carry data C1 that are output from the first full-adder FA31 of the first stage 921, and the second carry data C2 that is output from the first half-adder HA31 of the first stage 921. The third full-adder FA33 also may receive the first sign data SIGN1 and the second sign data SIGN2. The third full-adder FA33 may perform a first LSB addition operation to add a value of the first sign data SIGN1 as a new LSB to the first carry data C1 to generate first carry input data. The third full-adder FA33 may generate second carry input data by performing a second LSB addition operation to add a value of the second sign data SIGN2 as a new LSB to the second carry data C2. The third full-adder FA33 may perform an addition operation on the first summation data S1, the first carry input data, and the second carry input data to output fourth summation data S4 and the fourth carry data C4.

The fourth full-adder FA34 of the second stage 922 may receive the second summation data S2 that is output from the first half-adder HA31 of the first stage 921, the third summation data S3 and the third carry data C3 that are output from the second full-adder FA32 of the first stage 921, and the third sign data SIGN3. The fourth full-adder FA34 may perform an LSB addition operation to add a value of the third sign data SIGN3 as a new LSB to the third carry data C3 to generate third carry input data. The fourth full-adder FA34 may perform an addition operation on the second summation data S2, the third summation data S3, and the third carry input data to output fifth summation data S5 and the fifth carry data C5.

The fifth full-adder FA35 of the third stage 923 may receive the fourth summation data S4 and the fourth carry data C4 that are output from the third full-adder FA33 of the second stage 922, and the fifth carry data C5 that is output from the fourth full-adder FA34 of the second stage 922. The fifth full-adder FA35 also may receive the fourth sign data SIGN4 and the fifth sign data SIGN5. The fifth full-adder FA35 may perform a first LSB addition operation to add a value of the fourth sign data SIGN4 as a new LSB to the fourth carry data C4 to generate fourth carry input data. The fifth full-adder FA35 may generate fifth carry input data by performing a second LSB addition operation to add a value of the fifth sign data SIGN5 as a new LSB to the fifth carry data C5. The fifth full-adder FA35 may perform an addition operation on the fourth summation data S4, the fourth carry input data, and the fifth carry input data to output sixth summation data S6 and the sixth carry output data CO6. The adder ADD of the third stage 923 may receive the fifth summation data S5 that is output from the fourth full-adder FA34 and the sixth sign data SIGN6. The adder ADD may perform an addition operation on the fifth summation data S5 and the sixth sign data SIGN6 and may output the resulting data as seventh summation data S7.

The sixth full-adder FA36 of the fourth stage 924 may receive the sixth summation data S6 and the sixth carry data C6 that are output from the fifth full-adder FA35 of the third stage 923, the seventh summation data S7 that is output from the adder ADD of the third stage 923, and the seventh sign data SIGN7. The sixth full-adder FA36 may perform an LSB addition operation to add a value of the seventh sign data SIGN7 as a new LSB to the sixth carry data C6 to generate sixth carry input data. The sixth full-adder FA36 may perform an addition operation on the sixth summation data S6, the seventh summation data S7, and the sixth carry input data to output eighth summation data S8 and the seventh carry data C7.

The second half-adder HA32 of the fifth stage 925 may receive the eight summation data S8 and the seventh carry data C7 that are output from the sixth full adder FA36 of the fourth stage 924, and the eight sign data SIGN8. The second half-adder HA32 may perform an LSB addition operation to add a value of the 8th sign data SIGN8 as a new LSB to the seventh carry data C7 to generate seventh carry input data. The second half-adder HA32 may perform an addition operation on the eighth summation data S8 and the seventh carry input data to output the mantissa addition data D_MA.

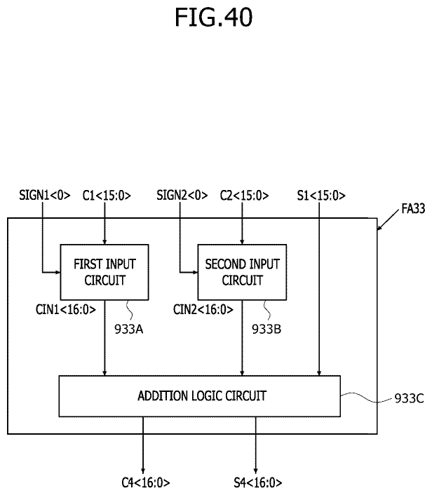

FIG. 40 is a block diagram illustrating one example of a third full-adder included in an adder tree of the adder circuit of FIG. 39. The following description of the third full-adder FA33 may be applied to a fifth full-adder FA35, which receives fourth summation data S4, fourth carry data C4, fifth carry data C5, fourth sign data SIGN4, and fifth sign data SIGN5.

Referring to FIG. 40, the third full-adder FA33 may include a first input circuit 933A, a second input circuit 933B, and an addition logic circuit 933C. The first input circuit 933A of the third full-adder FA33 may receive first carry data C1<15:0> and first sign data SIGN1<0>. The first input circuit 933A may generate first carry input data CIN1<16:0> by adding a new LSB having a value of the first sign data SIGN1<0> to the first carry data C1<15:0>. The first input circuit 933A may transmit the first carry input data CIN1<16:0> to the addition logic circuit 933C. The second input circuit 933B of the third full-adder FA33 may receive second carry data C2<15:0> and second sign data SIGN2<0>. The second input circuit 933B may generate second carry input data CIN2<16:0> by adding a new LSB having a value of the second sign data SIGN2<0> to the second carry data C2<15:0>. The second input circuit 933B may transmit the second carry input data CIN2<16:0> to the addition logic circuit 933C. The addition logic circuit 933C of the third full-adder FA33 may receive first summation data S1<15:0>, the first carry input data CIN1<16:0>, and the second carry input data CIN2<16:0>. The addition logic circuit 933C may perform an addition on the first summation data S1<15:0>, the first carry input data CIN1<16:0>, and the second carry input data CIN2<16:0> to output fourth summation data S4<16:0> and fourth carry data C4<16:0>.

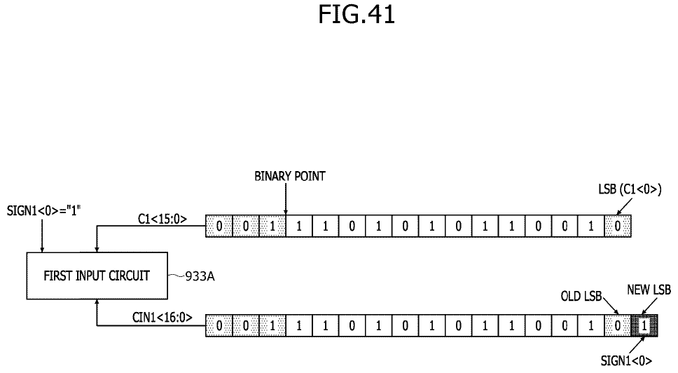

FIG. 41 is a diagram illustrating a LSB addition process of a first input circuit included in the third full-adder of FIG. 40. The following description of the first input circuit 933A may be applied to a second input circuit 933B included in the third full-adder FA33. In the present example, it may be assumed that the third full-adder FA33 is input with first carry data C1<15:0> of “001.1101 0101 1001 0” and first sign data SIGN1<0> of “1”.

Referring to FIG. 41, the first input circuit 933A of the third full-adder FA33 may be configured to generate first carry input data CIN1<16:0> by adding a new LSB having a value of the first sign data SIGN1<0> to a lower bit position (labeled “NEW LSB” in FIG. 41) of a LSB position (labeled “OLD LSB” in FIG. 41) of the first carry data CIN1<16:0> based on a binary point. As a result, the first carry input data CIN1<16:0> may have a size of 17 bits, which is 1 bit greater than the first carry data C1<15:0> of 16 bits. The number of bits to the left of the binary point in the first carry input data CIN1<16:0> may be the same as the number of bits to the left of the binary point in the first carry data C1<15:0>. On the other hand, the number of bits to the right of the binary point of the first carry input data CIN1<16:0> may be one more than the number of bits to the right of the binary point of the first carry data C1<15:0>. As illustrated in FIG. 41, when the first sign data SIGN1<0> is “1”, the first input circuit 933A, which has received the first carry data C1<15:0> of “001.1101 0101 1001 0”, may output the first carry input data CIN1<16:0> of “001.1101 0101 1001 01”.

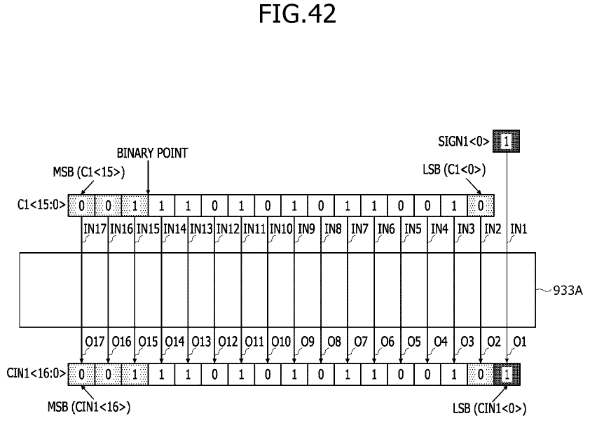

FIG. 42 is a diagram illustrating one example of a first input circuit configuration included in the third full-adder of FIG. 40.

Referring to FIG. 42, a first input circuit 933A of the third full-adder FA33 may be implemented with a plurality of input and output interconnection lines, without including any additional logic circuits. Specifically, the first input circuit 933A of the third full-adder FA33 may have first to seventeenth input lines IN1-IN17 and first to seventeenth output lines O1-O17. The first to seventeenth input lines IN1-IN17 may be each directly coupled with the first to seventeenth output lines O1-O17 in the first input circuit 933A. Data input to the first input circuit 933A through the first input line IN1 may be output from the first input circuit 933A through the first output line O1. Data input to the first input circuit 933A through the second input line IN2 may be output from the first input circuit 933A through the second output line O2. Data input to the first input circuit 933A through the third input line IN3 may be output from the first input circuit 933A through the third output line O3. Similarly, data input to the first input circuit 933A through the seventeenth input line IN17 may be output from the first input circuit 933A through the seventeenth output line O17.

The first input circuit 933A may be configured such that first sign data SIGN1<0> may be input through the first input line IN1, and each bit of 16 bits of first carry data C1<15:0> may be input through the second to seventeenth input lines IN2-IN17. Accordingly, the LSB C1<0> of the first carry data C1<15:0> may be input to the first input circuit 933A through the second input line IN2. The second to fifteenth bits of the first carry data C1<15:0> may be input to the first input circuit 933A through the third to sixteenth input lines IN3-IN16, respectively. And the MSB C1<15> of the first carry data C1<15:0> may be input to the first input circuit 933A through the seventeenth input line IN17.

The first sign data SIGN<0> input through the first input line IN1 may be output from the first input circuit 933A as the LSB CIN1<0> of the first carry input data CIN1<16:0> through the first output line O1. The LSB C1<0> of the first carry data C1<15:0> input through the second input line IN2 may be output from the first input circuit 933A as a second bit of the first carry input data CIN1<16:0> through the second output line O2. The MSB C1<15> of the first carry data C1<15:0> input through the seventeenth input line IN17 may be output from the first input circuit 933A as a MSB CIN1<16> of the first carry input data CIN1<16:0> through the seventeenth output line O17. In the same manner, the second through fifteenth bits of the first carry data C1<15:0> input through the third through sixteenth input lines IN3-IN16 may be output from the first input circuit 933A as the third to sixteenth bits of the first carry output data CO1<16:0> through the third through sixteenth output lines O3-016.

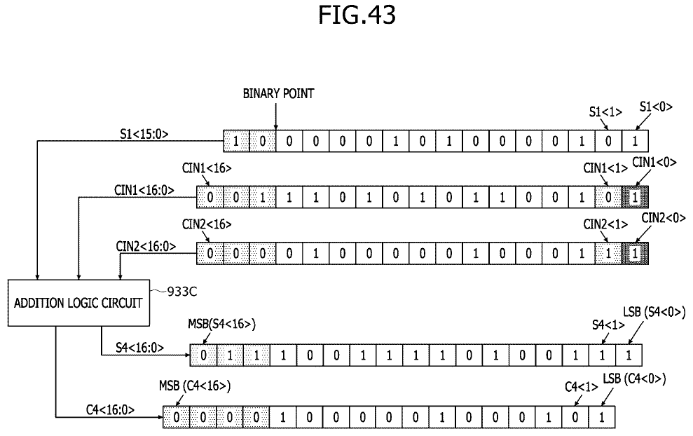

FIG. 43 is a diagram illustrating an addition operation of an addition logic circuit included in a third full-adder of FIG. 40. In this example, it may be assumed that the third full-adder FA33 is configured to add first summation data S1<15:0> of “10.0000 1010 0001 01”, first carry input data CIN1<16:0> of “001.1101 0101 1001 01”, second carry input data CIN2<16:0> of “000.0100 0001 0001 11”, and fourth sign data SIGN4<0> of “1”.

Referring to FIG. 43, the addition logic circuit 933A of the third full-adder FA33 may receive the first summation data S1<15:0>, the first carry input data CIN1<16:0>, the second carry input data CIN2<16:0>, and the fourth sign data SIGN4<0> and may output fourth summation data S4<16:0> and fourth carry data C4<16:0>. When “X” is a natural number from among 1 to 16, a “X”-th bit S4<X−1> of the fourth summation data S4<16:0> may have a summation value resulting from adding a value of a “X”-th bit S1<X−1> of the first summation data S1<15:0>, a value of a “X”-th bit CIN1<X−1> of the first carry input data CIN1<16:0>, and a value of a “X”-th bit CIN2<X−1> of the second carry input data CIN2<16:0>. The seventeenth bit S4<16>, which is a MSB of the fourth summation data S4<16:0> that is output from the addition logic circuit 933C, may have a summation value resulting from adding a value of a seventeenth bit CIN1<16> of the first carry input data CIN1<16:0> and a value of a seventeenth bit CIN2<16> of the second carry input data CIN2<16:0>. The carry values generated by this addition process might not be reflected in the fourth summation data S4<16:0>.

As exemplified in FIG. 43, a value of a first bit S4<0>, which is a LSB of the fourth summation data S4<0>, is “1”, which is a summation value resulting from adding “1”, which is a first bit S1<0> of the first summation data S1<15:0>, “1”, which is a value of a first bit CIN1<0> of the first carry input data CIN1<16:0>” (i.e., a new LSB added in the first input circuit 933A), and “1”, which is a value of a first bit CIN2<0> of the second carry input data CIN2<16:0> (i.e., a new LSB added in the second input circuit 933B). A carry value of “1” may be generated by this addition but is not reflected in the fourth summation data S4<16:0>. A value of a second bit S4<1> of the fourth summation data S4<16:0> may be “1”, which is a summation value resulting from adding “0”, which is a value of a second bit S1<1> of the first summation data S1<15:0>, “0”, which is a value of a second bit CIN1<1> of the first carry input data CIN1<16:0>, and “1”, which is a second bit CIN2<1> of the second carry input data CIN2<16:0>. A value of the seventeenth bit S4<16>, which is the MSB of the fourth summation data S4<16:0>, may be “0”, which is a summation value resulting from adding “0”, which is a value of the seventeenth bit CIN1<16> of the first carry input data CIN1<16:0>, and “0”, which is a value of the seventeenth bit CIN2<16> of the second carry input data CIN2<16:0>. In this way, the addition logic circuit 933C may output “011.1001 1110 1001 11” as the fourth summation data S4<16:0>.

A “X”-th bit C4<X−1> of the fourth carry data C4<16:0> that is output from the addition logic circuit 933C of the third full-adder FA33 may be a carry value generated as a result of adding a value of a “X”-th bit S4<X−1> of the first summation data S1<15:0>, a value of a “X”-th bit CIN1<X−1> of the first carry input data CIN1<16:0>, and a value of a “X”-th bit CIN2<X−1> of the second carry input data CIN2<16:0>. A MSB of the fourth carry data C4<16:0>, i.e., a seventeenth bit C4<16>, may have a carry value generated as a result of adding a value of a seventeenth bit CIN1<16> of the first carry input data CIN1<16:0> and a value of a seventeenth bit CIN2<16> of the second carry input data CIN2<16:0>.

As exemplified in FIG. 43, a value of a LSB C4<0> of the fourth carry data C4<16:0> may be “1”, which is a carry value generated as a result of adding “1”, which is a value of the first bit S1<0> of the first summation data S1<15:0>, “1”, which is a value of a first bit CIN1<0> of the first carry input data CIN1<16:0>, and “1”, which is a value of a first bit CIN2<0> of the second carry input data CIN2<16:0>. A value of the second bit C4<1> of the fourth carry data C4<16:0> may be “0”, which is a carry value generated as a result of adding “0”, which is a value of a second bit S1<1> of the first summation data S1<15:0>, “0”, which is a value of a second bit CIN1<1> of the first carry input data CIN1<16:0>, and “1”, which is a value of a second bit CIN2<1> of the second carry input data CIN2<16:0>. A value of the seventeenth bit, i.e., MSB C4<16> of the fourth carry data C4<16:0> may be a carry value generated as a result of adding “0”, which is a value of the MSB CIN1<16> of the first carry input data CIN1<16>, and “0”, which is a value of the MSB CIN2<16> of the second carry input data CIN2<16:0>. In this way, the addition logic circuit 933C may output the fourth carry data C4<16:0> of “0000.1000 0010 0010 1”.

The fourth summation data S4<16.0> may be the same as the first carry input data CIN1<16.0> and the second carry input data CIN2<16.0>, with 3 bits to the left of the binary point and 14 bits to the right of the binary point. On the other hand, the fourth carry data C4<16:0>, which consists of the carry values generated by the addition operation, may have the format of 4 bits to the left of the binary point and 13 bits to the right of the binary point. In other words, in the case of the fourth carry data C4<16:0>, the number of bits to the left of the binary point may be increased by one compared to the fourth sum data S4<16:0>, while the number of bits to the right of the binary point is decreased by one. As a result, the position of the LSB C4<0> of the fourth carry data C4<16:0> may be the same as the position of the second bit S4<1> of the fourth summation data S4<16:0> with respect to the binary point.

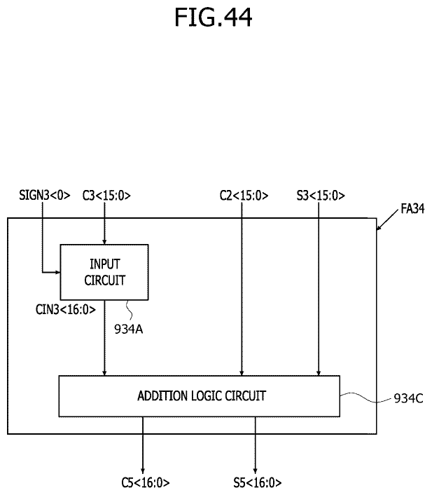

FIG. 44 is a block diagram illustrating one example of a fourth full-adder included in an adder tree of the adder circuit of FIG. 39. The following description of the fourth full-adder FA34 may be applied to a sixth full-adder FA36, which receives sixth sum data S6, seventh sum data S7, sixth carry data C6, and seventh sign data SIGN7.

Referring to FIG. 44, the fourth full-adder FA34 may include an input circuit 934A and an addition logic circuit 934C. The input circuit 934A of the fourth full-adder FA34 may be configured to a first input circuit 933A of a third full-adder FA33 described with reference to FIGS. 39 to 41. Accordingly, the input circuit 934A of the fourth full-adder FA34 may receive third carry data C3<15:0> and third sign data SIGN3<0>. The input circuit 934A may generate third carry input data CIN3<16:0> by adding a new LSB having a value of the third sign data SIGN3<0> to the third carry data C3<15:0>. The input circuitry 934A may transmit the third carry input data CIN3<16:0> to the addition logic circuit 934C. The addition logic circuit 934C of the fourth full-adder FA34 may receive second summation data S2<15:0> from a first half-adder (HA31 in FIG. 39), third summation data S3<15:0> from a second full-adder (FA32 in FIG. 39), and third carry input data CIN3<16:0> from the input circuit 934A. The addition logic circuit 934C may perform an addition operation on the second summation data S2<15:0>, the third summation data S3<15:0>, and the third carry input data CIN3<16:0> to output fifth summation data S5<16:0> and fifth carry data C5<16:0>. The addition operation in the addition logic 934C of the fourth full-adder FA34 may be performed in the same principle as the addition operation in the addition logic (933C in FIG. 43) of the third full-adder (FA33 in FIG. 39) described with reference to FIG. 43.

When mantissa data is negative, inverted mantissa data may be input to the adder tree 920. Accordingly, the “+1” operation in the negative number processing circuit 910 may be omitted based on the number of negative mantissa data. When mantissa data is positive, sign data of the mantissa data may have a value of “0”. When mantissa data is negative, sign data of the mantissa data may have a value of “1”. In other words, for positive mantissa data, adding a new LSB having a value of “0” of the sign data might not affect the result of an addition operation. On the other hand, for negative mantissa data, up to six “+1” operations may be performed by adding LSBs having a value “1” of the sign data to the carry data in the third to sixth full-adders FA33-FA36 of the adder tree 920. Then, in the adder ADD of the adder tree 920, a value of the sixth sign data SIGN6 may be added to the fifth summed data S5, so that up to one “+1” operation may be performed. Also, in the half-adder HA2, up to one “+1” operation may be performed by adding a value of the eighth sign data SIGN8 to the eighth summation data S8 and the seventh carry data C7.

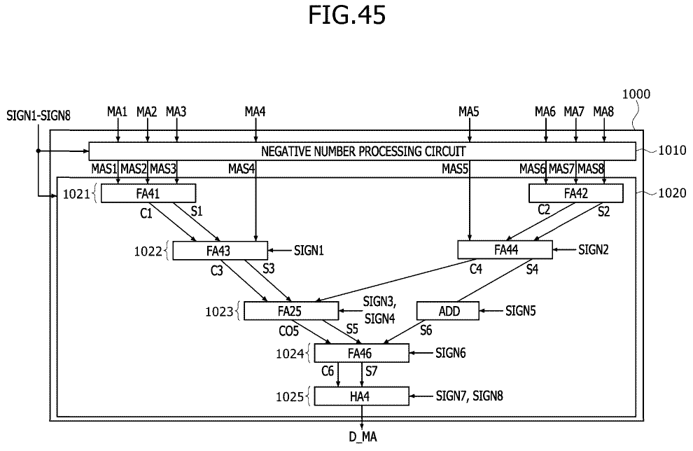

FIG. 45 is a block diagram illustrating an adder circuit according to another example of the present disclosure.

Referring to FIG. 45, the adder circuit 1000 may receive a number of floating point data. Hereinafter, the adder circuit 1000 will be described as receiving eight mantissa data, that is, the first to eighth mantissa data MA1-MA8, as input data. However, this is merely one example, and the number of mantissa data that may be input to the adder circuit 1000 can be varied. The first to eighth mantissa data MA1-MA8 may be mantissa data of the first to eighth floating point data, respectively. The first to eighth mantissa data MA1-MA8 may be positive or negative. The floating point data having positive mantissa data, among the first to eighth mantissa data MA1-MA8, may include sign data of “0”. On the other hand, the floating point data having negative mantissa data, among the first to eighth mantissa data MA1-MA8, may include sign data of “1”. The adder circuit 1000 may add all of the first to eighth mantissa data MA1-MA8 and may output mantissa addition data D_MA generated as a result of the addition.

In one embodiment, the adder circuit 1000 may include a negative number processing circuit 1010 and an adder tree 1020. The negative number processing circuit 1010 of the adder circuit 1000 may be configured identically to the negative number processing circuit 710 described with reference to FIGS. 21 and 22. Accordingly, the negative number processing circuit 1010 may output the positive mantissa data, among the first to eighth mantissa data MA1-MA8, as selected mantissa data MAS. The negative number processing circuit 1010 may output an inverted mantissa data as the selected mantissa data MAS. The inverted mantissa data may be data resulting from performing an inversion processing on the negative mantissa data.

The adder tree 1020 may perform an addition operation on the first to eighth selected mantissa data MAS1-MAS8 output from the negative number processing circuit 1010 to output mantissa add data D_MA. The adder tree 1020 may include first to fifth stages 1021-1025. As illustrated in FIG. 45, in the first stage 1021 of the adder tree 1020, a first full-adder FA41 and a second full-adder FA42 may be disposed. At the second stage 1022 of the adder tree 1020, a third full-adder FA43 and a fourth full-adder FA44 may be disposed. At the third stage 1023 of the adder tree 1020, a fifth full-adder FA45 and an adder ADD may be disposed. At the fourth stage 1024 of the adder tree 1020, a sixth full-adder FA46 may be disposed. And at the fifth stage 1025 of the adder tree 1020, a half-adder HA4 may be disposed. The first full-adder FA41 and the second full-adder FA42 of the first stage 1021 may operate in parallel. The third full-adder FA43 and fourth full-adder FA44 of the second stage 1022 may also operate in parallel. The fifth full-adder FA45 and adder ADD of the third stage 1023 may also operate in parallel.

The third to sixth full-adders FA43-FA46, the adder ADD, and the half-adder HA4 of the adder tree 1020 may receive at least one sign data SIGN. In an embodiment, the third to sixth full-adders FA43-FA46 and the half-adder HA4 receive a number of sign data equal to the number of carry data being input, and the adder ADD may receive one sign data. More specifically, the third full-adder FA43, which receives first carry data C1, may receive first sign data SIGN1. The fourth full-adder FA44, which receives second carry data C2, may receive second sign data SIGN2. The fifth full-adder FA45, which receives third carry data C3 and fourth carry data C4, may receive third sign data SIGN3 and fourth sign data SIGN4. The adder ADD may receive fifth sign data SIGN5. The sixth full adder FA46, which receives fifth carry data C5, may receive sixth sign data SIGN6. And the half-adder HA4, which receives sixth carry data C6, may receive seventh sign data SIGN7. The half-adder HA4 additionally may receive eighth sign data SIGN8.

The first full-adder FA41 and the second full-adder FA42 of the first stage 1021 may be configured identically to the addition logic 731A of the first full-adder (FA11 of FIG. 23) described with reference to FIG. 23, i.e., the first full-adder FA41 and the second full-adder FA42 may have the same structure as the structure of the first full-adder (FA11 of FIG. 23) with the output circuit (731B of FIG. 23) removed. Accordingly, the first full-adder FA41 may receive as input the first to third selected mantissa data MAS1-MAS3 output from the negative number processing circuit 1010. The first full-adder FA41 may perform an addition operation on the first to third selected mantissa data MAS1-MAS3 to output the first summation data S1 and the first carry data C1. Similarly, the second full-adder FA42 may receive the sixth to eighth selected summation data MAS6-MAS8 output from the negative number processing circuit 1010 as input. The second full-adder FA42 may perform an addition operation on the sixth to eighth selected mantissa data MAS6-MAS8 to output the second summation data S2 and the second carry data C2.

The third full-adder FA43, fourth full-adder FA44, and sixth full-adder FA46 of the second stage 1022 may be configured in the same manner as the third full-adder (FA34 of FIG. 44) described with reference to FIG. 44. Accordingly, the third full-adder FA43 of the second stage 1022 may receive the first summation data S1 and the first carry data C1 from the first full-adder FA41 of the first stage 1021 and may receive the fourth selected mantissa data MAS4 from the negative number processing circuit 1010. The third full-adder FA43 may generate the first carry input data by adding a value of the first sign data SIGN1 to the first carry data C1 as a new LSB. The third full-adder FA43 may perform an addition operation on the first carry input data, the first summation data S1, and the fourth selected mantissa data MAS4 to output the third summation data S3 and the third carry data C3. The fourth full-adder FA44 of the second stage 1022 may receive the second summation data S2 and the second carry data C2 from the second full-adder FA42 of the first stage 1021 and may receive the fifth selected mantissa data MAS5 from the negative number processing circuit 1010. The fourth full-adder FA44 may generate the second carry input data by adding a value of the second sign data SIGN2 to the second carry data C2 as a new LSB. The fourth full-adder FA44 may perform an addition operation on the second carry input data, the second summation data S2, and the fifth selected mantissa data MAS5 to output the fourth summation data S4 and the fourth carry data C4. The sixth full-adder FA46 of the fourth stage 1024 may receive the fifth summation data S5 and the fifth carry data C5 from the fifth full-adder FA45 of the third stage 1023 and may receive the sixth summation data S6 from the adder ADD of the third stage 1023. The sixth full-adder FA46 may generate the fifth carry input data by adding a new LSB of a value of the sixth sign data SIGN6 to the fifth carry data C5. The sixth full-adder FA46 may perform an addition operation on the fifth carry input data, the fifth summation data S5, and the sixth summation data S6 to output the seventh summation data S7 and the sixth carry data C6.

The fifth full-adder FA45 of the third stage 1023 may be configured identically to the third full-adder (FA33 of FIG. 40) described with reference to FIG. 40. Accordingly, the fifth full-adder FA45 may receive the third summation data S3 and the third carry data C3 from the third full-adder FA43 of the second stage 1022 and may receive the fourth carry data C4 from the fourth full-adder FA44 of the second stage 1022. The fifth full-adder FA45 may add a value of the third sign data SIGN3 to the third carry data C3 as a new LSB to generate the third carry input data. Also, the fifth full-adder FA45 may add a value of the fourth sign data SIGN4 to the fourth carry data C4 as a new LSB to generate the fourth carry input data. The fifth full-adder FA45 may perform an addition operation on the third carry input data, the fourth carry input data, and the third summation data S3 to output the fifth summation data S5 and the fifth carry data C5. The adder ADD of the third stage 1023 may receive the fourth summation data S4 from the fourth full-adder FA44 and the second sign data SIGN2. The adder ADD may perform an addition operation on the fourth summation data S4 and the second sign data SIGN2 and may output the resulting data as the sixth summation data S6.

The half-adder HA4 disposed at the fifth stage 1025 of the adder tree 1020 may be configured in the same manner as the fourth full adder (FA34 of FIG. 44) described with reference to FIG. 44, except that the eighth sign data SIGN8 may be input as the first carry generation logic value GO instead of the third summation data (S3<15: 0> of FIG. 44), and the addition logic circuit (934C of FIG. 44) may be configured as a prefix adder, such as a Kogge-Stone adder. Accordingly, the half-adder HA4 may receive the seventh summation data S7 and the sixth carry data C6 output from the sixth full-adder FA46. The half-adder HA4 also may receive the seventh sign data SIGN7 for new LSB addition to the sixth carry data C6, and the eighth sign data SIGN8 as the first carry generation logic value GO. The half-adder HA4 may generate the sixth carry input data by adding a value of the seventh sign data SIGN7 to the sixth carry data C6 as a new LSB. The half-adder HA4 may perform an addition on the sixth carry input data, the seventh summation data S7, and the eighth sign data SIGN8 and may output the mantissa addition data D_MA.

When mantissa data is negative, inverted mantissa data may be input to the adder tree 1020. Accordingly, the “+1” operation in the negative number processing circuit 1010 may be omitted based on the number of negative mantissa data. When the mantissa data is positive, sign data of the positive mantissa data may have a value of “0”. When the mantissa data is negative, sign data of the negative mantissa data may have a value of “1”. In other words, for the positive mantissa data, adding a new LSB having a value of “0” of the sign data might not affect the result of an addition operation. On the other hand, for the negative mantissa data, up to six “+1” operations may be performed by adding LSBs having a value “1” of the sign data to the carry data in the third to sixth full-adders FA41-FA46 and half-adder HA4 of the adder tree 1020. Then, in the adder ADD of the adder tree 1020, a value of the fifth sign data SIGN5 may be added to the fourth summed data S4 so that up to one “+1” operation may be performed. Also, in the half-adder HA4, up to one “+1” operation may be additionally performed by using a value of the eighth sign data SIGN8 as the first carry generation logic value during an addition operation.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An adder circuit comprising:
a negative number processing circuit configured to receive mantissa data and sign data of a plurality of floating point data and configured to output selected mantissa data, and
an adder tree configured to perform an addition operation on the selected mantissa data to generate mantissa addition data,
wherein the negative number processing circuit is configured to output mantissa data of floating point data having a positive sign as the selected mantissa data, and to output an inverted mantissa data in which values of mantissa data of the floating point data having a negative sign are inverted as the selected mantissa data, and
wherein the adder tree is configured to perform the addition operation on the selected mantissa data with a number of “+1” operations equal to the number of the inverted mantissa data output from the negative number processing circuit.

2. The adder circuit of claim 1, wherein the negative number processing circuit comprises a plurality of inverters and a plurality of selectors,
wherein the plurality of inverters are configured to invert the mantissa data of the plurality of floating point data and to output an inverted mantissa data,
wherein the plurality of selectors are configured to output the mantissa data or the inverted mantissa data as the selected mantissa data based on the sign data, and
wherein the selected mantissa data comprises a first selected mantissa data, a second selected mantissa data, a third selected mantissa data, a fourth selected mantissa data, and a fifth selected mantissa data.

3. The adder circuit of claim 2, wherein the plurality of selectors are configured to:
output the mantissa data as the selected mantissa data when the sign data is “0”, and
output the inverted mantissa data as the selected mantissa data when the sign data is “1”.

4. The adder circuit of claim 2, wherein the adder tree comprises a first stage to a “K”-th stage,
wherein the first stage comprises a first full-adder, the first full-adder receiving first sign data and the first to third selected mantissa data and outputting first summation data and first carry output data, and
wherein “K” is a natural number greater than 2.

5. The adder circuit of claim 4, wherein the first full-adder comprises:
an adding logic configured to perform an addition operation on the first to third selected mantissa data to generate the first summation data and first carry data, and
an output circuit configured to generate the first carry output data by adding a new least significant bit (LSB) having a value of the first sign data to a lower bit position of a LSB of the first carry data.

6. The adder circuit of claim 5, wherein the output circuit comprises one more input line than the number of bits of the first carry data, and the same number of output lines as the number of bits in the first carry output data,
wherein the first sign data is transferred to a first input line, among the input lines,
wherein a first output line, among the output lines, is coupled to the first input line, and
wherein the output lines, except for the first output line, is coupled to the input lines, except for the first input line, respectively.

7. The adder circuit of claim 4, wherein the first stage further comprises a first half-adder, the first half-adder receiving second sign data, the fourth selected mantissa data, and the fifth selected mantissa data as input and outputting second summation data and second carry output data.

8. The adder circuit of claim 7, wherein the first half-adder comprises:
an adding logic configured to perform an addition operation on the fourth selected mantissa data and the fifth selected mantissa data to generate the second summation data and second carry data, and
an output circuit configured to generate the second carry output data by adding a new LSB having the value of the second sign data to a lower bit position of a LSB of the second carry data.

9. The adder circuit of claim 4, wherein at least one of second to “K−1”-th stages comprises a second full-adder, the second full-adder receiving second summation data, second carry output data, and third carry output data from a previous stage with second sign data and outputting third summation data and fourth carry output data.

10. The adder circuit of claim 9, wherein the full-adder comprises:
an adding logic configured to perform an addition operation on the second summation data, the second carry output data, and the third carry output data to generate the third summation data and first carry data, and
an output circuit configured to generate the fourth carry output data by adding a new LSB having a value of the second sign data to a lower bit position of a LSB of the first carry data.

11. The adder circuit of claim 4, wherein at least one of second to “K−1”-th stages comprises a third full-adder, the third full-adder receiving second summation data, third summation data, and second carry output data from a previous stage with second sign data and outputting fourth summation data and third carry output data.

12. The adder circuit of claim 11, wherein the second full-adder comprises:
an adding logic configured to perform an addition operation on the second summation data, the third summation data, and the second carry output data to generate the fourth summation data and first carry data, and
an output circuit configured to generate the third carry output data by adding a new LSB having a value of the second sign data to a lower bit position of a LSB of the first carry data.

13. The adder circuit of claim 4, wherein the “K”-th stage comprises a second half-adder, the second half-adder receiving second summation data and second carry output data from “K−1”-th stage with second sign data and outputting the mantissa addition data.

14. The adder circuit of claim 13, wherein the second half-adder consists of a prefix adder, and
wherein the prefix adder receives the second sign data as a carry generation logic value of the prefix adder.

15. The adder circuit of claim 14, wherein the half-adder of the “K”-th stage generates the mantissa addition data by adding the carry generation logic value, the second summation data, and the second carry output data.

16. The adder circuit of claim 4, wherein at least one of second to “K−1”-th stages comprising an adder, the adder receiving second summation data from a previous stage with second sign data and adding the second summation data and the second sign data to output third summation data.

17. The adder circuit of claim 2, wherein the adder tree comprises a first stage to a “K”-th stage (where “K” is a natural number greater than 2), and
wherein the first stage comprises:
a first full-adder that receives the first to third selected mantissa data as input and outputs first summation data and first carry data, and
a first half-adder that receives the fourth selected mantissa data and fifth selected mantissa data and adds the fourth selected mantissa data and the fifth selected mantissa data to output second summation data and second carry data.

18. The adder circuit of claim 17, wherein at least one of second to “K−1”-th stages comprises a second full-adder, the second full-adder receiving third summation data, third carry data, and fourth carry data from a previous stage with first sign data and second sign data and outputting fourth summation data and fifth carry data.

19. The adder circuit of claim 18, wherein the second full-adder comprises:
a first input circuit configured to generate first carry input data by adding a new LSB having a value of the first sign data to a lower bit position of a LSB of the third carry data,
a second input circuit configured to generate second carry input data by adding a new LSB having a value of the second sign data to a lower bit position of a LSB of the fourth carry data, and
an adding logic configured to perform an addition operation on the third summation data, the first carry input data, and the second carry input data to generate the fourth summation data and the fifth carry data.

20. The adder circuit of claim 19, wherein the first input circuit comprises one more input line than the number of bits of the third carry data, and the same number of output lines as the number of bits in the first carry input data,
wherein the first sign data is transferred to a first input line among the input lines,
wherein a first output line, among the output lines, is coupled to the first input line, and
wherein the output lines, except for the first output line, is coupled to the input lines, except for the first input line, respectively.

21. The adder circuit of claim 17, wherein at least one of second to “K−1”-th stages comprises a third full-adder, the third full-adder receiving third summation data, fourth summation data, and third carry data from a previous stage with first sign data and outputting fifth summation data and fourth carry data.

22. The adder circuit of claim 21, wherein the third full-adder comprises:
an input circuit configured to generate first carry input data by adding a new LSB having a value of the first sign data to a lower bit position of a LSB of the third carry data, and
an adding logic configured to perform an addition operation on the third summation data, the fourth summation data, and the first carry input data to generate the fifth summation data and the fourth carry data.

23. The adder circuit of claim 17, wherein at least one of second to “K−1”-th stages comprises an adder, the adder receiving third summation data from a previous stage with first sign data and adding the first sign data and the third summation data to output fourth summation data.

24. The adder circuit of claim 17, wherein the “K”-th stage comprising a second half-adder, the second half-adder receiving third summation data and third carry data from “K−1”-th stage with first sign data and outputting the mantissa addition data.

25. The adder circuit of claim 24, wherein the second half-adder consists of a prefix adder, and
wherein the prefix adder receives the first sign data as a carry generation logic value of the prefix adder.

26. The adder circuit of claim 25, wherein the second half-adder comprises:
an input circuit configured to generate first carry input data by adding a new LSB having a value of the first sign data to a lower bit position of a LSB of the third carry data, and
an adding logic configured to generate the mantissa addition data by adding the carry generation logic value, the third summation data, and the first carry input data.
